(19) United States
(12) Patent Application Publication
(10) Pub. No.: US 2002/0156738 A1
(43) Pub. Date: Oct. 24, 2002

(54) "Pay as you go " database system

(76) Inventor: Thomas Irmler, Uobe (JP)

Correspondence Address: THOMAS IRMLER, 5-8-28, SHINOHARA-NAUAMA CHI, NADA-UU, UOBE, JP

(21) Appl. No.: 09/789,489

(22) Filed: Feb. 26, 2001

(51) Int. Cl. G06F 17/60

(52) U.S. Cl. 705/52

(57) ABSTRACT

The invention is a process to generate a recurring cash flow from users of a computer program to the developer of a computer program.

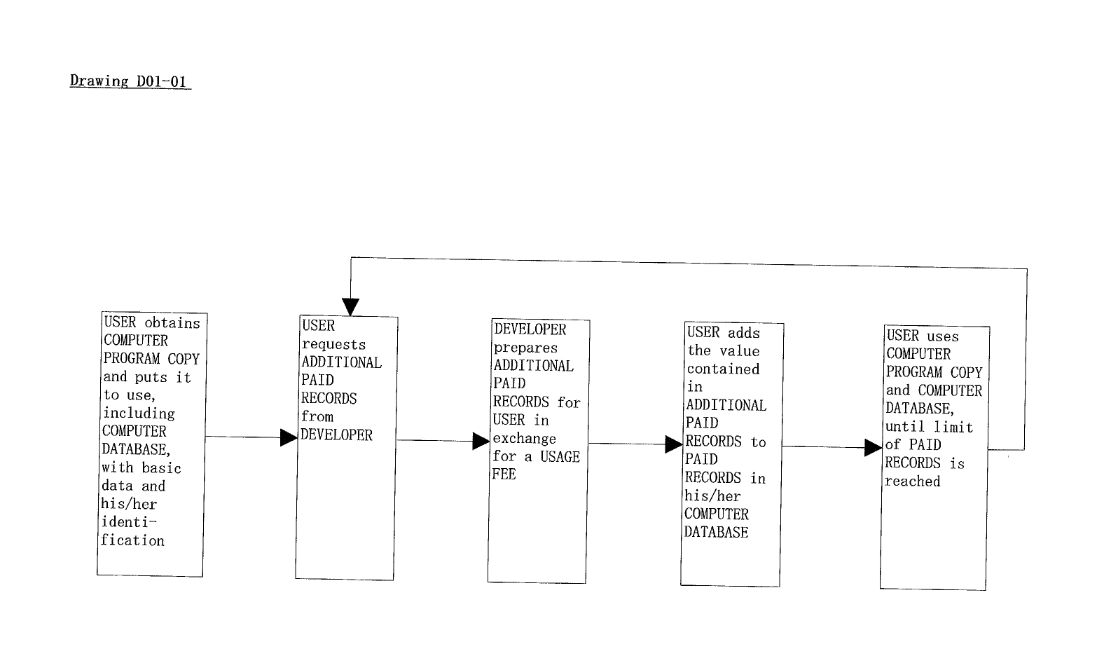

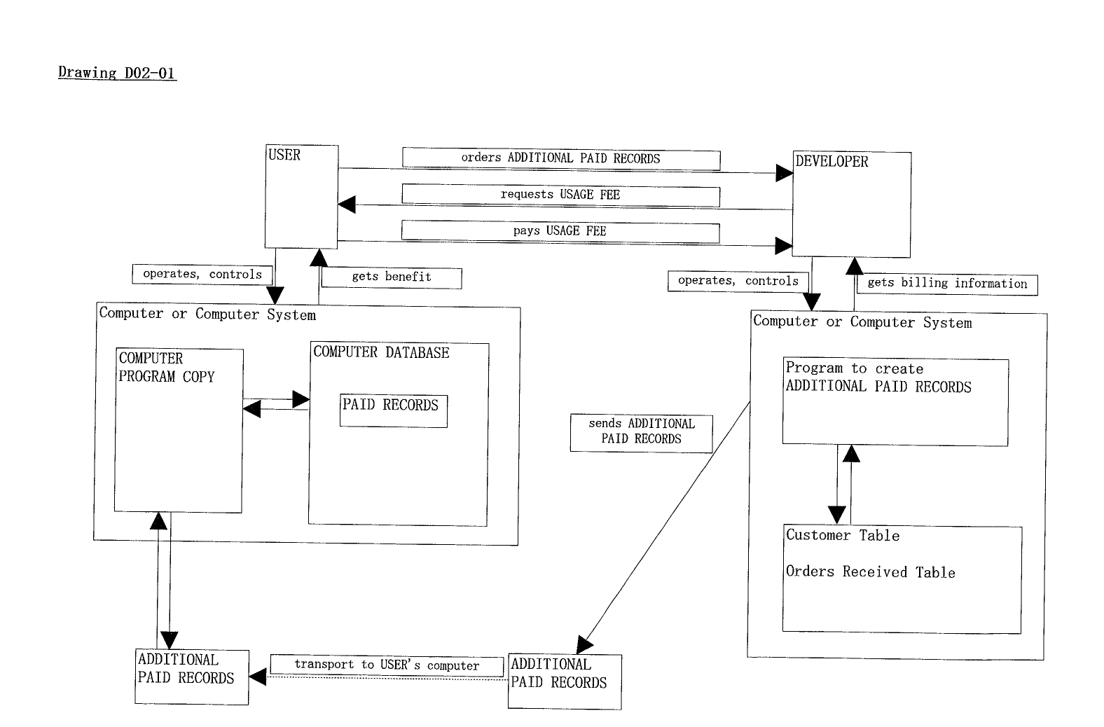

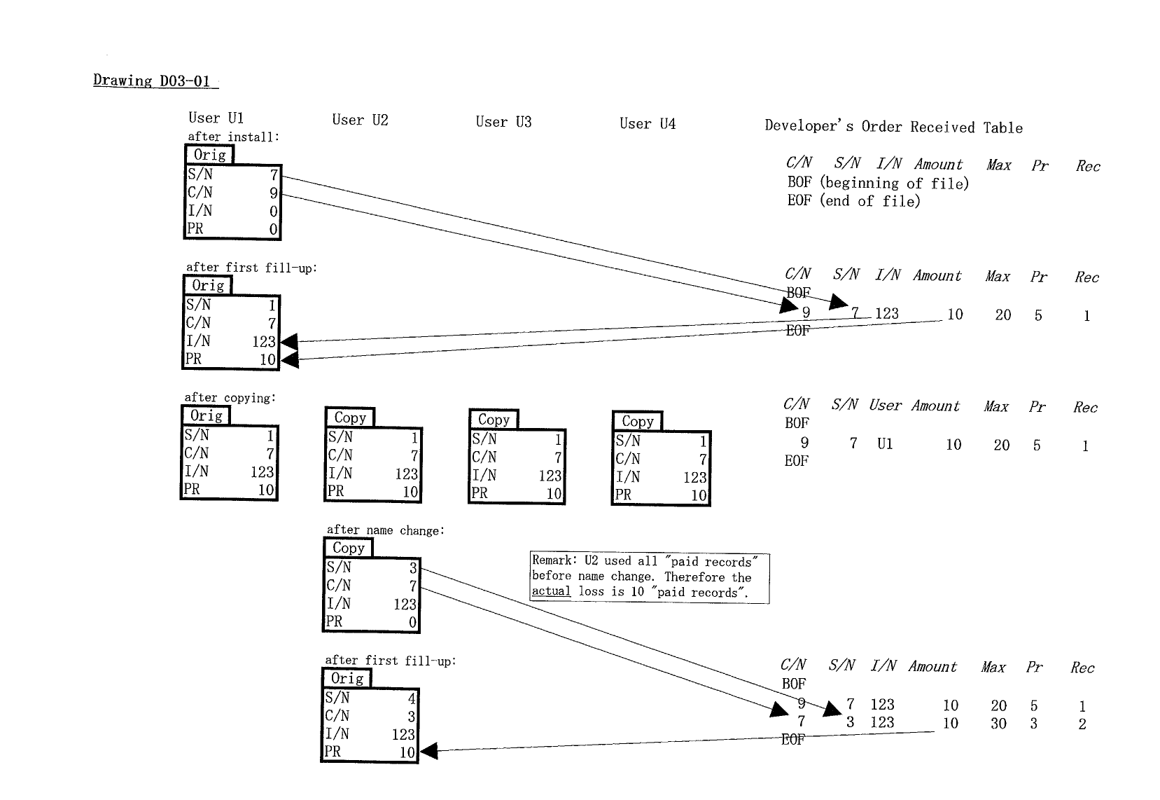

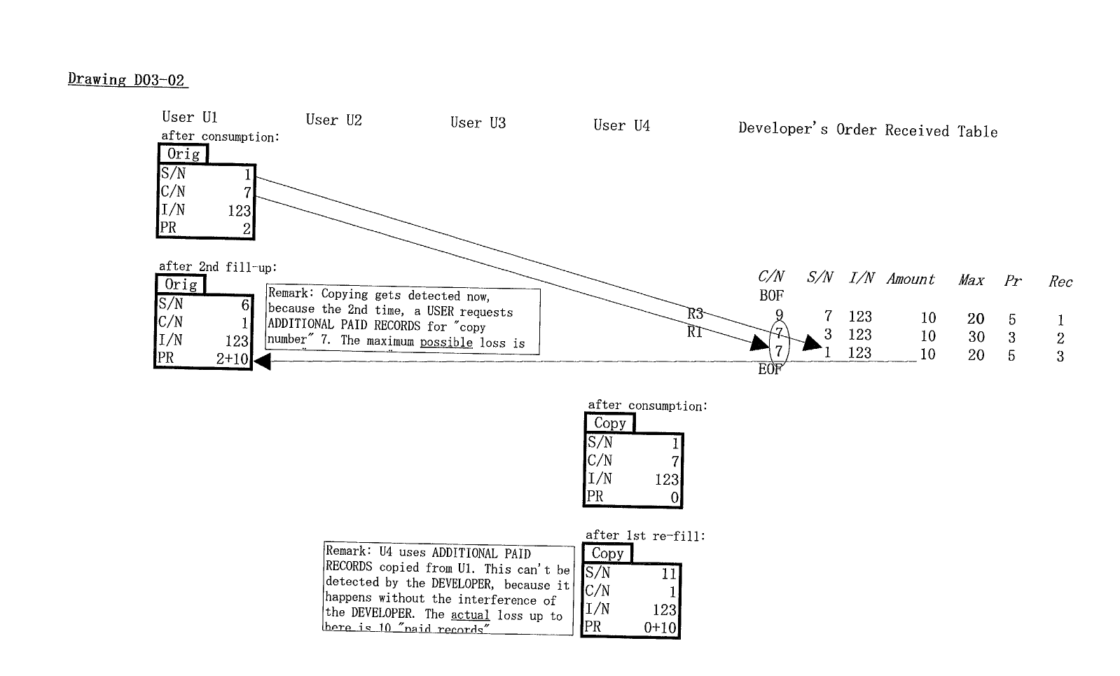

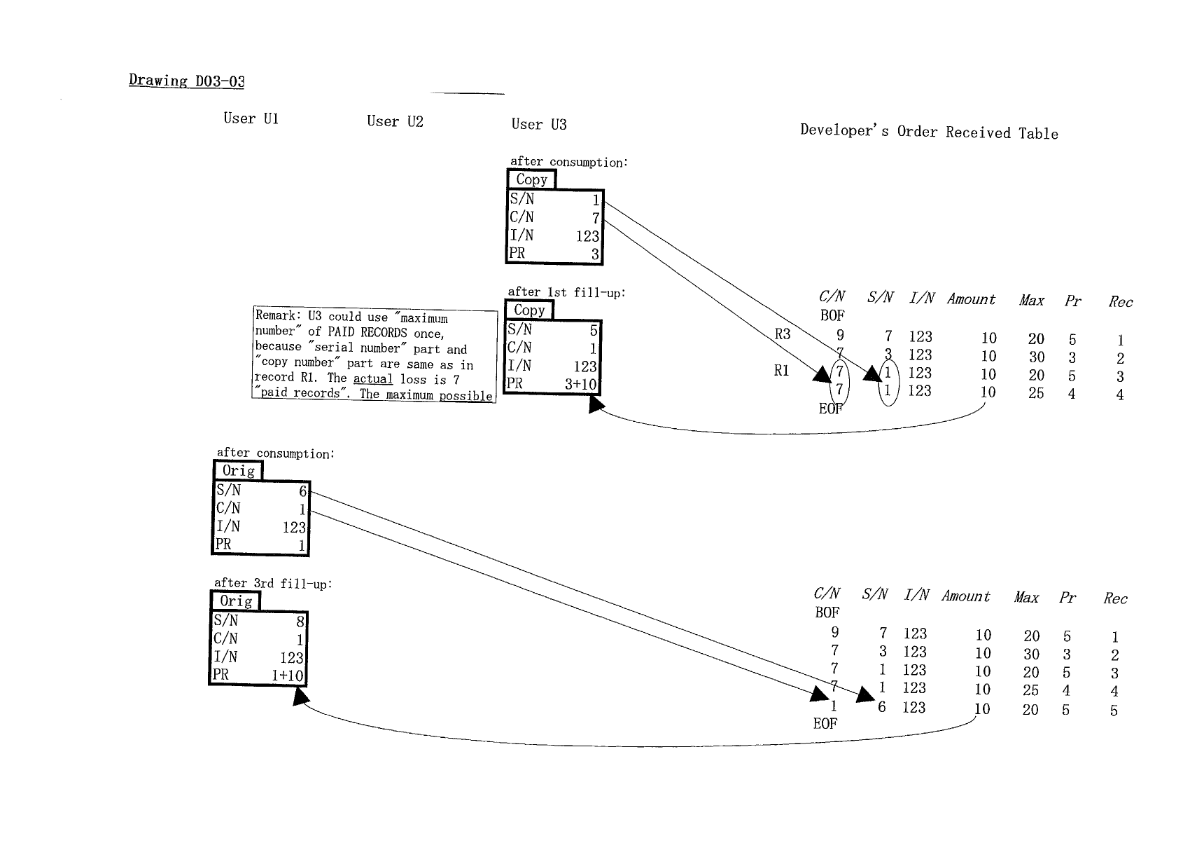

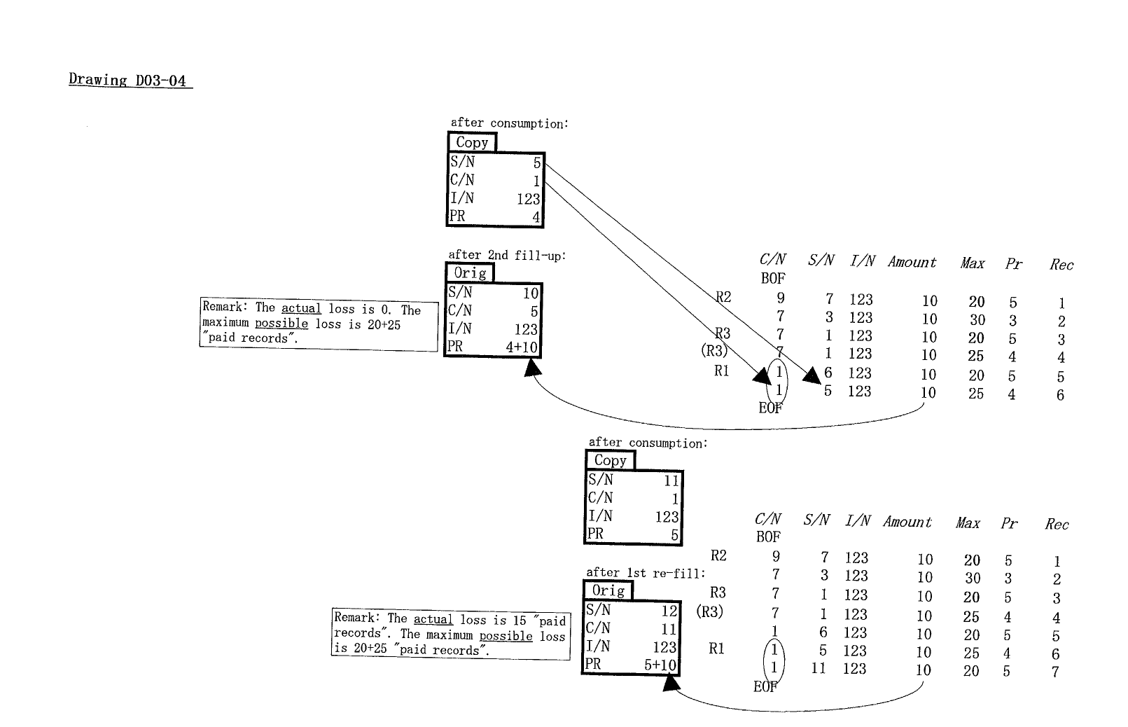

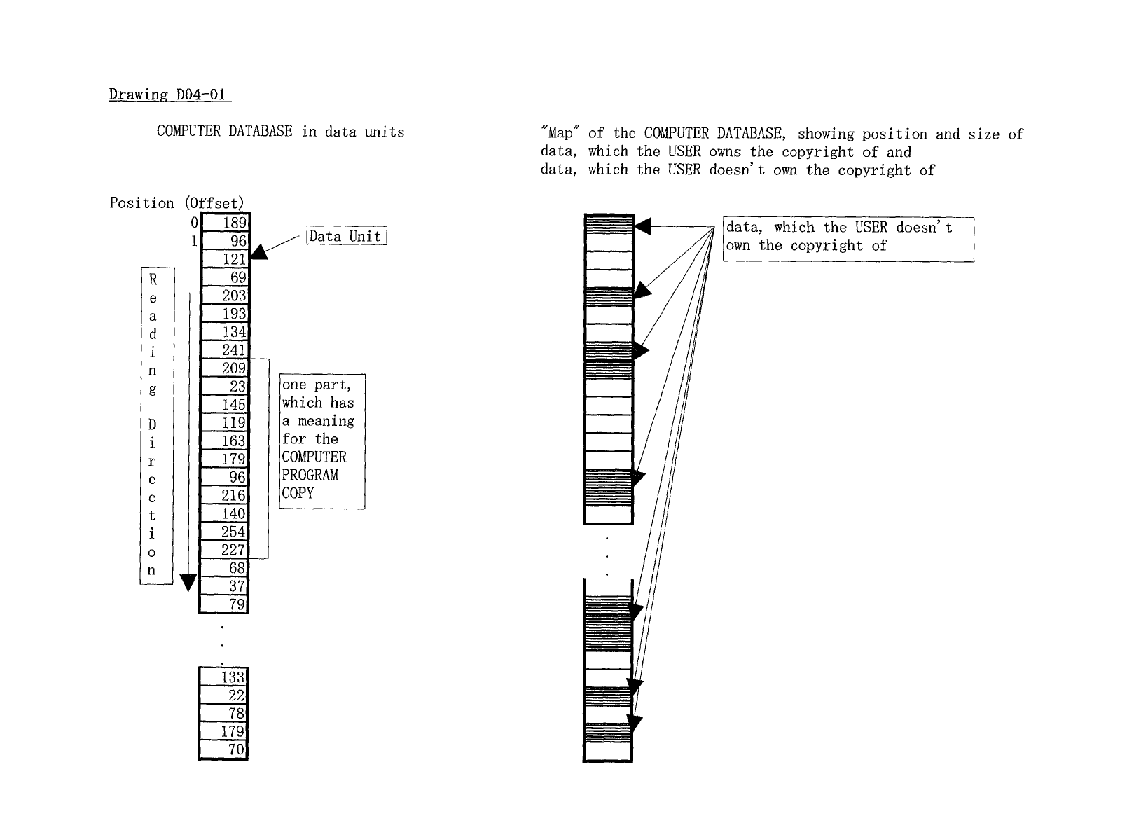

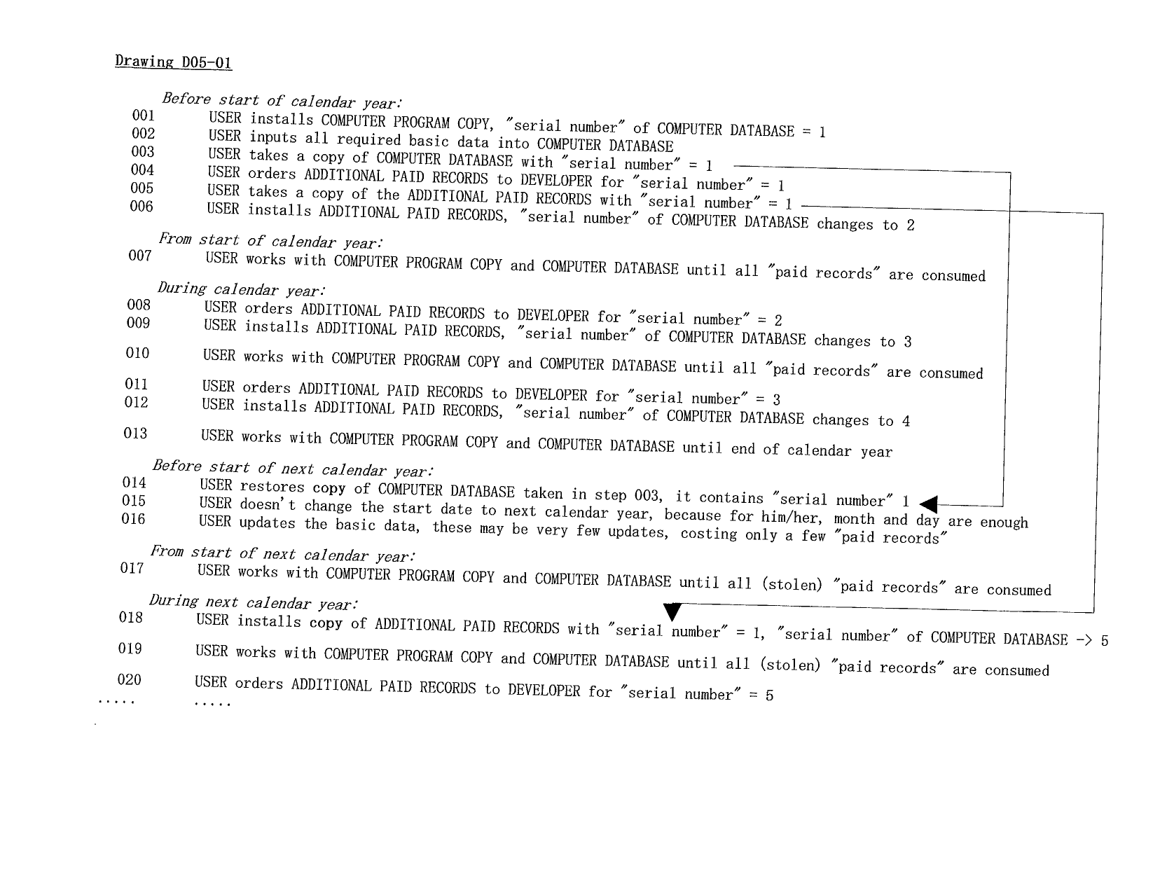

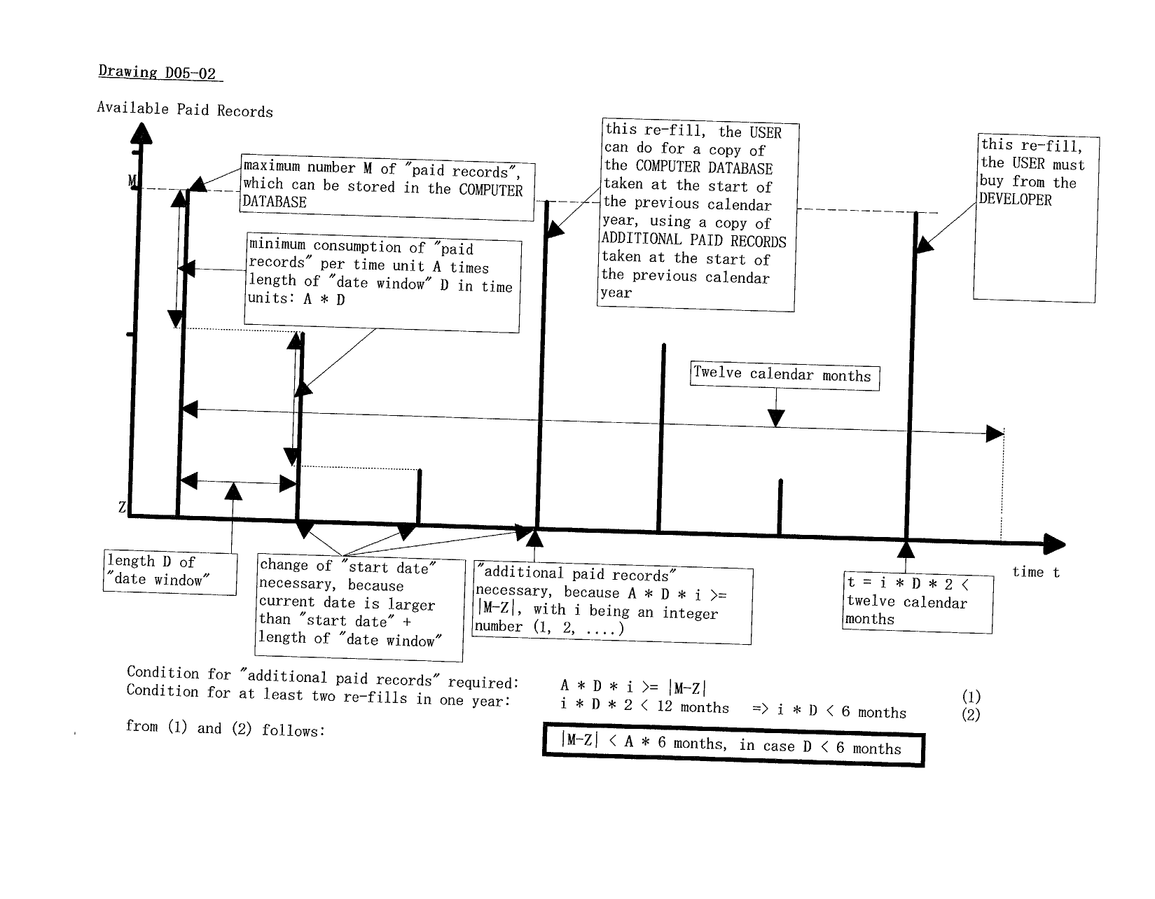

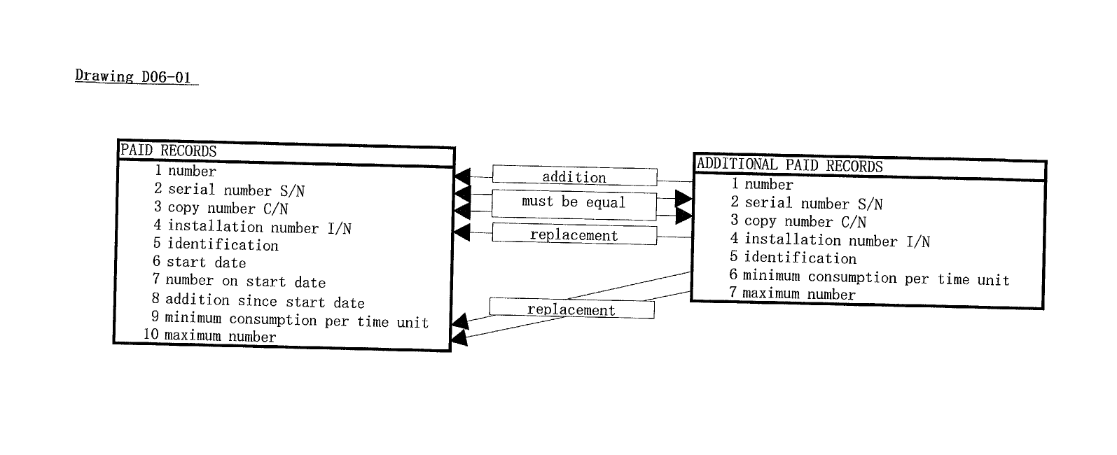

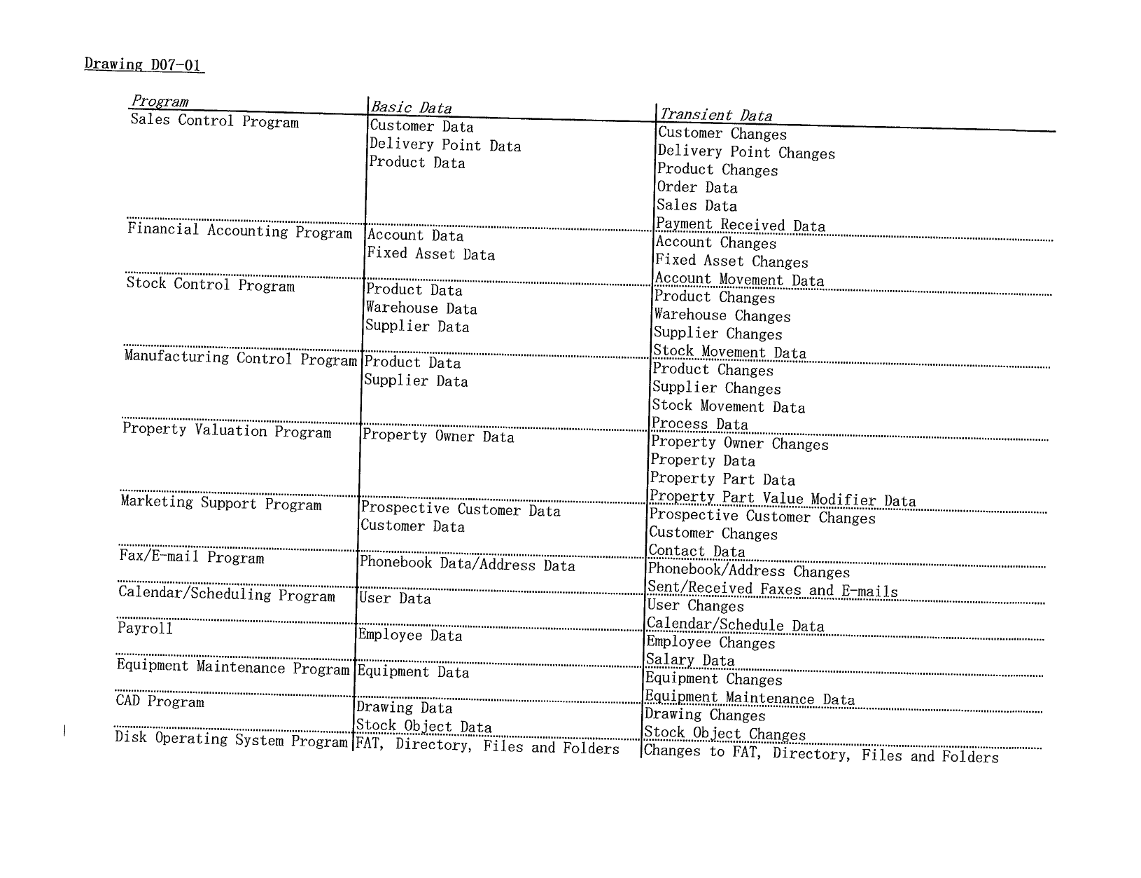

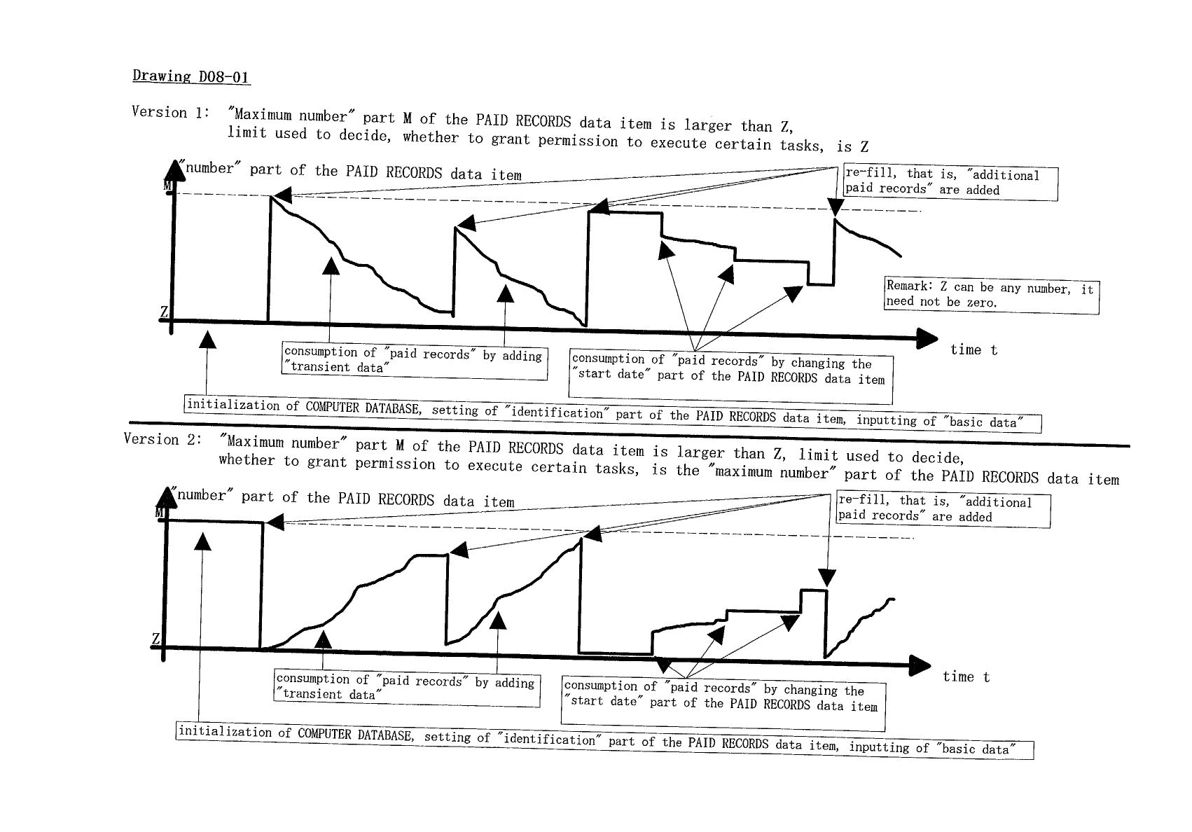

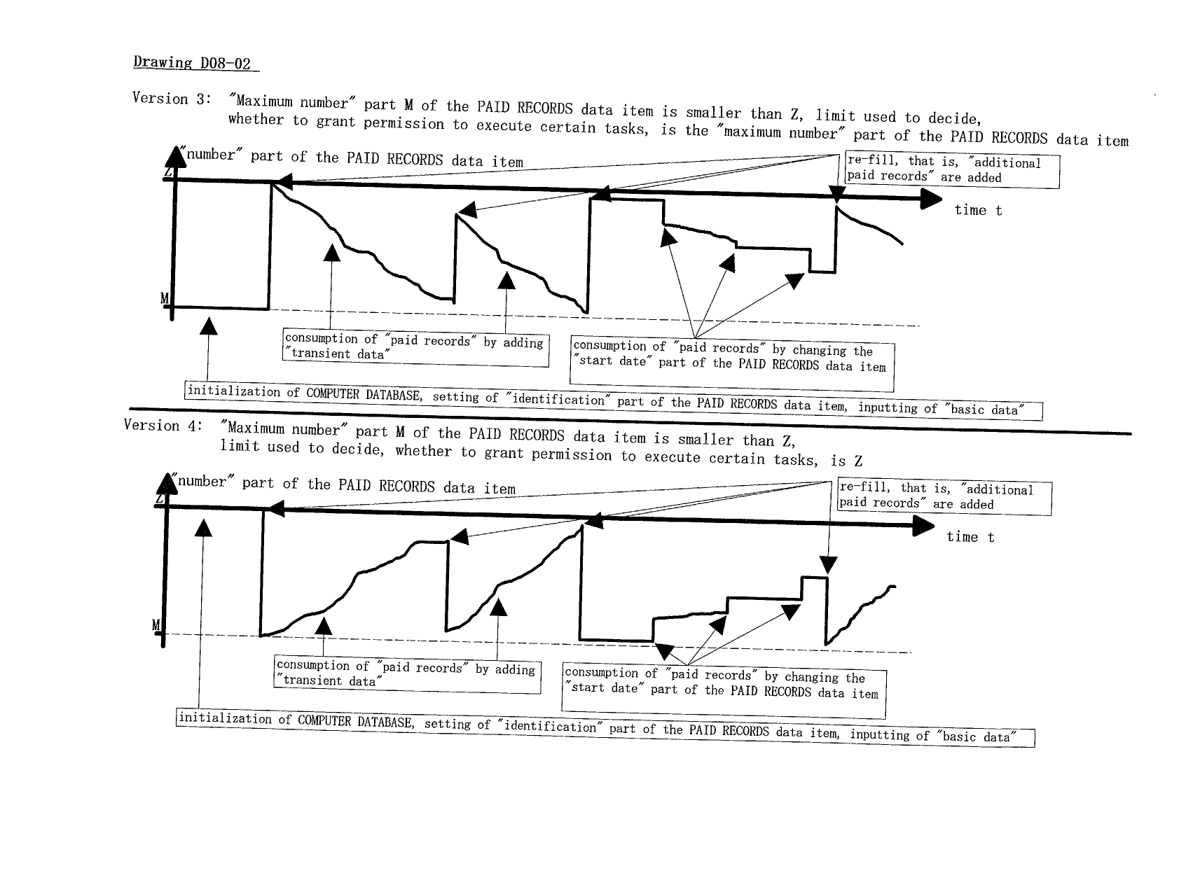

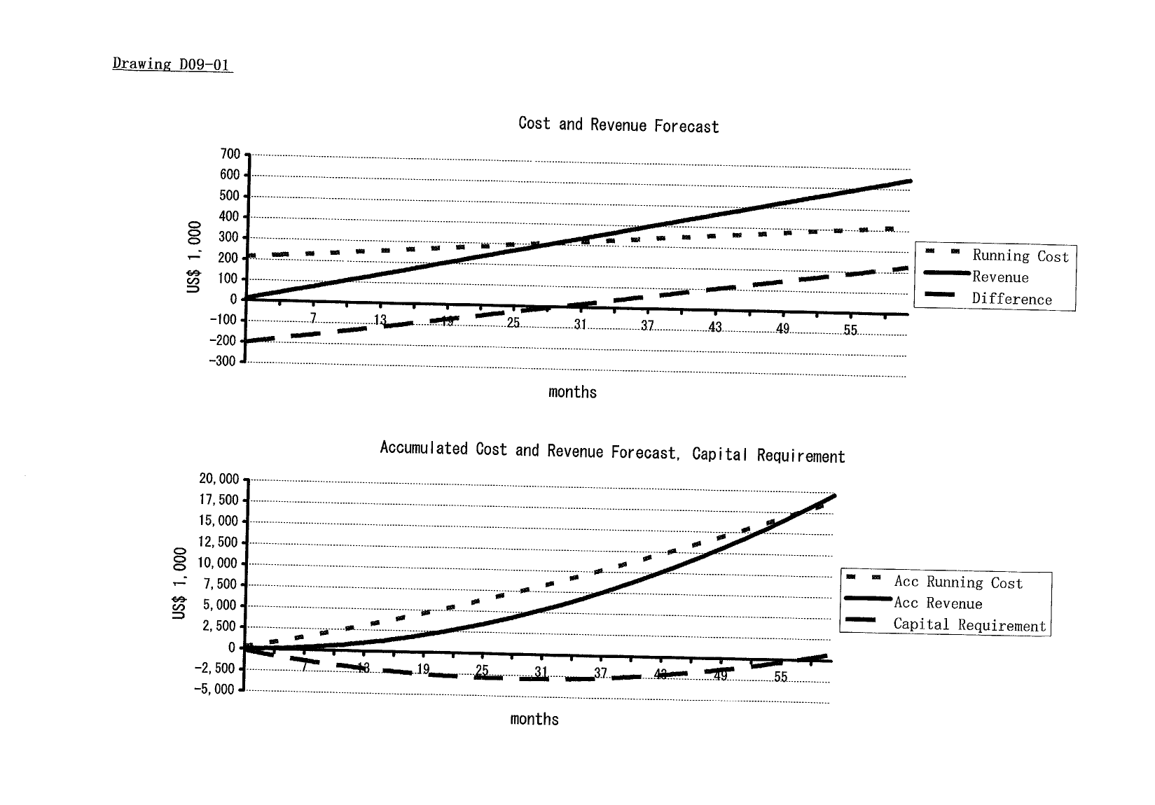

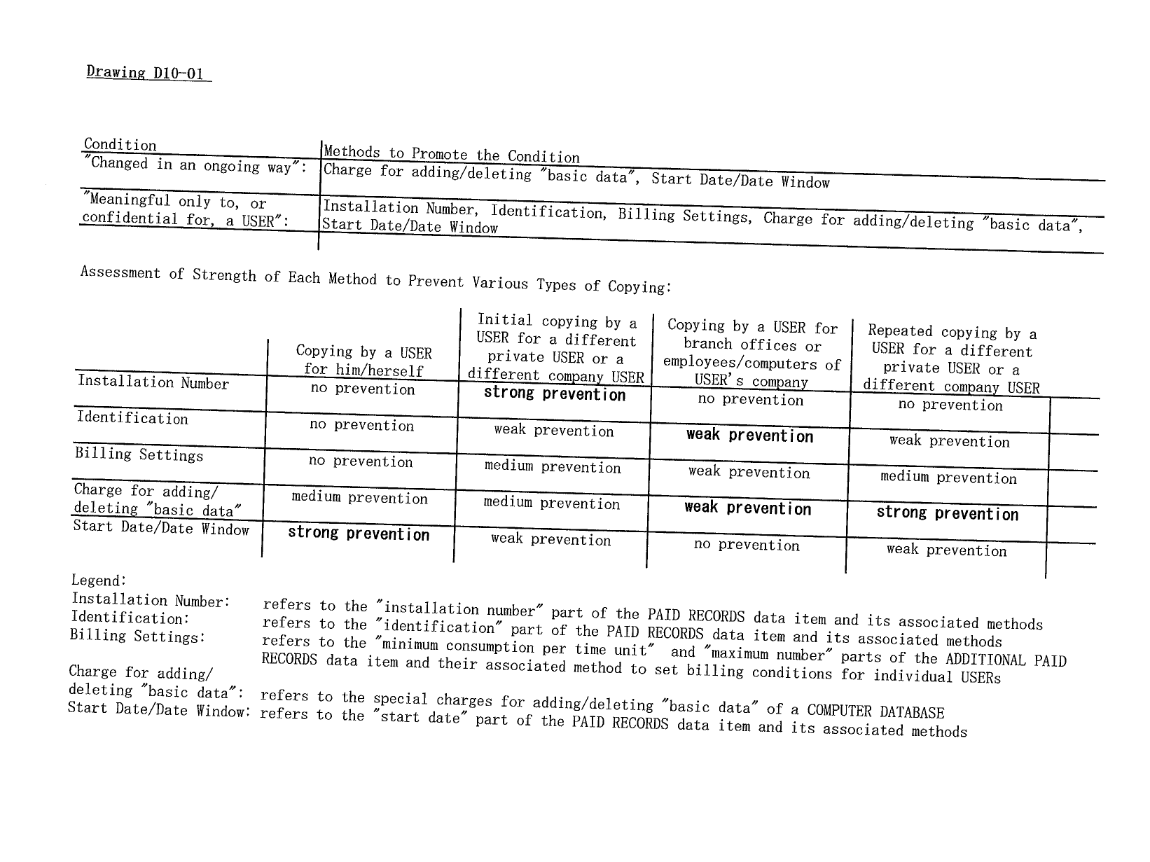

This is achieved by storing in an inventive way on the computer of the users an inventive piece of information (1) and using it in the following way:

The computer program contains an inventive additional code to modify that information (1), and to decide based on that information (1), how the user may use the computer program.

The additional code modifies the information (1) in such a way, that during the user uses the computer program, the information (1) is changed towards a limit.

When that limit is reached, the additional code in the program denies to the user to use an inventive part of the program.

To continue using the program, the user has to obtain from the developer of the program, in exchange for an inventive fee, another inventive piece of information (2), the developer using an inventive way to identify the user.

The additional code in the program uses this information (2) to change the information (1) away from the limit, thereby allowing the user to continue to fully use the program until information (1) reaches the limit again.

An inventive method to detect copying of information (1) and to estimate the loss to the developer from copying is included also, as well as a method to calculate kickbacks for intermediaries charged with distributing the program, a method to visualize the use of information (2) and a method to prevent a program from being distributed.

### CROSS REFERENCE TO RELATED APPLICATIONS

There are no related applications.

### STATEMENT OF FEDERALLY SPONSORED RESEARCH/DEVELOPMENT

The research and development is not and never has been sponsored by the U.S. Federal Government.

### REFERENCE TO MICROFICHE APPENDIX

There is no microfiche appendix.

### BACKGROUND OF THE INVENTION

The “pay as you go” database system is a new process for computer program developers to generate revenue from the use of computer programs,

which are to be used on computers, whose technical specifications as well as the skill to manufacture them are in the public domain and

the knowledge as well as the skill of how to put those programs to use on such computers are in the public domain.

In other words, the description below is not primarily concerned with computer programs,

which are to be used on computers, whose technical specifications or the skill to manufacture them are proprietary (non-standard computers like mainframes . . . ) or

the knowledge or the skill of how to put those programs to use on computers are not in the public domain (e.g. so-called pre-installed programs).

### STATE OF THE ART

Process 1

The currently almost exclusively used process to generate revenue from the use of such computer programs is to “license a program to a user”.

This means, that, in exchange for a license fee, a user obtains a copy of a computer program, installation instructions and a license information.

In other words, the computer program developer obtains a license fee once only for one copy of such a computer program, before the user obtains the means to use the program.

The copy of a computer program is the physical means for a user to make use of the program.

It consists usually of a specific arrangement of (encoded) instructions, which a certain type of computer can automatically read and perform, and instructions for the user how to make use of a computer performing the (encoded) instructions of the program.

Installation instructions tell in language understandable to everybody how to get a certain type of computer to read and perform the (encoded) instructions, which are part of the copy of the computer program.

The license information is a legal document, which tells the user, that the computer program developer claims copyright for the computer program. It gives information of what the user may do and may not do with the copy of the computer program.

The license information usually gives no time limit for the use of a computer program.

Process 2

Another process to generate revenue from the use of such computer programs is to charge fees at the time a user requests information regarding the program from the program developer.

In other words, revenue is generated at certain times during any user makes use of any copy of the computer program.

Process 3

A third process is to include in the computer program some (encoded) instructions, which obtain the current date from the computer hardware or another source, and block other (encoded) instructions in the program after a certain date.

If the user wants to use such a program after that date, he/she has to pay a fee to the program developer and gets in return a program change, which has a different date encoded in it.

In other words, revenue is generated at certain time intervals during any user makes use of any copy of the computer program.

Process 4

A fourth process to generate revenue is a program, which only performs certain tasks after obtaining permission to do so from the program developer, each and every time any user requests such a task to be performed.

For that purpose, the computer of any user is connected to another computer, which is controlled by the program developer.

Before certain tasks are performed, the program sends a signal to the computer of the program developer.

The computer of the user waits then until the computer of the program developer sends a signal back, which may be permission or denial of the task to be performed.

In case the computer of the program developer sends a permission signal, it also logs this permission; the log is then used to compute usage charges for the program to the user.

In other words, revenue is generated very frequently, that is, when any user makes any copy of the computer program perform certain tasks.

Process 5

The program developer provides to users so-called “free software”, i.e. renounces revenue.

Process 6

The developer installs his program on computer hardware by himself, therefore doesn't give installation instructions to users.

Or the developer sells licenses in bulk to hardware manufacturers who preinstall the program on their new hardware.

Process 7

The developer provides program and installation instructions to users and gets compensated by means of a maintenance contract.

### CRITICISM OF THE STATE OF THE ART

Introduction

The 4 processes described above are examined one by one for their potential to generate revenue for the program developer.

General

Because the technical specifications for computers, where such programs can be used, are in the public domain, as well as apparatuses to make copies of such programs, anybody can make copies of such programs without the knowledge of the program developer.

Such copies then can be put to use by everybody using the installation instructions, because they are in the public domain as well.

That means, the copyright for such programs is impossible to enforce. There are estimates that illegal copying costs developers of such computer programs billions of dollars in lost revenues per year.

Because of that, users, who actually pay for a program, usually pay more than their fair share of the program developer's expenses. Users knowing this are inclined to also use illegal copies, causing further revenue loss to the program developer.

Program developers have made attempts to prevent illegal copying, which all have failed.

Most notably, attempts made by including certain user-specific information into the copy of a program during the installation, this information remaining constant after the installation (like a user name or machine number), were not effective.

The user was then asked for this information when notifying the program developer of the installation or when requesting support from the program developer.

However users, who did neither notify the developer of an installation nor request support, were in practice free to use illegal copies.

Regarding Process 1

A

Because getting revenue from a program is coupled with the act of “installing” the program copy, only those users, who feel competent to install the program or have the money to get that job done, will contribute to the revenue of the program developer.

Some program developers are distributing free “trial copies” of their programs, installed and ready for use on computers.

To be able to make full use of the program, a user has to pay a fee, obtains in exchange a copy of a fully functional program, which must be installed in order to make use of it.

However users, who don't feel competent to perform the installation, won't buy the program, even if they like it in principle. To do the job the program would perform, they will use other means that are actually at their disposal.

This circumstance translates directly into loss of possible revenue for the program developer.

B

Because the program developer gets revenue only once when handing over a copy of a program, the developer must attempt to sell copies constantly in order not to face bankruptcy.

However, because illegal copies become available immediately after the first few legal copies are available, it is impossible to sell copies of the same program constantly.

Another reason for not being able to sell copies of the same program constantly is, that computer programs don't “wear off” in a way for instance mechanical apparatuses or food items do.

Program developers are tackling this issue by modifying their programs at a pace dictated by their accountants, selling the modifications as “upgrades”.

This, however, has lead to frustration both on the side of the developers as on the user side:

The developers have no room to release upgrades when they are ready, rather, they must release when the accounting department requires the release.

Also, upgrades must have built-in reasons for the next upgrade.

This is usually in the form of functional deficiencies that are apparent from the very first day a user sees his “upgrade”.

(On the other hand, for instance, a car works perfect when bought new, and then gets its “bugs” over the course of several years.)

Users come to perceive an upgrade as “a face-lift, new features, 90% of which appear to be not useful, on the other hand useful features of the previous version are not available any more, 10 old bugs removed and 10 new bugs introduced”.

Having to constantly adapt to face-lifts is often more hindrance than help for day-to-day work. On the other hand, without a face-lift, nobody would buy an upgrade, because it looks like the previous version.

For users, who don't buy upgrades on face-lifts alone, new features must be available. However, experience has shown, that substantially innovative and useful features don't become ready at the speed the accounting department would require them.

Also, users have their own limitations in comprehending and adapting to new features.

What is actually available are fixes for deficiencies of released programs. However, even though both developers and users would love them to be put to use, the accounting department doesn't:

The reason is, that generating revenue from such fixes is completely impossible, and, even worse, distributing such fixes takes away one big sales argument for an upgrade.

The frustration on the user side certainly leads to loss of possible revenue of the program manufacturer.

Also, program developers with the vision and the skill to create programs, which work well and are useful for many years, have the smallest revenue, while developers, who are able to sell something short-lived over and over again, have the biggest.

This puts off consumers, damaging the entire industry for such programs, again leading to loss of possible revenue.

Certainly, depending on the type of program, something short-lived might be the right thing, for instance for game programs.

However for business use, short-lived programs are probably not, what the user wants.

Yet another problem is, that users resist upgrading programs, which manage computer databases, because of concerns that the upgrade will not be able to work with all parts of the user's existing database.

Especially for programs, which are being upgraded at a fast pace, this concern has shown to be justified.

Users, who develop applications based on rapidly changing operating system programs, often see their product outdated before it hits the market at all, because the operating system program has changed already. Such users are looking envious at developers of applications for mainframes and mid-range computers, where operating system programs leave the application developer time to write off their investment.

All this again takes possible revenue away from program developers.

And finally, because revenue is practically only generated immediately after the release of a program, the flow of revenue to the program developer is very uneven. That causes financial problems.

C

Because the program developer needs to charge a user before handing over a copy of a program, the user must often commit a large sum of money before having been able to find out, whether the program suits him/her at all.

Even if the program developer agrees to be paid in installments, the user must sign a contract to pay all installments, because the program developer has no means to prevent a user from using a program once a copy is handed over.

This reduces the market size for a program to those users, who believe in a brand name, a recommendation, or for whom the charge for the program is negligibly small.

In other words, this is a reason for loss of possible revenue by the program manufacturer.

Regarding Process 2

One problem with this process is, that explanations regarding the program are usually available from other sources than the program developer.

Another problem is, that programs must perform with as little explanations as possible to be perceived by users as “useful”.

Yet another problem is, that users, who use a program very often, need probably very few additional explanations, while users, who use the program only a little, probably need more.

Charging high amounts for such additional explanations would make users, who use the program only a little, stop using it altogether, and make users, who use the program a lot, stop requesting additional explanations.

Charging any amount still is kind of unjust, because users, who use the program little, having little benefit from it, probably ask for more explanations, therefore effectively pay more than those using the program a lot.

Therefore, process 2 can not be a reliable source of revenue for a program developer.

Regarding Process 3

One problem with this approach is, that any user, who obtains a copy of a program containing a certain date limit, can use public domain knowledge to make copies of it and distribute the copies illegally.

Another problem is, that such a program “expires” even if it is not used at all. Such a program is an attempt to charge all users at fixed intervals, disregarding whether a user uses a program a lot or just a little.

It is obvious, that the first problem causes revenue loss to the program developer.

Because of the latter problem, such programs won't be very popular with many users, who, instead of buying the program with a new expiry date, will just stop using the program. This takes revenue away from the program developer.

Yet another problem is, that such a program has a problem to obtain the correct current date, because a user is free to input any date into the program.

Regarding Process 4 The problems with this process are with performance, cost and practicality.

Because every copy of such a program must wait for a signal from a computer of the program developer each and every time before performing certain tasks, performance of such a program depends a lot on the speed of signal transmission between each user's computer and a computer of the program developer and on the speed at which the computer of the program developer can process the signal received from a user's computer, at the time the signal is received.

In case the computer network, which transmits the signal, is slow, the user will see this as slow performance of the program on his computer, leading eventually to dissatisfaction and disuse of the program, so the developer loses revenue.

In case the computer network, which transmits the signal, is not working at the time when a user wants the program to perform a certain task, the user won't be able to work at all.

This will cause problems between the user and the network operator, with the network operator being liable for losses, which a user suffers because of not being able to use a program.

It may also cause a user to disuse such a program, causing revenue loss for the developer, even if the problems weren't the fault of the developer.

In case the computer of the program developer, which processes the signal, is slow, the user will see this as slow performance of the program on his computer, leading eventually to dissatisfaction and disuse of the program, so the developer loses revenue.

In case the computer of the program developer, which processes the signal, is not working at the time when a user wants the program to perform a certain task, the user won't be able to work at all.

This will cause problems between the user and the program developer, with the program developer being liable for losses, which a user suffers because of not being able to use a program.

It may also cause a user to disuse such a program, causing revenue loss for the developer.

Cost problems occur on the side of the program developer, who has to provide for a sufficient number of server computers, which must be available 24 hours a day, 365 days a year.

Also the program developer must bear the cost of signal transmission between the users' computers and the server computers, which may be a large percentage of the possible revenue for a program.

The practicality problem is, that each computer, which wants to use such a program, must all the time be connected to a high-speed network. This is simply physically impossible for mobile computers.

Regarding Process 5 This process only works for programs, which need not be changed any more after initial development and for which at the time of release no competitor is in the market, who sells a similar program and could press dumping charges.

All programs, which need to be developed to adjust to changing requirements of users and computer hardware, require funds for this development.

A computer hardware manufacturer, who develops an operating system program for its hardware only, needs to subsidize the development through hardware sales. That is probably more expensive than using a operating system package from a specialized developer, therefore the hardware will become less competitive. The in-house developed program also will sooner rather than later become dependent on the in-house developed hardware, that is, become more and more incompatible with products of other companies.

If that hardware manufacturer gives that operating system program to other parties free of charge or below development cost, the manufacturer faces dumping charges from software companies, which provide a similar operating system package.

Before a company user, on the other hand, obtains for example a “free” operating system program with “open source code”, it will have to find out, what in the long run is better:

To have a more or less small department develop in-house a program, on which day-to-day operation of the company depends or to buy a package from a specialized developer, who can share development cost between several users.

Again, if such a company gives the resulting program to other parties free of charge or below development cost, it will face dumping charges.

Therefore, also this process doesn't work except for very special programs or developers, who can afford to be altruistic.

Regarding process 6

The problem here is, that many users simply want to install a program by themselves. Therefore the developer loses revenue by insisting on installing the program by himself on the user's hardware.

In case of preinstalled programs on new hardware, the developer gets revenue only when hardware is sold. Revenue from users who want to use the program on their existing hardware is lost.

Regarding Process 7

The problem here is, that a user can cancel such a maintenance contract at any time, with the developer having only legal means to prevent the user from using the program after such a cancellation. Therefore, this process only works for such users, where the legal cost to prevent the user from using a program, which is not paid for, are lower than the lost revenue. That means, this process only works for large corporate users.

Below described invention addresses above issues:

Programs equipped with the invention perform certain operations only for a certain number of times, after which the user must purchase a sort of “recharge” for the program, to make it perform those operations again.

This “recharge” is not an “upgrade” of the program, therefore, after the “recharge”, the user has not to learn new tasks or get used to new screens; anyway, the manufacturer of the program has got revenue.

Users pay for the services that a program provides; more, if they use more, and less if they use less.

Programs, which control sales activities, even can be set up to charge more, if the user makes more money and less, if he makes less, for instance by charging for the number of sales records logged by the program.

Program developers, who create programs, which are useful for many years, get rewarded by having revenue from happy users, who continue to use the program for a long time.

Program developers can distribute innovative upgrades when those upgrades are ready for use, because the point of time of distributing an upgrade is far less closely linked to the flow of revenue.

Competition between program developers will be promoted, because each program developer will try to be first to market with substantive innovations, in order to snatch revenue away from the competitors.

Users can use that version of a program, which they think suits them best, without taking revenue away from the manufacturer by not upgrading on time.

Each user can use the program at his own pace and according to his financial capabilities, which may vary from time to time.

The developer on the other hand can issue bug fixes for his programs without the danger of facing bankruptcy.

A user is not bound to a fixed payment schedule for a long time; instead, the user can buy “recharges” for his program when he feels using the services of the program to be the best option.

A program, which is set up in such a way, that a user can use (and pay for) only certain functions (from many installed functions) at any time, saves the user the hassle of upgrading from trial versions to full versions.

Liabilities of computer network providers and program developers towards users of programs are reduced to almost zero, because the information, whether a program may be used or not, is stored on the users' computers.

The program developer need not spend a large percentage of the revenue for a program to cover data transmission cost.

Mobile computers can use such a program without being permanently connected to a high-speed computer network.

The program developer also doesn't depend on computer hardware manufacturers for a large percentage of its revenue, because the revenue creation is hardware-independent for standard programs, which work on standard hardware.

Users, whether corporate or private, have the benefit of having over the long term a well-supported and compatible program, which comes from a developer, which is viable over the long term.

Cost for usage of a program will come down for those users, who have paid in the past, because those users, who haven't paid in the past, will have to pay, if the invention is used.

The invention uses a technique that can easily be included into programs, which manage any form of database except the smallest ones. Any personal computer can run such a program.

At the same time, the technique is far more difficult to circumvent by users, who want to use the program without paying for it, than any existing technique. Casual theft is eliminated completely, professional theft is reduced by orders of magnitude.

### BRIEF SUMMARY OF THE INVENTION

A “pay as you go” database system works as follows:

For each change, which a program makes to a computer database on request of a user, the program makes another change automatically, which is subtracting an amount from a deposit stored in the same database,

in such a way, that the user can't prevent the automatic change from happening. The program must store the data in the database in such a way, that the user can't separate the deposit from his/her database.

In other words, the program automatically balances changes to the database, which are requested by the user and changes to the deposit (which are requested by the developer).

Before each change to the database, the program checks, whether the deposit is empty. In case the deposit is empty, the program doesn't make the change to the database, which the user requested.

So, in order to get the program to fulfill his/her request, the user must get a fill-up for the deposit in his/her database.

The developer of the program provides such a fill-up in exchange for a usage charge, which the user has to pay in order to get the fill-up.

In other words, the developer of the program gets revenue, whenever any user of the program requests a fill-up, the amount of revenue depending on

the number of copies of a program installed,

how much each installed copy is used and

the time span, which any copy of the program is used.

The developer creates a fill-up, which can only be used for the database of the user, who has requested the fill-up, the database being in the status, which it had at he time, when the fill-up was requested.

In other words, the user, who requested the fill-up, is identified at the point of time, when he/she requested the fill-up, indirectly through a piece of data in his/her database,

this piece of data automatically being changed to a new, unique value when the deposit of the user's database is being filled up.

Below follows a step-by-step explanation:

When a program is installed on a computer, a data item called “paid records” is created in a storage facility of that computer.

These “paid records” are inseparably merged with a computer database, which the program creates and manages, the database being only useful for a certain person or group of persons, or only useful in combination with one particular computer and being useful only if stored permanently.

When the user instructs the program to perform a certain task, the program checks whether there are enough “paid records” left.

If there are, the program performs the task and reduces the amount of “paid records” by a certain amount, which is associated with that particular task.

If there aren't, the program doesn't perform the task, but notifies the user, that “paid records” is empty and how to get a fill-up.

The user can then request from the program developer a fill-up for the “paid records”, by telling the amount of additional paid records desired and identifying him/herself using two data: 1 some static properties like name and address and 2 a serial number contained in his/her database.

When getting a request, the program developer creates a fill-up for the identified user. This fill-up may be a removable computer storage media (e.g. a floppy disk) containing some data.

Those data are, inseparably merged with each other, some “additional paid records” and the serial number of the database of the user.

When handing over the fill-up, the program developer requests a fee.

The user then inserts that removable computer storage media into the computer where the program is installed and instructs the program, to add the “additional paid records” to the “paid records”.

The program stores the sum of “paid records” and “additional paid records” in the database and changes the serial number of the database.

After the program has completed this task, the user can continue using the program, little by little using up the “paid records”, until the remaining amount is zero.

Another possibility to obtain a fill-up is, that the computer program automatically makes contact with a computer controlled by the program developer and obtains a fill-up from that computer, which generates a bill to the user.

Summarizing:

Revenue for a program is generated all the time during any copy of such a program is used,

with permissions to use a program copy being stored on the users computer, up to a certain amount.

### BRIEF DESCRIPTION OF THE SEVERAL VIEWS OF THE DRAWINGS

Drawing D01 Process

1 sheet

Outline of the process to generate revenue from the use of a COMPUTER PROGRAM COPY

Drawing D02 Parts of the Mechanism and Interaction with USER and DEVELOPER

2 sheet

Outline of the parts of the mechanism used in the process and the interaction of the parts with USER of program and DEVELOPER of program

Drawing D03 Copy Detection and Loss Estimation

4 sheets

Detailed flow, how to detect copying of payment information and how to estimate the loss caused by copying of payment information

Drawing D04 COMPUTER DATABASE

1 sheet

To support the explanation of the word COMPUTER DATABASE

Drawing D05 Changed in an Ongoing Way

2 sheets

To support the explanation of how the invention achieves, that a database is being changed in an ongoing way

Drawing D06 PAID RECORDS data item and ADDITIONAL PAID RECORDS data item

1 sheet

The parts of these data items and the use of the parts

Drawing D07 Program Samples

1 sheet

List of the programs and the databases, which they manage, which are used to describe a concrete embodiment of the invention

Drawing D08 “Number” part of the PAID RECORDS data item

2 sheets

Change over time of the “number” part of the PAID RECORDS data item. This “number” part is used by the COMPUTER PROGRAM COPY to decide whether to grant or whether to deny permission to execute certain tasks.

Drawing D09 Cost and Revenue Forecast

1 sheet

Revenue created by the process over time and cost to support the explanation of the calculation of the price of one “paid record”

Drawing D10 “Changed in an Ongoing Way” and “Meaningful only to, or confidential for, a USER” as Necessary Conditions to Prevent Copying of COMPUTER DATABASE and PAID RECORDS

1 sheet

List of the invented methods to prevent copying of PAID RECORDS data items and assessment of their strength

### DETAILED DESCRIPTION OF THE INVENTION

Please refer to drawings D01 and D02 for an outline of the invented process and the parts of the process.

Drawing D01 shows, that each USER of a COMPUTER PROGRAM COPY must, after installing it and inputting his/her basic data, contact the DEVELOPER to obtain ADDITIONAL PAID RECORDS, in order to start using the COMPUTER PROGRAM COPY.

After that, each USER must contact the DEVELOPER again from time to time for ADDITIONAL PAID RECORDS, the time interval depending on the intensity of usage of the COMPUTER PROGRAM COPY.

Each time the DEVELOPER sends ADDITIONAL PAID RECORDS to a USER, the DEVELOPER requests from the USER a USAGE FEE.

Drawing D02 shows, that the COMPUTER PROGRAM COPY, the COMPUTER DATABASE and the PAID RECORDS are all stored on a computer or computer system outside of the control of the DEVELOPER.

It also must be noted, that all the parts of the mechanism, namely COMPUTER PROGRAM COPY, COMPUTER DATABASE, PAID RECORDS and ADDITIONAL PAID RECORDS, are computer data, not hardware.

To make and use the invention, the DEVELOPER of a computer program has to do the following steps:

Step 1: Find out, with which database managed by the program (existing or to be developed) the PAID RECORDS data item is to be merged, and how to merge it (from #022).

Step 2: Find out for which services of the program to charge how much, and which services to deny, if there are no “paid records” left (from #492).

Step 3: Make changes/additions to the program (from #606)

Step 4: Establish an apparatus to provide USERs of the program with ADDITIONAL PAID RECORDS (from #871).

Step 5: Distribute COMPUTER PROGRAM COPIES to USERs (from #960)

Below, each step is described in detail. The numbers on the right hand side are used for reference within this detailed description.

PAID RECORDS written in CAPITALS always means the PAID RECORDS data item, as described from #239 below. “Paid records” in quotes means the permission to use the COMPUTER PROGRAM COPY.

ADDITIONAL PAID RECORDS written in CAPITALS always means the ADDITIONAL PAID RECORDS data item, as described from #872 below. “Additional paid records” in quotes means the permission to use the COMPUTER PROGRAM COPY.

Regarding step 1, the question, with which database to merge the PAID RECORDS data item:

A “pay as you go” database system consists of

a COMPUTER PROGRAM COPY,

a COMPUTER DATABASE,

a PAID RECORDS data item,

an ADDITIONAL PAID RECORDS data item.

COMPUTER PROGRAM COPY is described below in step 3 (from #607), PAID RECORDS is described below in the 2nd part of step 1 (from #239), ADDITIONAL PAID RECORDS is described below in step 4 (from #872).

This is what is meant by COMPUTER DATABASE:

A COMPUTER DATABASE is a data item, which is

1 stored in computer files, in computer disk volumes or in other sequential or block-oriented computer storage facilities,

for which means to make copies of one entire file, of one entire disk volume or of one entire storage facility and to distribute those copies may be easily available to the USER,

however the DEVELOPER doesn't make available to the USER any means to make meaningful copies of or meaningful modifications of parts of one file, of one disk volume or of one storage facility, except as prescribed in the COMPUTER PROGRAM COPY,

2 being changed in an ongoing way during the entire usage term of a COMPUTER PROGRAM COPY, the changes intended by the USER to be lasting,

code in the COMPUTER PROGRAM COPY being the only means made available by the DEVELOPER to the USER to make meaningful changes of the COMPUTER DATABASE,

3 meaningful only to, or confidential for, the USER.

Ad 1 (“stored in computer files, disk volumes . . . ”):

Examples are the files stored on personal computers or on file servers, or the hard disk volumes of personal computers or of file servers, or data stored in floppy diskettes or on other removable storage, like smart-cards, memory sticks etc.

A COMPUTER DATABASE consists of one or more such files, such disk volumes or such storage facilities.

All those files, all those disk volumes or all those storage facilities can be stored on computer hardware, which is outside of the control of the DEVELOPER. The invention makes this possible.

Although the DEVELOPER may store some or all the files, some or all the disk volumes or some or all the storage facilities on computer hardware, which is controlled by the DEVELOPER, there is no need to do this in order to use the invention.

A COMPUTER DATABASE consists of a sequence of data units (bytes), the order of the data units, when read in one certain direction, containing the meaning of the COMPUTER DATABASE, or of parts of it, to the COMPUTER PROGRAM COPY (see drawing D04).

For purposes of this description, a COMPUTER DATABASE consists of two kinds of data (see drawing D04):

1 data, which the USER of the COMPUTER DATABASE owns.

This is data, which the USER has typed or otherwise input by him/herself.

E.g. if the USER inputs the names of his/her customers into the COMPUTER DATABASE, the stored names are his/her own.

If the USER makes a drawing and stores it in the COMPUTER DATABASE, the stored drawing data are his/her own.

If the USER reads a text or sings a song and stores the recording in the COMPUTER DATABASE, the stored data are his/her own.

2 data, which the USER of the COMPUTER DATABASE doesn't own.

This is those data stored in the COMPUTER DATABASE, which are used by the COMPUTER PROGRAM COPY to find the data owned by the USER within the COMPUTER DATABASE, i.e. information about the position of the data units, which contain the USER's data.

Examples are the file allocation table and directory of a computer disk, or the keys and indexes stored in a record-oriented database file.

They tell—to the COMPUTER PROGRAM COPY only—the position (offset) of the data units, which contain the USER's data, within the COMPUTER DATABASE, which are usually scattered all around the COMPUTER DATABASE.

The DEVELOPER must not give any means to the USER to convert those data, which the USER of the COMPUTER DATABASE doesn't own, into a form, which is readable by other programs or directly understandable to the human senses.

An example for a form, which is directly understandable to the human senses, is a printout, an example for a form readable by other programs is an output in text-file format, of a so-called “map” of the COMPUTER DATABASE.

(Such a “map” tells, at which position (offset) in the COMPUTER DATABASE each piece of the USER's own data is stored, how many data units each piece occupies, and how to convert the so indicated data units into a form understandable to the human senses.)

But the DEVELOPER must include code in the COMPUTER PROGRAM COPY to unconditionally convert those data, which the USER of the COMPUTER DATABASE owns, into a form readable by other programs or directly understandable to the human senses.

That means, even if the USER has not paid for use the COMPUTER PROGRAM COPY, it anyway must allow the USER to convert those data, which the USER owns.

Without this latter function, the DEVELOPER may be obliged to provide a “map” of the COMPUTER DATABASE, for the USER to exercise his full rights regarding his/her own computer data.

However, a “pay as you go database system” doesn't function, in case USERs have a “map” of the COMPUTER DATABASE, because then they have other means but the COMPUTER PROGRAM COPY to meaningfully make copies of or changes of parts of the COMPUTER DATABASE.

Ad 2 “being changed in an ongoing way . . . ” (see drawing D10):

“Being changed in an ongoing way” is a necessary condition,

in order to eliminate the possibility, or to make it at least as costly as possible, for a USER to make a copy of the COMPUTER DATABASE and then to replace the COMPUTER DATABASE after some time with the (old) copy in order to steal “paid records”.

(In drawing D10 referred to as “Copying by a USER for him/herself”)

Because the COMPUTER DATABASE contains the PAID RECORDS data item, USERs could attempt to save a copy of the COMPUTER DATABASE, and then to replace the original database with the copy at a later date, in order to use the “paid records” in the copy again.

However, if the COMPUTER DATABASE is “being changed in an ongoing way”, replacing the original COMPUTER DATABASE with an old copy destroys all the inputs made between the time the copy was taken and the time the original is replaced.

Therefore, the price, which the USER pays for gaining “paid records” in such a way, is to have to input some data again. This takes at least the USER's time.

Inputting data also reduces the amount of available “paid records” in the COMPUTER DATABASE, as explained in detail in step 2 (from #493).

The invention includes a method, which makes it especially costly to add or to delete “basic data”, that is, those data, which must be available in the COMPUTER DATABASE before starting to work with it,

and whose permanent storage is the fundamental purpose of the COMPUTER PROGRAM COPY (see from #187).

The invention includes another method, to make the COMPUTER PROGRAM COPY promote, that the COMPUTER DATABASE, which it maintains, is “being changed in an ongoing way”:

Part one (of two) of this method is, that both “transient data” and “basic data”, which the COMPUTER PROGRAM COPY uses or stores, require a correct date to be useful, and, that the COMPUTER PROGRAM COPY allows this date at any time to be only within a “date window”.

(Remark:

“Transient data” shall be defined as those data, which define, how the “basic data” in a database are to be changed, respectively, have been changed.

They are called “transient”, because they are stored in the database only for a short time or not stored at all.

See the examples below (from #083 and from #205) for how to apply these categories “transient data” and “basic data” to twelve types of programs.)

This “date window” starts from a “start date”, which is stored in the COMPUTER DATABASE.

The COMPUTER PROGRAM COPY contains code, which doesn't allow the USER to input, nor does it read from the computer hardware, any date prior to this “start date”, neither for temporary use, nor for storage in the COMPUTER DATABASE.

Further, code in the COMPUTER PROGRAM COPY doesn't allow the USER to input, nor does it read from the computer hardware, any date later than this “start date” plus a “date window”, neither for temporary use, nor for storage in the COMPUTER DATABASE.

The COMPUTER PROGRAM COPY also contains code, which allows the USER to change the “start date” to a value larger than the stored “start date” value.

During the “start date” is changed, available “paid records” are reduced by a certain amount. This amount can be regarded as a minimum charge per time unit.

That means: Even if the USER could use almost all data contained in an old copy of the COMPUTER DATABASE as they are, in order to be able to use the current date with the COMPUTER DATABASE, he/she needs at least to change the “start date” in the old copy.

However, by changing the “start date”, the amount of available “paid records” is reduced, the more, the older the copy is.

By setting the minimum charge per time unit, the DEVELOPER can make almost sure, that no USER gains “paid records” by restoring an old copy of the COMPUTER DATABASE.

The invention contains the computation formula for the minimum charge, as described below from #135 with the help of drawing D05-02.

Practical examples for twelve kinds of programs (see drawing D07):

1 Sales control program:

“Transient data” are sales records, order records and the changes to customer records, to delivery point records and to product records.

The sales control program stores in the COMPUTER DATABASE a “start date”. When the USER logs a sales record in order to output a delivery note, a correct date must be stored with that record.

The sales control program doesn't accept any date prior to the “start date”, nor does it accept any date later than “start date” plus “date window”, for example, 2.5 months after the “start date”.

So, from time to time, the USER has to change the “start date” stored in his/her COMPUTER DATABASE, in order to be able to record correct dates with the sales records.

After the USER changes the “start date”, for example, from January 1 to February 1, the sales control program doesn't accept any date prior to February 1, however it accepts dates until mid-April.

The same considerations apply for order records logged, to output an internal order, also for dates used to decide, which sales to include in a monthly statement or invoice.

2 Financial accounting program:

“Transient data” are account movement records and the changes to account records and to fixed asset records.

Each account movement record needs a date, for the financial accounting program to decide, in which monthly profit & loss statement or in which balance sheet it must be included.

Each change to an account record or to a fixed asset record needs a date to tell, when the change was effective.

3 Stock control program:

“Transient data” are stock movement records and the changes to product records, to supplier records and to warehouse records.

Each stock movement record needs a date, to indicate when the stock item was actually moved in or out of the warehouse. The stock control program uses this date to provide movement reports for each stock item and monthly movement totals.

4 Manufacturing control program:

“Transient data” are stock movement records and the changes to product records and to supplier records.

Each stock movement needs a date, to indicate when the stock item was actually moved in or out of the warehouse.

Each process record needs a date, to indicate, when the process step was actually started or completed.

The manufacturing control program uses this date to provide movement reports for each stock item, monthly movement totals, monthly manufacturing totals.

5 Property valuation program:

“Transient data” are property records, property part records, property part value modifier records and the changes to property owner records.

For the USER to track, when a property record, owner record, property part record, or property part value modifier record was created or was updated, the property valuation program must store in the database the date, when a record was created/updated.

Only if a correct date is stored, is it possible to verify, whether a certain computer record is current, or whether it appears to be outdated and must be checked before being used.

6 Marketing support program:

“Transient data” are contact records and the changes to prospective customer's records and to customer records.

To allow the USER to track, when a prospective customer's record, a customer record, a contact record was created or was updated, the marketing support program must store in the database the date, when a record was created/updated.

Only if a correct date is stored, is it possible to verify, whether a certain computer record is current, or whether it appears to be outdated and must be checked before being used, or whether it may be deleted.

7 Fax/e-mail program:

“Transient data” are incoming and outgoing faxes and e-mails and the changes to the address books.

To allow the USER to track, when a fax or e-mail record was created or was updated, that is, when a fax or e-mail was sent or was received, the fax/e-mail program must store in the database the date, when a record was created/updated.

Only if a correct date is stored, is it possible to verify, when a fax or e-mail was sent or was received, or whether it is old and may be deleted.

8 Calendar/scheduling program:

“Transient data” are the calendar and schedule entries and the changes to the names of the people who share the calendar or the schedule.

An entry in a calendar or in a schedule requires per definition a date associated with it. Only if a correct date is stored, the program fulfills its basic purpose at all.

9 Payroll program:

“Transient data” are the salary records and the changes to employee records.

Each salary record needs a date, for the payroll program to decide, in which monthly salary report it must be included. Each employee record needs a date to indicate when it was created or was updated last time.

10 Equipment maintenance control program:

“Transient data” are the equipment maintenance records and the changes to the equipment records.

Each equipment maintenance record needs a date, for the USER to track, when the equipment was maintained. This is essential information for proper maintenance, therefore, storing proper dates is a basic purpose of such a program.

To allow the USER to track, when an equipment record was created or was updated, the equipment maintenance control program must store in the database the date, when a record was created/updated.

Only if a correct date is stored, is it possible to verify, whether a certain computer record is current, or whether it appears to be outdated and must be checked before being used, or whether it may be deleted.

11 CAD program:

“Transient data” are the changes to the drawings and to the stock objects (the changes as such usually not being stored).

To allow the USER to track, when a drawing/stock object was created or was updated, the CAD program must store in the database the date, when it was created/updated.

Only if a correct date is stored, is it possible to verify, whether a drawing/stock object record is current, or whether it appears to be outdated and must be checked before being used, or whether it may be deleted.

12 Disk operating subsystem program:

“Transient data” are the changes to the combination of file allocation table, directory entries, files and folders (the changes as such usually not being stored).

A disk operating subsystem program requires a current date, in order to store with each directory entry the time, when it (respectively the associated file or folder) was created, or when it was updated last time.

When the disk operating subsystem program is started, it asks the USER for the current date, or it lets the USER confirm the current date obtained from the computer hardware.

However, it doesn't accept any date prior to the “start date”, nor does it accept any date later than, for example, 2.5 months after the start date.

If the USER wants his/her files to be marked with the correct date, the disk operating subsystem program must have the correct current date set.

Part two (of two) of the method is, that in the date stored with the “transient data” and “basic data”, at least month and day must be correct, to be of any use, even if some USERs wouldn't need a correct year in the date.

Please refer to drawing D05-01 for an explanation how a USER, who doesn't care about the year part of the date, can steal “paid records”.

As shown in this drawing, a “serial number” of the COMPUTER DATABASE changes every time, when “additional paid records” are added, to a new, unique value.

This changing of the “serial number” is the method included in this invention to reduce theft of “additional paid records” by copying to a minimum. See also explanation from #257.

To make sure, that each USER must order ADDITIONAL PAID RECORDS to the DEVELOPER at least once per calendar year, the DEVELOPER must (see drawing D05-02)

set the absolute difference between the maximum number of “paid records” M storable in a COMPUTER DATABASE and a constant number Z to less than the product of number of time units, which fit into six calendar months, times the minimum consumption of “paid records” per time unit A, and

set the length of the “date window” D to less than six calendar months.

For example, if the time unit is one month, the minimum consumption per time unit is 1000 per one month and Z is zero, then the maximum number of “paid records” must be set to less than 6000.

If the maximum number of “paid records” is set according to this rule, then each USER is forced to obtain “additional paid records” before one calendar year ends.

In other words, no USER can work through an entire calendar year using “paid records”, which he/she has stolen by making a copy of his/her COMPUTER DATABASE and of ADDITIONAL PAID RECORDS.

When the USER finally has to order ADDITIONAL PAID RECORDS to the DEVELOPER, the DEVELOPER has a method to detect, that a PAID RECORDS data item was copied (see below, from #948).

Ad 3 “meaningful only to, or confidential for, the USER” (see drawing D10):

“Meaningful only to, or confidential for, the USER” is a necessary condition,

in order to eliminate the possibility, or to make it at least as unattractive as possible for a USER, to make a copy of the COMPUTER DATABASE and to give the copy to USERs of other copies of the same program in order to steal “paid records”.

(In drawing D10 referred to as “Initial copying by a USER for a different private USER or a different company USER”) Because the COMPUTER DATABASE contains the PAID RECORDS data item, USERs could attempt to make copies of the COMPUTER DATABASE, and then give the copies to other USERs, in order for them to use the “paid records” as well, without actually paying.

However, if the COMPUTER DATABASE is “meaningful only to, or confidential for, the USER”,

replacing the COMPUTER DATABASE of a USER X with the copy of a COMPUTER DATABASE of another USER Y destroys all the inputs made by USER X, replacing them with data, which may be meaningless to the USER X.

In case the COMPUTER DATABASE of USER Y is confidential, USER Y is expected to not make copies for other USERs and to guard his/her COMPUTER DATABASE.

The invention includes four methods to promote, that the COMPUTER DATABASE of a USER, is “meaningful only to, or confidential for, the USER”:

Method 1:

The COMPUTER DATABASE contains an “installation number”, which the DEVELOPER sends to a USER's COMPUTER DATABASE at the time, when the USER orders ADDITIONAL PAID RECORDS for this COMPUTER DATABASE for the first time.

After that, this “installation number” is required for the USER to obtain ADDITIONAL PAID RECORDS.

This “installation number” never changes except the USER initializes (i.e. makes completely empty) the COMPUTER DATABASE.

The DEVELOPER uses this “installation number” to bill a USER.

That means, if a USER X makes copies of his/her COMPUTER DATABASE for other USERs, who use it without initializing it, USER X is billed by the DEVELOPER for ADDITIONAL PAID RECORDS, which other USERs order.

Therefore, this “installation number” can be regarded as confidential for each USER.

Method 2:

Whenever the USER changes his/her “identification” stored in the COMPUTER DATABASE, the COMPUTER PROGRAM COPY reduces the amount of available “paid records” to zero.

That means, if a USER takes a copy of a COMPUTER DATABASE from another USER, and then changes the “identification” to his own, all the “paid records” are lost, therefore, there's no gain in obtaining a copy of a COMPUTER DATABASE from another USER.

The exact algorithm is described in step 3 (from #703).

The “identification” must allow to distinguish each COMPUTER DATABASE unequivocally. That means:

If the COMPUTER PROGRAM COPY is expected to manage one single COMPUTER DATABASE for one company, then for “identification” only the name of the company is required.

If the COMPUTER PROGRAM COPY is expected to manage one COMPUTER DATABASE for each branch office of a company, then for “identification” the name of the company and name of the branch office are required.

If the COMPUTER PROGRAM COPY is expected to manage one COMPUTER DATABASE for each employee or each computer of a company, then as “identification” the name of the company, name of the branch office and name of the employee or machine number are required.

In case of private USERs, “identification” must contain name and address or name and telephone number.

The program must make it as attractive as possible to the USER to input a correct identification, for example, by marking output (on-screen or printed) of the program or data stored in the COMPUTER DATABASE with this identification.

This method is mainly targeted at companies, where a COMPUTER DATABASE may be copied for several branch offices or several employees/computers, in order to steal “paid records”.

If, for example, one branch office of a company copies a COMPUTER DATABASE for another branch office, then if the other branch office sets the branch name in the COMPUTER DATABASE, all copied “paid records” are gone.

(In drawing D10 referred to as “Copying by a USER for branch offices or employees/computers of USER's company”)

Method 3:

The data, which are part of the PAID RECORDS data item, their relationship to each other and their effect on the use of the COMPUTER PROGRAM COPY make it difficult for the USER to figure out whether he/she gains or looses by obtaining a copy of a COMPUTER DATABASE containing stolen “paid records”.

(The exact description of the parts of the PAID RECORDS data item follows in the second part of step 1, from #238, which describes how to merge it with the COMPUTER DATABASE.)

PAID RECORDS contains information about how a USER of a COMPUTER PROGRAM COPY is billed, namely a setting of how many “paid records” are to be consumed at least per time unit, and of how many “paid records” can be stored in the COMPUTER DATABASE at most.

So, before obtaining a COMPUTER DATABASE containing stolen “paid records”, a USER has to figure out, whether the billing settings in this COMPUTER DATABASE fit to his/her usage pattern.

This method is mainly targeted at companies, where a COMPUTER DATABASE may be copied for several branch offices or for several employees/computers, in order to steal “paid records”.

For example, if there are several branch offices with a different average monthly consumption of “paid records”, copying a COMPUTER DATABASE from a branch with a higher consumption to a branch with a lower consumption results in no gain.

Copying a COMPUTER DATABASE from a branch with a lower consumption to a branch with a higher consumption results in higher cost per one “paid record” for the branch with the higher consumption,

in case the DEVELOPER links price per “paid record” with minimum consumption per month. Therefore, again no gain by copying a COMPUTER DATABASE.

The PAID RECORDS data item contains a “start date”, which defines the start of a “date window”, within which the COMPUTER PROGRAM COPY can work.

Changing the “start date” costs “paid records” according to the minimum consumption per time unit setting in the PAID RECORDS data item.

So, before obtaining a COMPUTER DATABASE containing stolen “paid records”, a USER has to figure out, whether after changing the start date to the value, which he/she needs, any gain in “paid records” is left.

Method 4:

The DEVELOPER sets in the COMPUTER PROGRAM COPY the charges for certain tasks in such a way, that a USER, who obtains a copy of a COMPUTER DATABASE containing stolen “paid records”, has high cost to enter those data, which he/she actually needs to keep.

Those data, which need to be kept in order to be able to use the COMPUTER PROGRAM COPY, are called “basic data”.

In case a copy of a COMPUTER DATABASE from another USER contains no data, which are of use for the USER, who obtains the copy, this USER has to input some “basic data”, in order to start working, or to continue working.

In case a copy of a COMPUTER DATABASE from another USER contains data, which are (e.g. during browsing and searching) a hindrance for the USER, who obtains the copy, this USER has to delete those data, in order to start working, or to continue working.

The idea is, to charge the USER

for adding such “basic data” in relation to the current number of available “paid records”, which are stored in the COMPUTER DATABASE,

precisely, the cost of adding “basic data” is calculated as the current number of available “paid records” times a factor x times the ratio of the number of records to be added and the sum of number of records to be added times a factor y and the current number of records in the database times a factor z,

or the current number of records in that part of the database, which the added records belong to times a factor z,

in formula language: cost=P * x * n/(y * n+z * c), with

x larger than zero and smaller than or equal to one,

y larger than zero and smaller than ten,

z larger than zero and smaller than ten,

the inventor thinks that using x=1, y=1.1 and z=1 is best, for deleting such “basic data” in relation to the maximum number of available “paid records”, which can be stored in the COMPUTER DATABASE,

precisely, the cost of deleting “basic data” is calculated as the maximum number of available “paid records” times a factor x times the ratio of the number of records to be deleted and the current number of records in the database,

or the current number of records in that part of the database, which the deleted records belong to,

in formula language: cost=|M−Z|* x * n/c, with

x larger than zero and smaller than or equal to one, the inventor thinks that using x=1 is best, with

P: current number of “paid records”, i.e. the absolute difference between the “number” part of the PAID RECORDS data item and the limit used to decide whether to grant or whether to deny permission to execute certain tasks

M: the “maximum number” part of the PAID RECORDS data item

Z: a fixed constant number

n: number of records of “basic data” to be added or to be deleted

c: total of number of records of “basic data” in the database or in that part of the database, the added or deleted records belong to.

This method works only, in case the USER needs at least a few hundred items (e.g. records, files) of “basic data” in the COMPUTER DATABASE:

E.g. a USER obtains a COMPUTER DATABASE containing stolen “paid records” and 1,000 useless items of “basic data”, so that the USER can enter 100 items of his/her useful “basic data” without having too much loss (according to the formula of #196).

In this case the 1,000 useless items certainly are a hindrance during browsing or searching for the 100 useful items in the database. However of there were just 10 items of useful data to browse for, the 1,000 useless items are not such a big hindrance.

In any case, if a USER deletes the useless items, shell be charged according to the formula of #200.

Therefore, for COMPUTER DATABASEs with at least a few hundred useful items “of basic data”, this method can be regarded as a strong prevention of “repeated copying by a USER for a different private USER or a different company USER” (drawing D10).

What is meant with “basic data” shall be described for twelve types of programs (see drawing D07):

1 Sales control program:

“Basic data” are customer data, delivery point data and product data.

2 Financial accounting program:

“Basic data” are the accounts and the fixed assets.

3 Stock control program:

“Basic data” are the product data, the warehouse data and the supplier data.

4 Manufacturing control program:

“Basic data” are the product data and the supplier data.

5 Property valuation program:

“Basic data” are property owner data.

6 Marketing support program:

“Basic data” are prospective customer data and customer data.

7 Fax/e-mail program:

“Basic data” are the records of e-mail addresses or the records of fax numbers (the so-called address books or phone books)

8 Calendar/scheduling program:

“Basic data” are the records of names of people who share the calendar or the schedule.

9 Payroll program:

“Basic data” are the employee records.

10 Equipment maintenance control program:

“Basic data” are the equipment records.

11 CAD program:

“Basic data” are the drawings and the stock drawing objects.

12 Disk operating subsystem program:

“Basic data” are the combination of file allocation table, directory entries, files and folders.

In addition to that, the invention includes a method to find out, whether for a copied COMPUTER DATABASE “additional paid records” are ordered to the DEVELOPER (see drawing D03):

Whenever the COMPUTER PROGRAM COPY adds “additional paid records” to the COMPUTER DATABASE, it replaces a “copy number” stored in the COMPUTER DATABASE with a “serial number” stored there, and it changes the “serial number” to a new, unique value.

Before the DEVELOPER sends out “additional paid records” for a certain COMPUTER DATABASE, the DEVELOPER requests this “serial number” and “copy number” and a “installation number” from the USER.

The DEVELOPER then records this “serial number”, “copy number” and “installation number”, and marks the ADDITIONAL PAID RECORDS with this particular “serial number”, “copy number” and “installation number”.

If for a particular “copy number” more than once an order for “additional paid records” was received, the COMPUTER DATABASE containing this “copy number” was copied, possibly containing usable “paid records”.

The exact algorithm how the DEVELOPER checks the record of “serial numbers” and “copy numbers” for an estimate of a revenue loss by copying is described in step 4 below (from #948).

Regarding step 1, the question how to merge the PAID RECORDS data item with the COMPUTER DATABASE:

A data item called PAID RECORDS must be stored INSEPARABLE from the COMPUTER DATABASE.

PAID RECORDS means a data item, which is

1 modified on request of commands, which are part of the COMPUTER PROGRAM COPY, when the COMPUTER PROGRAM COPY executes commands to modify the COMPUTER DATABASE, and

2 used by the COMPUTER PROGRAM COPY to decide whether to perform certain types of operations.

PAID RECORDS consists of the parts (see drawing D06)

1 number

2 serial number,

3 copy number (option C),

4 installation number,

5 identification,

6 start date,

7 number on start date,

8 addition since start date,

9 minimum consumption per time unit,

10 maximum number.

Explanation of the parts of PAID RECORDS:

ad 1, the “Number” Part (See Drawing D08).

A 4-byte integer number works.

This number is changed by a certain amount towards a limit whenever the COMPUTER PROGRAM COPY completes certain tasks, and this number is compared with that limit by the COMPUTER PROGRAM COPY to decide, whether to perform certain tasks.

See from #643, from #703, from #717 and from #745 for the exact algorithms to change the “number” part of PAID RECORDS.

See from #727 for the exact algorithm to decide from the “number” part of PAID RECORDS whether to perform certain tasks.

ad 2, the “Serial Number” part.

An 8-byte date number, consisting of year, month, day, hour, minute, second, works in most cases, except when there are very many COMPUTER PROGRAM COPIES expected to be put to use. In this case a combination of an 8-byte date and a 4-byte number works.

This “serial number” is used to identify the COMPUTER DATABASE, and therefore indirectly the USER of the COMPUTER PROGRAM COPY when adding “additional paid records” to the database (see #750 and from #803).

Whenever the COMPUTER PROGRAM COPY adds “additional paid records” to the COMPUTER DATABASE, it changes this “serial number” to a new, unique number (see #774 and #837).

Whenever the COMPUTER PROGRAM COPY initializes the COMPUTER DATABASE or changes the “identification” part of PAID RECORDS, it sets the “serial number” to a new, unique number (see from #643 and from #703).

This is to prevent the following (see drawing D05-01):

A USER X could attempt for a COMPUTER PROGRAM COPY, which requires no USER name nor company name to be useful:

Install the COMPUTER PROGRAM COPY, then, before storing any important data in the COMPUTER DATABASE, buy and store in the COMPUTER DATABASE the maximum number of “paid records”, which can be stored in the COMPUTER DATABASE.

Next, make many copies of the COMPUTER DATABASE, and distribute those copies to other USERs who are also just starting to use a COMPUTER PROGRAM COPY, having no important data in their COMPUTER DATABASEs yet either.

After that, the USERs, who got a copy of the COMPUTER DATABASE of USER X, use the COMPUTER PROGRAM COPY, consuming the (stolen) PAID RECORDS their COMPUTER DATABASEs contain.

(They can consume the maximum number of “paid records” storable in the COMPUTER DATABASE, in case they don't set their identification in PAID RECORDS, as explained below under step 3, from #703.)

At some time, each USER needs “additional paid records” to continue to use the COMPUTER PROGRAM COPY. Now USER X may order to the program DEVELOPER some “additional paid records”, using the “serial number” in his COMPUTER DATABASE.

Before adding the “additional paid records” to his COMPUTER DATABASE, USER X makes copies of the “additional paid records” for distribution to the other USERs.

This is possible, in case “additional paid records” are delivered on storage media, which the USER can make copies of.

Those other USERs then can add those (stolen) copies of “additional paid records” to their COMPUTER DATABASES.

That's in case of USERs who don't set their identification in PAID RECORDS.

However, now, the COMPUTER PROGRAM COPY changes the “serial number” of each COMPUTER DATABASE to a new, unique number, therefore, further theft is not possible with this method.

So, the term, during which twice the maximum number of “paid records” are consumed by the USERs, is to be regarded by the DEVELOPER as trial period. USERs who have come to like the program during that term are expected to come and pay up.

Below under step 2 (from #597), the formula of the relationship between “minimum consumption per time unit”, “maximum number” and the length of the trial period is described.

ad 3: the “Copy Number” Part.

Data type must be same as the “serial number” part, see 2 above (#252), for instance an 8-byte date. Only used in case copy detection and loss estimation is done, see #641, from #803 and #948.

Whenever the COMPUTER PROGRAM COPY adds “additional paid records” to the COMPUTER DATABASE, it replaces the “copy number” part of PAID RECORDS with the “serial number” part (see #773 and #836).

Whenever the COMPUTER PROGRAM COPY initializes the COMPUTER DATABASE, it sets the “copy number” to a new, unique number (see #649).

This is done for the DEVELOPER to be able to find out, whether a USER used stolen “paid records”, or even used stolen “paid records” and stolen “additional paid records”, in the following way (also see drawing D03): When a USER requests “additional paid records”, he/she must give to the DEVELOPER both “serial number” and “copy number”.

The DEVELOPER records both numbers in order to estimate the loss from copying PAID RECORDS and ADDITIONAL PAID RECORDS. See step 3 below (from #803) for an exact description.

ad 4: the “Installation Number” Part

A 4-byte integer number works.

This number is set to a special initial value, when the USER installs the COMPUTER PROGRAM COPY or initializes the COMPUTER DATABASE. See from #643.

When the DEVELOPER gets the first order of ADDITIONAL PAID RECORDS from the USER, the DEVELOPER creates a unique, new number and sends it together with the ADDITIONAL PAID RECORDS to the USER. See from #745.

ad 5: the “Identifications Part

Three strings of 48 bytes each, for name, company name and machine number. The exact number of bytes is not important. However it must be large enough to distinguish USERs with similar names.

See above from #166 for the exact requirements for the “identification” part.

ad 6: the “Start Date” Part

An 8-byte date value, consisting of 4-digit year, month and day, or any compressed value containing this information, is enough.

As described above (from #067), under the explanation of the meaning of “changed in an ongoing way”, this date marks the first date, which the COMPUTER PROGRAM COPY accepts as input at any given time.

The setting of this value is compulsory for any USER, who wants the COMPUTER PROGRAM COPY to process and to store data with the correct date associated.

ad 7: the “Number on Start Date” Part

This must be the same data type as the “number” part, see 1 above (#247), for instance a 4-byte integer.

The COMPUTER PROGRAM COPY sets this value when the USER requests to change the “start date”. See step 3 below (from #686) for an exact description.

ad 8: the “Addition Since Start Date” Part

Data type must be compatible with the “number” part, see 1 above (#247), for instance a 4-byte integer number.

The COMPUTER PROGRAM COPY sets this value when the USER requests to change the “start date” and when “additional paid records” are added. See step 3 below (from #686 and #772) for an exact description.

ad 9: the “Minimum Consumption per time Unit” Part

A 4-byte integer is enough.

This number is set by the DEVELOPER according to assumptions made about the use of each COMPUTER PROGRAM COPY. See step 2 below (from #568) for the calculations related to this value.

It is used by the COMPUTER PROGRAM COPY to modify the “number” part of PAID RECORDS during it changes the “start date” part on request of the USER. See step 3 below (from #686) for an exact description.

ad 10: the “Maximum Number” Part

Data type must be compatible with the “number” part, see 1 above (#247), for instance a 4-byte integer.

This number is set by the DEVELOPER according to assumptions made about the use of each COMPUTER PROGRAM COPY. See step 2 below (from #597) for the calculations related to this value.

It is used by the COMPUTER PROGRAM COPY during adding “additional paid records” to the COMPUTER DATABASE. See step 3 below (from #758) for an exact description.

| Totalling the size: | |
|---|---|
| “number” | 4 bytes |
| “serial number” | 8 bytes |
| “copy number” | 8 bytes |
| “installation number” | 4 bytes |
| “identification” | 144 bytes |
| “start date” | 8 bytes |
| “number on start date” | 4 bytes |
| “addition since start date” | 4 bytes |
| “minimum consumption per time unit” | 4 bytes |
| “maximum number” | 4 bytes |
| total | 192 bytes |

So, in total, the size of PAID RECORDS is about 192 bytes. This amount of data has to be INSEPARABLY LINKED with the COMPUTER DATABASE.

INSEPARABLY LINKED means with regard to COMPUTER DATABASE and PAID RECORDS,

that, in case the COMPUTER DATABASE consists of several files, PAID RECORDS is stored in a file, which contains that type of “basic data” with the highest number of items,

(e.g. in case of a sales control program, if there are 10 customers and 1000 products to store, PAID RECORDS must be linked to the file, to the disk volume or to the storage facility containing the products data)

that, in case the COMPUTER DATABASE consists of several disk volumes, PAID RECORDS is stored in a disk volume,

which contains that type of “basic data” with the highest number of items,

(e.g. in case of a disk operating subsystem, PAID RECORDS must be linked to the volume where the operating subsystem program files are stored, because this number of files is known to the DEVELOPER and necessary for any USER)

that, in case the COMPUTER DATABASE consists of several storage facilities, PAID RECORDS is stored in a storage facility, which contains that type of “basic data” with the highest number of items,

that the particular file, disk volume or storage facility containing the PAID RECORDS data item is

1 being changed in an ongoing way during the entire usage term of a COMPUTER PROGRAM COPY by the COMPUTER PROGRAM COPY,

2 meaningful only to, or confidential for, the USER, that the COMPUTER PROGRAM COPY is the only means, which the DEVELOPER makes available to the USER,

to make meaningful copies of parts of the combination of COMPUTER DATABASE and PAID RECORDS or to delete meaningful parts of the combination of COMPUTER DATABASE and PAID RECORDS.

The danger for the DEVELOPER is, that the USER finds out, at which offset of the file, disk volume or storage facility, which stores the COMPUTER DATABASE or a part of it, the PAID RECORDS data item is stored, and how many bytes it uses.

(See drawing D04 and from #039 for the meaning of “offset”).

After having found this out, the USER could write a simple program, which reads the PAID RECORDS data item from this offset, stores it somewhere, and then puts it back, when the USER needs new “paid records”.

There are two methods to solve this problem:

1 When a COMPUTER PROGRAM COPY (1) is installed, it creates a COMPUTER DATABASE, which contains the parts of PAID RECORDS at offsets, which are different from the offsets used when a COMPUTER PROGRAM COPY (2) is installed.

2 During the use of a COMPUTER PROGRAM COPY, the offsets of the parts of PAID RECORDS within the COMPUTER DATABASE change according to a rule, which the DEVELOPER doesn't make known to the USER.

When method 1 is used, each USER has to find out for his own COMPUTER DATABASE where all the parts of the PAID RECORDS data item are stored, e.g. by inflicting damage to the COMPUTER DATABASE and watching the reaction of the COMPUTER PROGRAM COPY.

Although this is already very time-consuming and costly (in case the size of the COMPUTER DATABASE is large compared to the size of PAID RECORDS), after having found the offsets out, the USER could use the COMPUTER PROGRAM COPY for free.

When method 2 is used, the USER has to find out anew from time to time, where the parts of the PAID RECORDS data item have gone.

This is practically impossible, in case the time interval between such changes is shorter than the time interval required to find the PAID RECORDS data item. Three concrete methods to INSEPARABLY LINK the COMPUTER DATABASE and the PAID RECORDS shall be described:

1 For a COMPUTER PROGRAM COPY and COMPUTER DATABASE, which are created using a programming environment, which allows to put several separate data items into one computer file, lock the file and encrypt the file,

the format of the file being only known to the supplier of the programming environment.

2 For a COMPUTER PROGRAM COPY called “disk operating subsystem”, which manages a COMPUTER DATABASE, which is a combination of file allocation table (FAT), directory entries, files and folders, similar to DOS or to MS-Windows.

3 For a COMPUTER DATABASE, where the DEVELOPER has sole control of, and doesn't publish, the format of the COMPUTER DATABASE.

Ad 1:

Using a programming environment, which allows to put several data items into one disk file, allows to set password-protected access permissions to the items in the file and allows to encrypt the file, like Microsoft Access.

In the wording used by MS-Access manuals, the DEVELOPER needs to do the following:

Establish “user-level security”, and create three users, called for instance “Programmer”, “Normal” and “System”, each with its own, distinct password.

Give to user “Programmer” all permissions for all objects (databases, tables, queries, forms, reports, macros and modules).

Give to user “Normal” open permission for databases, read- only permissions for tables and queries, “execute-only permissions for forms, reports, macros and modules.

Give to user “System” open permission for databases, read- write permissions for all tables and queries, no permissions for all other objects.

Make sure, that all other users, which may be defined, don't have any permission for any objects, neither directly nor through membership in groups nor through ownership of objects.

Log in as “Programmer” and do all the following work in that session.

Create a MDB file to contain the COMPUTER DATABASE, and another MDB file to contain the COMPUTER PROGRAM COPY and another MDB file to contain ADDITIONAL PAID RECORDS.

Create all tables required for the database in the MDB file prepared for the COMPUTER DATABASE.

Before creating the tables for PAID RECORDS, put some data into each of the tables of the COMPUTER DATABASE. This is important to make it as difficult as possible for the USER to find out the offset(s), at which PAID RECORDS is stored within the MDB file.

Create in that same file the tables required for PAID RECORDS, then set for user “Normal” permissions to None.

That means, user “Normal” can not even open PAID RECORDS and read it without using code contained in the COMPUTER PROGRAM COPY.

(User “Normal” also can not read the names of the fields in the tables used for PAID RECORDS.)

At this point, PAID RECORDS is stored in a MDB file together with the COMPUTER DATABASE, and not even the DEVELOPER knows the offset(s) of the MDB file, where PAID RECORDS is stored. (These offsets are calculated by the programming environment.)

Create in the file prepared for ADDITIONAL PAID RECORDS the required tables, then set for user “Normal” permissions to None. That means, user “Normal” can not even open nor read those tables without using code contained in the COMPUTER PROGRAM COPY.

(User “Normal” also can not read the names of the fields in the tables used for ADDITIONAL PAID RECORDS.)

Create in the MDB file prepared for the COMPUTER PROGRAM COPY all the queries, forms, reports, macros and modules required for the program.

The modules, which modify the tables in the COMPUTER DATABASE, PAID RECORDS and ADDITIONAL PAID RECORDS, must contain the password of user “System” in order to start a session using that password.

The DEVELOPER must make sure, that those modules do not publish this password, nor publish any function, which starts a public session using that password without closing it before return, nor publish any function, which modifies table access permissions.

Finally, the three MDB files must be encrypted using the function, which MS-Access provides for that purpose, to prevent USERs from using special tools to modify meaningfully the data contained in the files.

The functions, which modify the COMPUTER DATABASE and PAID RECORDS or ADDITIONAL PAID RECORDS must do this within one single transaction, to make sure, that all prescribed changes are saved completely. (The required functions are described further down.)

Each distributed COMPUTER PROGRAM COPY must include:

a copy of the MDB file, which contains the COMPUTER PROGRAM COPY

a copy of the MDB file, which contains COMPUTER DATABASE and PAID RECORDS

or, alternatively, the COMPUTER PROGRAM COPY to contain code, which creates an MDB file containing COMPUTER DATABASE and PAID RECORDS,

the password of user “Normal” in order for the USER to log into MS-Access

and the MDA or MDW file containing encryption keys, usernames and passwords in encrypted form.

During the USER works with the COMPUTER PROGRAM COPY, adding data, changing data and deleting data in the COMPUTER DATABASE, the offset(s) of PAID RECORDS change(s) (at least) every time,

the COMPUTER PROGRAM COPY compacts the MDB file, which contains the COMPUTER DATABASE, to a value, which depends on the amount and the kind and size of data contained in that MDB file. They might also change, when PAID RECORDS is changed.

Ad 2:

For a program called “disk operating subsystem”, which manages a COMPUTER DATABASE, which is a combination of file allocation table (FAT), directory entries, files and folders, similar to DOS or to MS-Windows.

For the purpose of merging the FAT with PAID RECORDS, the FAT stores in each record

1 a “marker” of 1 byte which tells the meaning of the record (is it cluster information or PAID RECORDS information?),

2 a “field 1” of 3.5 byte, containing a cluster number in case the record contains cluster information, a part of PAID RECORDS in case the record contains that information,

3 a “field 2” of 3.5 byte, containing cluster contents information (unused, bad, reserved, number of next cluster in chain) in case the record contains cluster information, a part of PAID RECORDS in case the record contains that information,

This makes 8 bytes per record; for a hard disk, which has 2,097,152 clusters, the whole FAT is therefore 16,777,216 bytes plus 507,656 bytes for PAID RECORDS, in case for each 1024 clusters, except one block of 1024 clusters, one PAID RECORDS data item is stored, as explained below:

The “marker” is:

0, in case the record contains cluster information,

1, in case record contains the “number” part of PAID RECORDS,

2, in case record contains part 1 of “serial number” part of PAID RECORDS,

3, in case record contains part 2 of “serial number” part of PAID RECORDS,

4, in case record contains part 1 of “copy number” part of PAID RECORDS,

5, in case record contains part 2 of “copy number” part of PAID RECORDS,

6, in case record contains part 1 of “identification” part of PAID RECORDS,

7, in case record contains part 2 of “identification” part of PAID RECORDS,

8 , in case record contains part 3 of “identification” part of PAID RECORDS,

9 , in case record contains part 4 of ““identification” part of PAID RECORDS,

10, in case record contains part 5 of “identification” part of PAID RECORDS,

11, in case record contains part 6 of “identification” part of PAID RECORDS,

12, in case record contains part 7 of “identification” part of PAID RECORDS,

13, in case record contains part 8 of “identification” part of PAID RECORDS,

14, in case record contains part 9 of “identification” part of PAID RECORDS,

15, in case record contains part 10 of “identification” part of PAID RECORDS,

16, in case record contains part 11 of “identification” part of PAID RECORDS,

17, in case record contains part 12 of “identification” part of PAID RECORDS,

18, in case record contains part 13 of “identification” part of PAID RECORDS,

19, in case record contains part 14 of “identification” part of PAID RECORDS,

20, in case record contains part 15 of “identification” part of PAID RECORDS,

21, in case record contains part 16 of “identification” part of PAID RECORDS,

22, in case record contains part 17 of “identification” part of PAID RECORDS,

23, in case record contains part 18 of “identification” part of PAID RECORDS,

24, in case record contains part 19 of “identification” part of PAID RECORDS,

25, in case record contains part 20 of “identification” part of PAID RECORDS,

26, in case record contains the “installation number” part of PAID RECORDS,

27, in case record contains the “start date” part of PAID RECORDS,

28, in case record contains the “number on start date” part of PAID RECORDS,

29, in case record contains the “addition since start date” part of PAID RECORDS,

30, in case record contains the “minimum consumption per time unit” part of PAID RECORDS,

31, in case record contains the “maximum number” part of PAID RECORDS.

That is, one PAID RECORDS data item takes 31 records in the FAT. The numbers 1 through 31 can be assigned to other parts of the PAID RECORDS data item as well, also less than 31 records may be used, without impact to the merging algorithm below.

When the disk operating subsystem creates a partition with such a FAT, it must put the records on the storage media in an order, which is not in consecutive sequence of cluster number, in other words: the record for cluster 0 must not be followed necessarily by the record for cluster 1, the record for cluster 1 must not be followed necessarily by the record for cluster 2 and so on.

Rather, a random sequence of cluster numbers must be created and stored, when the FAT is created.

To achieve this, the disk operating subsystem does the following:

1 Find out the total number of clusters on the disk, then divide this number by 1024, the result is the “number of cluster blocks”. Allocate RAM of 1055 times 8 bytes, for 1024+31 records of 8 bytes each, the “current block”.

2 Set 0 as the “start of current blocks.

3 Make record 0 the “current record”.

4 Create one random number between 0 and 1023+31 (because one PAID RECORDS data item uses 31 records), the “current number”.

5 Check, if the “current number” is “used”: Do for each record in the “current block”, until “current number” is found to be ““used” or until the record before the “current record” has been checked:

if “marker” is 0, compare “current number” and “field 1” minus “start of current block”, if equal, then “current number” is “used”.

if marker is not equal 0, compare “current number” and “marker” minus (“start of current block” divided by 32) plus 1023, if equal, “current number” is “used”.

6 If the “current number” is “used”, continue from step 4.

7 If the “current number” is not “used” and smaller than 1024, set in the “current record” field “marker” to 0 and “field 1” to “current number” plus “start of current block”, this is the cluster number.

8 If the “current number” is not “used” and larger than 1023, mark the “current record” as part of a PAID RECORDS data item, by setting “marker” to “current number” minus 1023 plus (“start of current block” divided by 32) and field 1” to 0.

9 Continue from step 4 with the next “current record”, which is “current record” plus 1 until 512 records are filled (“current record” is 512).

Then continue as follows:

10 Make record 513 the “current record”.

11 Set 0 as “current number”.

12 Check, if the “current number” is “used”:

Do for each record in the “current block”, until current number” is found to be “used” or until the record before the “current record” has been checked:

if “marker” is 0, compare “current number” and “field 1” minus “start of current block”, if equal, then “current number” is “used”,

if marker is not equal 0, compare “current number” and “marker” minus (“start of current block” divided by 32) plus 1023, if equal, “current number” is “used”.

13 If the “current number” is “used”, continue from step 12 with the next “current number”, which is “current number” plus 1.

14 If the “current number” is not “used” and smaller than 1024, set in the “current record” field “marker” to 0 and “field 1” to “current number” plus “start of current block”, the cluster number.

15 If the “current number” is not “used” and larger than 1023, mark the “current record” as part of a PAID RECORDS data item, by setting “marker” to “current number” minus 1023 plus (“start of current block” divided by 32),

16 Continue from step 12 with the next “current number”, which is “current number” plus 1, and the next “current record”, which is “current record” plus 1, until all positions from 0 to 1023+31 are filled, that is, “current record” is 1054.

17 Set in each record “field 2” to 0, then encrypt each record separately and store the result on disk, this is 1055 records of 8 bytes each, starting from offset (“start of current block” divided by 1024 times 1055 times 8).

Then continue as follows:

18 Set 1 as the “start of current block”.

19 Make record 0 the “current record”.

20 Set 0 as “current number”.

21 If the “current number” is smaller than 1024, set in the “current record” field “marker” to 0 and “field 1” to “current number” plus “start of current block”, the cluster number.

22 If the “current number” is larger than 1023, mark the “current record” as unused, by setting “marker” to FFFF.

23 Continue from step 21 with the next “current number”, which is “current number” plus 1, and the next “current record”, which is “current record” plus 1, until all positions from 0 to 1023+31 are filled, that is, “current record” is 1054.

24 Set in each record “field 2” to 0, then encrypt each record separately and store the result on disk, this is 1055 records of 8 bytes each, starting from offset (“start of current block” divided by 1024 times 1055 times 8).

25 Continue from step 20 with the next “start of current block”, which is “start of current block” plus 1024, until “start of current block” is (“number of cluster blocks” times 1024) minus 1.

Remark Regarding Step 1:

The DEVELOPER can choose to use another number of clusters per cluster block. The larger the number, the more difficult it is to find the parts of PAID RECORDS, and the more time it takes to merge PAID RECORDS into one block.

The smaller the number, the more PAID RECORDS data items the program can offer to other programs.

Remark Regarding Step 10:

From this step onward, the random number generator isn't used any more, in order to save time to merge the cluster block. The DEVELOPER can choose another number but 512 to switch.

The larger the number, the longer it takes to merge the cluster block, however the smaller the probability, that two consecutive clusters are in two consecutive records.

Remark Regarding Step 8:

During creating records for clusters 1024 through 2047, add 32 to the marker of the parts of the PAID RECORDS data item, during creating records for clusters 2048 through 3071 add 64 to the marker of the parts of the PAID RECORDS data item.

For the next block of clusters add 96, and so on. This means, that for each 1024 clusters on the disk, the FAT contains one PAID RECORDS data item.

The disk operating subsystem uses just the one in the first cluster block for itself, the others it can offer to other programs for their billing purposes (see from #857).

The last cluster block with “start of current block” of 2047 can not contain a PAID RECORDS data item, because the marker field can not distinguish it any more.

Remark Regarding Steps 18 to 25:

From the 2nd cluster block onward, cluster records and PAID RECORDS data items are stored in consecutive order of cluster number, with 31 records marked as unused at the end of each block.

This is to save time during partitioning, because merging PAID RECORDS with the cluster records is a time consuming process (possibly several seconds per cluster block).

Doing this for 2048 cluster blocks at once takes hours.

Therefore, when the disk operating subsystem receives a request from another program, it then takes the time to merge cluster records with PAID RECORDS for that cluster block, which is put to use then (see from #857).

In order for the disk operating subsystem to save changes to the FAT quickly to disk, and to find information in the FAT quickly, an index must be in RAM all the time the disk operating subsystem has access to the disk.

For that purpose, when the disk operating subsystem boots such a disk, it has to do the following:

Allocate a contiguous RAM area of number of clusters times 6 bytes, this makes up to 12 MB, as RAM 1.

Allocate a contiguous RAM area for PAID RECORDS, with size 192 bytes plus 31 bytes times 3 (for the offsets of the records where the parts of PAID RECORDS are stored) plus 1 byte for a number of each PAID RECORDS item. This makes up to 585 kB for 2047 PAID RECORDS data items.

Read and decrypt the entire FAT, storing in RAM 1 each cluster number (3 byte, 21 bit used) together with a number calculated as offset of the record in the FAT divided by 8 (3 byte, 22 bit used), in the order they are read.

Sort RAM 1 according to cluster number.

Allocate a contiguous RAM area of number of clusters times 3 bytes, this makes up to 6 MB, as RAM 2.

Move the calculated numbers in the order in which they are now (after sorting) from RAM 1 to RAM 2. Each of these numbers now points to the offset of the FAT on disk, where information for that cluster is stored,

whose number is implied by the offset at which the number is stored in RAM 2.

For instance: If one needs to know where on the disk the information for cluster 5 is stored, one reads the number at offset 5 * 3=15 from RAM 2 and obtains a 3 byte long number.

This number, multiplied by 8, plus 4.5 byte, is the offset at which the information for cluster 5 is stored in the FAT, as a field of 3.5 byte length.

Finally, de-allocate RAM 1.

Now the disk is up. It requires permanently up to 6.6 MB RAM for an index into the FAT, during boot up to 18.6 MB RAM, however this is no problem with today's computer hardware.

Ad 3:

For a program where the DEVELOPER has sole control of, and doesn't publish, the format of the COMPUTER DATABASE.

To merge PAID RECORDS INSEPARABLY with the COMPUTER DATABASE, the DEVELOPER must include in the COMPUTER PROGRAM COPY:

a code, which creates, when the COMPUTER PROGRAM COPY is installed, a file, disk volume or storage facility containing PAID RECORDS and COMPUTER DATABASE, which is several ten times larger than the PAID RECORDS data item, that is, at least several kilobytes,

PAID RECORDS to be stored at an offset (or at offsets), which is (are) not the same for each installation, or

each COMPUTER PROGRAM COPY to be bundled with a file, disk volume or storage facility containing COMPUTER DATABASE and PAID RECORDS of several kilobyte size, and

a code, which runs automatically from time to time during the COMPUTER PROGRAM COPY is used by the USER, and which moves PAID RECORDS within the file, disk volume or storage facility, which contains both PAID RECORDS and COMPUTER DATABASE,

to (a) different offset(s), which depend(s) on the amount and kind and size of data contained in that file, disk volume or storage facility, like an optimization program, which sorts tables and recreates indexes.

This latter code most DEVELOPERs have in their libraries. For better protection, a code must be included, which encrypts some or all data, the method and keys to be chosen by the DEVELOPER.

Regarding step 2: Find out for which services of the program to charge how much, and which services to deny, if there are no “paid records” left.

There are four kinds of charges:

1 the charge for changing the “identification” part of PAID RECORDS, as mentioned above in step 1 (from #162) and described exactly in step 3 below (from #703),

2 the charge for changing “basic data”, as described exactly in step 1 above (from #187),

3 the charge for changing the “start date” part of PAID RECORDS, as mentioned above in step 1 (from #078) and described exactly in step 3 below (from #686),

4 charges for adding “transient data”, the meaning of “transient data” as defined above in step 1 (from #070).

The basic rule regarding charges #4 is:

Changes to the COMPUTER DATABASE, which positively correlate with the benefit a USER has from using the COMPUTER PROGRAM COPY, are balanced with charging “paid records” to the USER.

In other words, setting charges #4 is not an exact science. It is up to the DEVELOPER to decide, what fits best to the program.

The DEVELOPER basically rents a COMPUTER PROGRAM COPY to a USER, like a car rental company rents a car. Charges can be calculated based on the time a USER has a COMPUTER PROGRAM COPY at his/her disposal, or by time and by intensity of use, like a car rental company may charge surcharges for excess miles.

This invention provides for both possibilities.

Here are examples for twelve kinds of programs, which the inventor believes to work:

1 Sales Control program:

When the sales control program creates, updates or deletes one order received record, it charges a constant number of “paid records” (or nothing), or

when the sales control program creates, updates or deletes one sales record, it charges a constant number of “paid records” (or nothing), or

when the sales control program creates, updates or deletes one payments received record, it charges a constant number of “paid records” (or nothing),

2 Financial Accounting Program:

When the financial accounting program creates, updates or deletes one account movement, it charges a constant number of “paid records” (or nothing),

3 Stock Control Program:

When the stock control program creates, updates or deletes one stock movement, it charges a constant number of “paid records” (or nothing),

4 Manufacturing Control Program:

When the manufacturing control program creates, updates or deletes one stock movement, it charges a constant number of “paid records” (or nothing), or

when the manufacturing control program creates, updates or deletes one process record, it charges a constant number of “paid records” (or nothing),

5 Property Valuation Program:

When the property valuation program updates one property owner's record, it charges a constant number of “paid records” (or nothing), or

when the property valuation program creates, updates or deletes one property's record, it charges a constant number of “paid records” (or nothing), or

when the property valuation program creates, updates or deletes one property part's record, it charges a constant number of “paid records” (or nothing), or

when the property valuation program creates, updates or deletes one property part's value modifier record, it charges a constant number of “paid records” (or nothing),

6 Marketing Support Program:

When the marketing support program updates one prospective customer's record, it charges a constant number of “paid records” (or nothing), or

when the marketing support program updates one customer's record, it charges a constant number of “paid records” (or nothing), or

when the marketing support program creates, updates or deletes one contact's record, it charges a constant number of “paid records” (or nothing),

7 Fax/E-Mail program:

When the fax/e-mail program updates one address book record, it charges a constant number of “paid records” (or nothing), or

when the fax/e-mail program creates, updates or deletes one record of received or sent fax/e-mail, it charges a constant number of “paid records” (or nothing),

8 Calendar/Scheduling program:

When the calendar/scheduling program updates one user name record, it charges a constant number of “paid records” (or nothing), or

when the calendar/scheduling program creates, updates or deletes one calendar or schedule record, it charges a constant number of “paid records” (or nothing),

9 Payroll Program:

When the payroll program creates, updates or deletes one salary record, it charges a constant number of “paid records” (or nothing),

10 Equipment Maintenance Control Program:

When the equipment maintenance control program creates, updates or deletes one maintenance record, it charges a constant number of “paid records” (or nothing), or

when the equipment maintenance control program updates one equipment record, it charges a constant number of “paid records” (or nothing),

11 CAD Program:

When the CAD program updates one drawing, it charges a constant number of “paid records” (or nothing), or

when the CAD program updates one drawing, it charges a number of “paid records” proportional to the number of drawing elements added, or updated, or deleted, or added and updated, or added and updated and deleted, or added and deleted, or updated and deleted, or

when the CAD program updates one stock object record, it charges a constant number of “paid records” (or nothing),

12 Disk Operating Subsystem Program:

When the disk operating subsystem program changes the “file name” field of a directory entry, it charges a constant number n1 of “paid records” (or nothing), or

when the disk operating subsystem program changes the “date updated” field of a directory entry, it charges a constant number n2 of “paid records” (or nothing).

For the algorithm to charge “paid records” to a USER see below from #717.

When there are no “paid records” left in the COMPUTER DATABASE, the COMPUTER PROGRAM COPY must deny adding of “transient data” only, that is,

the COMPUTER PROGRAM COPY must always allow adding or deleting “basic data”, allow changing the “start date” or “identification” parts of PAID RECORDS, even if there are no “paid records” left.

The COMPUTER PROGRAM COPY also must always and unconditionally allow to display on screen, print and convert into formats readable by other programs those parts of the COMPUTER DATABASE, which the USER owns.

For the algorithm to deny adding of “transient data” to a USER, see below from #727.

For the definition of “basic data” see above from #065, #189 and from #205.

For the definition of those parts of the COMPUTER DATABASE, which the USER owns, see above from #040.

A method to calculate the price for one “paid record” is as follows:

First, decide the time unit used for setting the “minimum consumption per time unit” part of PAID RECORDS. One month works for all the twelve kinds of programs, which are mentioned as examples in this description.

Estimate the minimum number of times, which the average COMPUTER PROGRAM COPY runs any of the tasks, which process “transient data” and cost “paid records”, per time unit.

For instance, a sales control program is estimated to log a minimum of 3,000 sales records per one month,

a financial accounting program is estimated to log a minimum of 150 account movements per month,

a disk operating subsystem is estimated to do a minimum of 150 file renames and a minimum of 10,000 file updates per month.

Multiplying these values with the factor, which the tasks charge for each “transient data” item processed, and adding the results gives the value to set in the “minimum consumption per time unit” part of PAID RECORDS.

For instance, in the sales control program, logging one sales record is decided to be charged with one “paid record”. Therefore, the “minimum consumption per time unit” part of PAID RECORDS is 3,000,

in the financial accounting program, logging one account movement is decided to be charged with one “paid record”. Therefore, the “minimum consumption per time unit” part of PAID RECORDS is 150,

in the disk operating subsystem program, one file rename is decided to be charged with 100 “paid records”, one file update with 1 “paid record”. Therefore, the “minimum consumption per time unit” part of PAID RECORDS is 25,000.

Call this “minimum consumption per time unit” part of PAID RECORDS A.

Next do the following:

Estimate the number of COMPUTER PROGRAM COPIES, which can be distributed during a forecast term (e.g. five years after release) and call this number N, then calculate the sum of the following 9 items:

1 the cost of development of the program before release,

2 the cost of research and development of major improvements of the program for the forecast term,

3 the cost of developing bug fixes for the program for the forecast term,

4 the cost of selling to the USERs N COMPUTER PROGRAM COPIES, in other words, the number of sales people permanently employed times the cost for each during the forecast term,

5 the cost of manufacturing and bringing to the USERs N COMPUTER PROGRAM COPIES, that is, cost of manufacturing CD-ROMs, manuals, cost in the sales channel, or, if the DEVELOPER installs directly at the USER, the cost for that,

(Cost 1 through 5 assumed to be independent from the number of COMPUTER PROGRAM COPIES installed.)

6 capital cost for the forecast term: In case cost 1 through 5 take about two thirds of the total, therefore cost 7 through 9 take about one third, about 15% of the total cost are required as starting capital, the interest to be paid over the forecast term on that capital is cost 6 (see drawing D09).

7 The cost of supporting USERs of N COMPUTER PROGRAM COPIES for the forecast term, divided by a factor X, which is two, in case the number of installations per month is assumed constant,

8 the cost of bringing bug fixes to the USERs of N COMPUTER PROGRAM COPIES for the forecast term, divided by a factor X, which is two, in case the number of installations per month is assumed constant,

9 the cost of creating and bringing ADDITIONAL PAID RECORDS to the USERs of N COMPUTER PROGRAM COPIES for the forecast term, divided by a factor X, which is two, in case the number of installations per month is assumed constant,

and then divide this sum by

the product of N and the expected number of “paid records”, which one COMPUTER PROGRAM COPY consumes during the forecast term, which is at least A times the number of time units, which fit into the forecast term.

and then multiply the result with a factor X, this factor being

two, in case the number of installations per month is assumed constant,

larger than two, in case the program is expected to take off slowly, but to pick up during the forecast term to reach the expected number of copies,

smaller than two, in case the program is expected to take off fast, but then to slow down during the forecast term to reach the expected number of copies.

This calculation makes sure, that over the forecast term, the total of the cost and the total of the income from “paid records” is equal (see drawing D09).

The income from “paid records” is smaller than the cost for the first part of the term, therefore capital is required. After that, the income is always larger than the cost, assuming, that all installed COMPUTER PROGRAM COPIES are being used continuously.

Under this assumption, after the forecast term, capital is being generated from the income from “paid records”.

Decide the length of the trial period for one COMPUTER PROGRAM COPY. Call this value T. It must be expressed in the same time unit as the “minimum consumption per time unit”. For instance 6 months.

Now the “maximum number” part of PAID RECORDS is to be calculated as:

|M−Z|=(T×A)/2, Z being a constant number, e.g. zero

See above under step 1 (from #257) for an explanation of how USERs can obtain “paid records”, which they haven't paid for. This consideration is the basis for the formula.

Because the absolute difference between the “maximum number” part M of PAID RECORDS and a constant number Z has to be less than the result of number of time units, which fit into six calendar months times the “minimum consumption per time unit” part A of PAID RECORDS (see step 1 above, from #135), T must be smaller than 12 months.

A third consideration to be made regarding the value M is, that a USER should not have to order “additional paid records” too often, in case they are distributed via storage media or e-mail.

The inventor thinks, that in this case, |M−Z| should be a bit larger than the average expected consumption of “paid records” per month.

Regarding step 3: Make changes/additions to the program.

At first, an explanation of the word COMPUTER PROGRAM COPY:

The COMPUTER PROGRAM COPY is a data item, which

1 is stored in computer files, in computer disk volumes or in other sequential or block-oriented computer storage facilities,

for which means to make copies of one entire file, of one entire disk volume or of one entire storage facility and to distribute those copies may be easily available to the USER,

however the DEVELOPER doesn't make available to the USER any means to make meaningful copies of or meaningful modifications of parts of one file, of one disk volume or of one storage facility,

2 contains code, some or all of which is to be executed on computers, whose specifications regarding the execution of code are completely or partially known to the USER,

3 contains INSEPARABLY LINKED the code prescribing those tasks of the computer program, which change the COMPUTER DATABASE, or perform other actions, while changing the PAID RECORDS,

All those files, all those disk volumes or all those storage facilities containing the COMPUTER PROGRAM COPY can be stored or can be executed on computer hardware, which is outside of the control of the DEVELOPER, i.e. neither the computer hardware nor its specification is the property of the DEVELOPER. The invention makes this possible.

Although the DEVELOPER may store some or all the files, some or all the disk volumes or some or all the storage facilities containing the COMPUTER PROGRAM COPY on computer hardware, which is controlled by the DEVELOPER, there is no need for this in order to use the invention.

That means, the computer hardware can be standard hardware like IBM-AT compatible or Microsoft Windows compatible PCs without any hardware additions.

INSEPARABLY LINKED meaning with regard to the tasks mentioned above, which modify COMPUTER DATABASE and PAID RECORDS, not necessarily, that all the code of the COMPUTER PROGRAM COPY must be in one file, in one disk volume or in one storage facility, although this is one possibility, but, that the DEVELOPER does not make available to the USER any means to partially delete code or to change code, which prescribes those tasks, from the COMPUTER PROGRAM COPY, (That means, the code prescribing those tasks must be in a form, which is as time-consuming and costly as possible to reverse compile or to disassemble.

In the case the program is delivered as code, which is converted into machine code at run time, the delivered code must be stored in encrypted form, the conversion program also as large as possible.

In case the program is delivered in machine code (so-called EXE or DLL files, never use so-called COM files), it must be as few and as large files as possible.

The inventor thinks that any code larger than 1 MB (megabyte) is sufficiently large.

The danger for the DEVELOPER is, that a USER reverse compiles or disassembles a COMPUTER PROGRAM COPY to the point, that the USER understands the encryption and decryption programs used and knows the encryption keys used for COMPUTER DATABASE, PAID RECORDS and ADDITIONAL PAID RECORDS. Encryption and decryption programs and keys are all stored in each COMPUTER PROGRAM COPY.

However, although this danger exists, the loss for the DEVELOPER from unlawful use of COMPUTER PROGRAM COPIES is anyway reduced by orders of magnitude, as the following calculation shows:

From 10,000 USERs, who would be able to install an “unlicensed” COMPUTER PROGRAM COPY, for sure less than one is technically in the position to disassemble or to reverse compile a COMPUTER PROGRAM COPY.

From this first approximation follows, that a DEVELOPER, who estimates the loss by use of unlicensed COMPUTER PROGRAM COPIES to US$100,000 per year, sees the loss reduced to less than US$10 per year by applying this invention.

For a better approximation it must be considered, that disassembly or reverse compilation takes time and money.

The inventor guesses that the cost is in the tens or in the hundreds of thousands of US$ for one version of a COMPUTER PROGRAM COPY. Any USER, who is technically in the position to disassemble or reverse compile, will think about, where the money is better spent: on unlawfully disassembling or reverse compiling, or on writing a program similar to the COMPUTER PROGRAM COPY from scratch.

Many such USERs will opt for the latter, because it's lawful. This consideration reduces the loss for the DEVELOPER even further.

For a third approximation, the ratio of the cost of disassembly or reverse compilation to the average amount charged by the DEVELOPER for a COMPUTER PROGRAM COPY must be considered. In case the cost for disassembly or reverse compilation are estimated to just US$50,000 and the DEVELOPER charges US$50 for one average COMPUTER PROGRAM COPY per year, the time to retrieve the cost by using one COMPUTER PROGRAM COPY would be 1,000 years. That means, only COMPUTER PROGRAM COPIES, which yield in average US$5,000 or more per year and per USER, are worth of disassembling. Also this consideration reduces the loss for the DEVELOPER further.

For a fourth approximation, USERs must be considered, who reverse compile or disassemble a COMPUTER PROGRAM COPY and then attempt to retrieve the cost for this from other USERs. Such USERs face the same problems as the DEVELOPER: whether to charge a lump-sum once for a modified COMPUTER PROGRAM COPY, which allows to steal “paid records”, or whether to establish a system to provide other USERs with fake “additional paid records”.

In the first case, the USERs, who have spent money on disassembling, have problems with copying of their creation without paying by USERs. They also face damages, if they are caught: Because each COMPUTER PROGRAM COPY is the property of the DEVELOPER, modifying it constitutes causing property damage to the DEVELOPER. The DEVELOPER can easily prove such property damage, by presenting such a modified COMPUTER PROGRAM COPY. Such evidence is far easier to obtain than evidence for an unlicensed installation of a COMPUTER PROGRAM COPY.

In the second case, they have to invest in an undercover distribution system for fake “additional paid records”.

Also in this case, they face damages if caught: They basically modify, i.e. damage, the PAID RECORDS data item, which is property of the DEVELOPER.

Remain those USERs, who are able to spend money and time not to make money, but just to cause damage to the DEVELOPER. They and their customers must be prosecuted by legal means, as described in the previous paragraph.

All USERs who obtain fake “additional paid records” or tools to steal “paid records” basically allow very questionable people to tamper with their COMPUTER DATABASEs. Therefore it appears to be a realistic assumption, that the overwhelming majority of USERs simply won't allow this to happen.)

and, that the DEVELOPER does not make available to the USER any means to execute without authorization any of those tasks partially, (That means, that the program must not publish any API (application program interface), which allows to run such a task partially, like changing a part of PAID RECORDS only without making the changes to the COMPUTER DATABASE, which go with it, and vice versa, without authorization, that means: if an API is published, it must be protected with an access key, as described from #857.)

and, that the code, which prescribes those tasks, contains commands that verify the successful completion of the task,

and, that, if such verification fails, the COMPUTER PROGRAM COPY denies permission to execute the tasks defined from #555, until the uncompleted task is completed, (That means, verifying, whether both the changes to PAID RECORDS and the changes to the COMPUTER DATABASE are properly saved to a file, to a disk volume or to a storage facility, by using a transaction mechanism.)

and, that the DEVELOPER doesn't make available to the USER any means to convert the code of the COMPUTER PROGRAM COPY into a form, which is directly understandable to the human senses.

(That means, the DEVELOPER must not make available any means to view or to print the code, nor any means to reverse compile or to disassemble the code.)

In total, the DEVELOPER has to make ten changes/additions to the code of an existing program. Two more changes/additions are optional.

At first, the DEVELOPER must decide whether to use the number Z as limit or the “maximum number” part M of the PAID RECORDS data item as limit, for the program to decide, whether to allow to run certain tasks (see from #727 and drawing D08).

The inventor thinks, that there is neither advantage nor disadvantage to either choice. It is also possible to use a number smaller than Z for the “maximum number” part M of the PAID RECORDS data item.

The inventor thinks, that using zero for the number Z as limit with a positive number for “maximum number” M is the best option for the DEVELOPER. However, in the description below in this step, all cases are covered.

The number Z must be hard-coded into each COMPUTER PROGRAM COPY.

Next, the DEVELOPER must decide the length of the “date window”.

For programs, which are being used daily, a window length of one day works.

For programs, which are used Monday through Friday, a window length of seven days or larger must be used.

Accounting programs often use a “date window” of two months or of 2.5 months, to allow the USER to make corrections of data which are up to that time span in the past.

The length of the “date window” must in any case be smaller than six months, according to the considerations made above from #135.

This “date window” length is to be hard-coded in the program, that is, it is part of the COMPUTER PROGRAM COPY, or to be stored in the COMPUTER DATABASE in such a way, that the USER can't change it without using the COMPUTER PROGRAM COPY.

And third, the DEVELOPER must give the program a “program type identifier”, hard-coded into the program.

Fourth, the DEVELOPER must decide whether to use copy detection and loss estimation (option C). As shown on drawing D10, the mechanisms to prevent copying of “paid records” within one company are weak. Therefore, if the program can be used in several branch offices or for several employees or computers in one company, the use of copy detection and loss estimation is advisable.

Fifth, the developer must decide whether to implement the possibility to change billing conditions for a USER (option B). In case usage patterns may vary between USERs, or for USERs over time, it is advisable to implement this feature.

Change/Addition 1: (Installation, Initialization)

The code of the install part of the program (which is executed upon request of the USER) must be extended to initialize the PAID RECORDS data item and the COMPUTER DATABASE:

The “number” part to

Z, in case Z is used as limit,

(the “maximum number” part of PAID RECORDS, in case the “maximum number” part of PAID RECORDS is used as limit),

the “serial number” part to a new, unique value, e.g. the sum of the current date converted into an integer number and a random number between 0 and 1,

the “copy number” part (in case option C is used) to a new, unique value, e.g. the sum of the current date converted into an integer number and a random number between 0 and 1,

the “installation number” part to a specific initial value,

the “identification” part to a specific initial value, the “start date” part to a specific initial value, which is prior to the release date of the program minus the length of the “date window”,

the “number on start date” part to

Z, in case Z is used as limit,

(the “maximum number” part of PAID RECORDS, in case the “maximum number” part of PAID RECORDS is used as limit),

the “addition since start date” part to zero,

the “minimum consumption per time unit” part to the value, which was calculated in step 2 (from #562),

the “maximum number” part to the value, which was calculated in step 2 (from #597),

all parts of the COMPUTER DATABASE (except PAID RECORDS) to specific initial values.

Change/Addition 2: (Program Start)

The code, which runs every time when the program is started (by the USER), must be extended to check, whether “identification” part and “start date” part of PAID RECORDS have been set by the USER:

If the “identification” part is equal to the initial value, ask the USER to input his/her identification. If the USER inputs something, store it in the “identification” part of PAID RECORDS.

The question by the program to the USER has to include a hint, that the identification must be fixed before “paid records” are loaded, respectively that changing the identification after loading “paid records” costs all the loaded “paid records”.

If the “start date” part is equal to the initial value, ask the USER to input the start date. If the USER inputs a date, store it in the “start date” part of PAID RECORDS.

The question by the program to the USER has to include a hint, that setting the start date backwards requires a re-installation of the program and re-inputting of all data into the database, and,

that setting the start date forward from the next time on requires a certain amount of “paid records” for each time unit (month) it is set forward.

Change/Addition 3: (Input of Current Date Upon Program Start)

In case the existing program implements an “application-specific date window” (see remark below this paragraph, from #681, for what is meant by “application-specific date window”), like some accounting programs do, then there is nothing to do here, otherwise, the program must be extended to implement such a “date window”, by checking each date input, whether it is within the current “date window”, see change/addition 8 below, from #738.

In case the program takes the date stored with “transient data” from the computer hardware or from another program instead of requiring it to be input explicitly (like a disk operating subsystem program, which uses the date from the computer hardware to store in the directory entries) then the following code has to be added:

The code, which runs every time when the program is started (by the USER), must be extended to ask the USER for the current date.

If the USER inputs a date prior to the “start date” part of PAID RECORDS, the program must reject it.

If the USER inputs a date after the “start date” part of PAID RECORDS plus the length of the “date window”, the program must either

reject the date and tell the USER, that the start date must be changed before this current date can be used or

change the “start date” part of PAID RECORDS, so that the current date is within the “date window”, according to the rules described below in change/addition 4.

Remark:

With “application-specific date window” is meant, that for instance an accounting program doesn't log any records with a date prior to a certain start date, and with a date after the start date plus the length of the “date window”.

For instance, if the log for the month of January is not completed yet, the start date is January 1st. In case the length of the “date window” is 2.5 months, the USER can't log anything with a date after mid-March.

By the end of February, probably all logs for January are final, so the USER can “close” January, by changing the start date from January 1st to February 1st.

The effect is, that the USER can't change the data of January any more, but he/she can now input data until new “start date” plus length of the “date window”, which is February 1st plus 2.5 months, that is, mid-April.

Change/Addition 4: (Change of Start Date of “Date Window”)

In case the existing program implements an “application-specific date window” (see remark after previous paragraph, from #681, for what is meant by “application-specific date window”), like some accounting programs do, then the DEVELOPER must make sure,

that the “start date” used by this “application-specific date window” is stored in the COMPUTER DATABASE,

INSEPARABLE from the PAID RECORDS.

In case the existing program doesn't store a start date yet, it must be extended to store it in the “start date” part of the PAID RECORDS data item.

In any case, the program must get a facility (e.g. a button to click with the mouse and a data entry form with a text box and another button) to allow a USER to display the stored “start date” and to change it according to these rules:

Before the program stores a change of the old “start date” to a new “start date” (on request of the USER), it must make the following calculation (the quoted names all refer to parts of the PAID RECORDS data item):

In case Z is used as limit and the “maximum number” part of PAID RECORDS is larger than Z, or the “maximum number” part of PAID RECORDS is used as limit and the “maximum number” part of PAID RECORDS is smaller than Z:

“number on start date” changed by the absolute value of the “addition since start date” away from the limit and the result changed by the absolute difference between new “start date” and the old “start date” in time units multiplied by “minimum consumption per time unit” towards the limit.

Remark:

In case the difference between new “start date” and the old “start date” is in days, and the time unit is one month, use 30 days per month as conversion. It doesn't matter, that some months are shorter and others longer.

If the result of that calculation is closer to the limit than the “number” part of PAID RECORDS, then set the “number” part to that result, however, if the result is not between Z and the “maximum number” part of PAID RECORDS, set the “number” part to the limit.

(In case the “maximum number” part of PAID RECORDS is used as limit and the “maximum number” part of PAID RECORDS is larger than Z, or Z is used as limit and the “maximum number” part of PAID RECORDS is smaller than Z:

“number on start date” changed by the absolute value of the “addition since start date” away from the limit and the result changed by the absolute difference between new “start date” and the old “start date” in time units multiplied by “minimum consumption per time unit” towards the limit.

If the result of that calculation is closer to the limit than the “number” part of PAID RECORDS, then set the “number” part to that result,

however, if the result is not between Z and the “maximum number” part of PAID RECORDS, set the “number” part to the limit.)

Next, the program stores the new start date in the “start date” part of PAID RECORDS. At the same time, it must store in the “number on start date” part of PAID RECORDS that value, which is now in the “number” part of PAID RECORDS, and

store in the “addition since start date” part of PAID RECORDS the value zero.

Change/Addition 5: (Change of User Identification)

In case the existing program stores a user identification, like a name or a machine number, this identification must be stored in the “identification” part of the PAID RECORDS data item in the COMPUTER DATABASE,

or in the COMPUTER DATABASE INSEPARABLE from the PAID RECORDS data item.

In case the existing program doesn't store a user identification yet, it must be extended to store it in the “identification” part of the PAID RECORDS data item.

The program must get a facility (e.g. a button to click with the mouse and a data entry form with a text box and another button) to allow a USER to display the stored “identification” and to change the “identification”.

Before storing a change (on request of the USER), in case the “number” part of PAID RECORDS is between Z and the “maximum number” part of PAID RECORDS, excluding Z, in case Z is used as limit, (between Z and the “maximum number” part of PAID RECORDS, excluding the “maximum number” part of PAID RECORDS, in case the “maximum number” part of PAID RECORDS is used as limit),

the program has to give a warning message to the USER, that all available “paid records” will be consumed, while the “identification” is being changed.

During the program stores a change to the “identification”, it must

store in the “number” part of PAID RECORDS in case Z is used as limit, the value Z, (in case the “maximum number” part of PAID RECORDS is used as limit, the value of the “maximum number” part of PAID RECORDS), and

store in the “serial number” part of PAID RECORDS a new, unique value, e.g. the sum of the current date converted into an integer number and a random number between 0 and 1.

Change/Addition 6: (Charging for Program Use)

The code of a program must be extended to do the following during any tasks are executed (on request of the USER), which add or delete “basic data”, or which process “transient data” and for which the DEVELOPER has decided to charge money (see from #493 and drawing D08):

Read the “number” part of PAID RECORDS.

In case Z is used as limit:

Subtract an amount (in case the “maximum number” part of PAID RECORDS is larger than Z, the amount is larger than zero, otherwise smaller than zero) associated with the running task, as decided by the DEVELOPER, from that number.

If the result is between Z and the “maximum number” part of PAID RECORDS (inclusive), store the result in the “number” part of PAID RECORDS, otherwise store Z in the “number” part of PAID RECORDS.

(In case the “maximum number” part of PAID RECORDS is used as limit:

Add an amount (in case the “maximum number” part of PAID RECORDS is larger than Z, the amount is larger than zero, otherwise smaller than zero) associated with the running task, as decided by the DEVELOPER, to that number.

If the result is between Z and the “maximum number” part of PAID RECORDS (inclusive), store the result in the number” part of PAID RECORDS, otherwise store the value of the “maximum number” part of PAID RECORDS in the number” part of PAID RECORDS.)

Change/Addition 7: (Blocking tasks when no “Paid Records” are Left)

The code of a program must be extended to do the following before any tasks are executed (on request of the USER), which the DEVELOPER has decided to block in case the USER hasn't paid for use of the COMPUTER PROGRAM COPY (see step 2, from #555):

In case Z is used as limit:

Check, whether the “number” part of PAID RECORDS is equal to Z.

If this is the case, display a message to the USER, that the requested task isn't going to be executed, because no “paid records” are left. Also display how to obtain and add “paid records”. Don't execute the requested task then.

If this is not the case, i.e. the “number” part of PAID RECORDS is not equal to Z, execute the requested task.

(In case the “maximum number” part of PAID RECORDS is used as limit:

Check, whether the “number” part of PAID RECORDS is equal to the “maximum number” part of PAID RECORDS.

If this is the case, display a message to the USER, that the requested task isn't going to be executed, because no “paid records” are left. Also display how to obtain and add “paid records”. Don't execute the requested task then.

If this is not the case, i.e. the “number” part is not equal to the “maximum number” part of PAID RECORDS, execute the requested task.)

Change/Addition 8: (Prevention of Use of Dates Outside the “date Window”)

The code of a program must be extended to do the following during any tasks (running on request of the USER), which read a date value, which is input by the USER, or which is retrieved from the computer hardware:

Compare the input/retrieved date value with the “start date” part of PAID RECORDS.

In case the input date is smaller than the “start date” part of PAID RECORDS, reject the date as invalid date and stop the running task.

In case the input date is larger than the “start date” part of PAID RECORDS plus the length of the “date window”, then reject the date as invalid and stop the running task.

In the other case, i.e. the input/retrieved date is equal to or larger than the “start date” and smaller than or equal to “start date” plus length of “date window”, execute the requested task.

Change/Addition 9: (Adding “Paid Records”)

The code of the program must be extended to receive “additional paid records” from the DEVELOPER, or to request them and receive them.

(See below under step 4, from #872, for an explanation of the parts of an ADDITIONAL PAID RECORDS data item.)

At first, reception only is described. This code is required in case “additional paid records” are delivered on storage media or as e-mail attachment to the USER.

Upon a command of the USER, code in the program

(1) checks whether the “serial number” part of PAID RECORDS equals the “serial number” part of ADDITIONAL PAID RECORDS, if it doesn't (negative result), it rejects the “additional paid records”,

(2) checks (in case option C is used) whether the “copy number” part of PAID RECORDS equals the “copy number” part of ADDITIONAL PAID RECORDS, if it doesn't (negative result), it rejects the additional paid records”,

(3) checks whether the “installation number” part of PAID RECORDS equals the “installation number” part of ADDITIONAL PAID RECORDS, or whether the “installation number” part of PAID RECORDS equals the initial value if neither is the case (negative result), it rejects the “additional paid records”,

(4) checks whether the “number” part of ADDITIONAL PAID RECORDS is equal to zero, if it is (positive result), it rejects the “additional paid records”,

(5) in case Z is used as limit and the “maximum number” part of PAID RECORDS is larger than Z, or the “maximum number” part of PAID RECORDS is used as limit and the “maximum number” part of PAID RECORDS is smaller than Z: checks whether the result of changing the “number” part of PAID RECORDS by the absolute value of the “number” part of ADDITIONAL PAID RECORDS away from the limit is between Z and the “maximum number” part of ADDITIONAL PAID RECORDS, or, if ADDITIONAL PAID RECORDS has no “maximum number” part, between Z and the “maximum number” part of PAID RECORDS, (in case the “maximum number” part of PAID RECORDS is used as limit and the “maximum number” part of PAID RECORDS is larger than Z, or Z is used as limit and the “maximum number” part of PAID RECORDS is smaller than Z: checks whether the result of changing the “number” part of PAID RECORDS by the absolute value of the “number” part of ADDITIONAL PAID RECORDS away from the limit is between Z and the “maximum number” part of ADDITIONAL PAID RECORDS, or, if ADDITIONAL PAID RECORDS has no “maximum number” part, between Z and the “maximum number” part of PAID RECORDS,) if it isn't (negative result), it rejects the “additional paid records”,

(6) checks whether the “identification” part of PAID RECORDS is equal to the initial value set by the installation part of the program, if it is (positive result), it rejects the “additional paid records”,

(7) checks whether the “start date” part of PAID RECORDS is equal to the initial value set by the installation part of the program, if it is (positive result), it rejects the “additional paid records”,

If result of check (1) is positive and result of check (2) is positive and result of check (3) is positive and result of check (4) is negative and result of check (5) is positive and result of check (6) is negative and result of check (7) is negative, then the code

1 In case Z is used as limit and the “maximum number” part of PAID RECORDS is larger than Z, or the “maximum number” part of PAID RECORDS is used as limit and the “maximum number” part of PAID RECORDS is smaller than Z: changes the “number” part of PAID RECORDS by the absolute value of the “number” part of ADDITIONAL PAID RECORDS away from the limit (e.g. adds both), (In case the “maximum number” part of PAID RECORDS is used as limit and the “maximum number” part of PAID RECORDS is larger than Z, or Z is used as limit and the “maximum number” part of PAID RECORDS is smaller than Z: changes the “number” part of PAID RECORDS by absolute value of the “number” part of ADDITIONAL PAID RECORDS away from the limit (e.g. subtracts the “number” part of ADDITIONAL PAID RECORDS from the “number” part of PAID RECORDS),

2 adds the “number” part of ADDITIONAL PAID RECORDS to the “addition since start date” part of PAID RECORDS, then overwrites with the result the “addition since start date” part of PAID RECORDS,

3 overwrites the “copy number” part of PAID RECORDS with the “serial number” part of PAID RECORDS (in case option C is used),

4 overwrites the “serial number” part of PAID RECORDS with a new, unique value, e.g. the sum of the current date converted into an integer number and a random number between 0 and 1.

5 overwrites the “installation number” part of PAID RECORDS with the “installation number” part of ADDITIONAL PAID RECORDS,

6 overwrites the “minimum consumption per time unit” part of PAID RECORDS with the “minimum consumption per time unit” part of ADDITIONAL PAID RECORDS (in case option B is used),

7 overwrites the “maximum number” part of PAID RECORDS with the “maximum number” part of ADDITIONAL PAID RECORDS (in case option B is used),

8 deletes the file, the disk volume or the storage facility containing the ADDITIONAL PAID RECORDS, or marks the icon representing the ADDITIONAL PAID RECORDS on a graphical computer screen as empty, or sets the “number” part of ADDITIONAL PAID RECORDS to zero,

9 displays a message whether addition of “paid records” was successful, and recommends to order another “additional paid records” right now, for uninterrupted service by the COMPUTER PROGRAM COPY.

The command to add “additional paid records” must be as “graphic” as possible to the USER. E.g. showing COMPUTER DATABASE and ADDITIONAL PAID RECORDS as icons on a graphic user interface, the command mentioned in #749 being dragging the ADDITIONAL PAID RECORDS and dropping them on the COMPUTER DATABASE, so that the icon for ADDITIONAL PAID RECORDS disappears during above 9 steps are executed.

Next, request and reception is described. This code is required in case “additional paid records” are delivered via computer network to the USER.

(Remark: The actions of the computer of the DEVELOPER are written in italics. The Customer Table and Orders Received Table of the DEVELOPER are described in step 4, from #916. The steps written in italics also apply for requests processed manually by the DEVELOPER.)

Upon a command of the USER, or when at start of the program after inputting of current date the number of available “paid records” is below a threshold, then code in the program

1 checks whether the “identification” part of PAID RECORDS is equal to the initial value set by the installation part of the program, if it is, it doesn't request “additional paid records” and ends;

2 checks whether the “start date” part of PAID RECORDS is equal to the initial value set by the installation part of the program, if it is, it doesn't request “additional paid records” and ends;

3 establishes a connection via a computer network to a computer controlled by the DEVELOPER,

4 if the “installation number” part of PAID RECORDS equals the initial value, then

sends the “identification” part of PAID RECORDS and the “program type identifier” of the COMPUTER PROGRAM COPY to the computer of the DEVELOPER, including a request to examine them, then waits for a response otherwise, sends the “installation number” part of PAID RECORDS to the computer of the DEVELOPER, including a request to examine it, then waits for a response (if the computer of the DEVELOPER receives a combination of “identification” and “program type identifier”, then

the computer of the DEVELOPER checks whether a USER with this “identification” is identifiable with a third party (for instance a certain combination of credit card number and name),

if the USER isn't identifiable, the computer of the DEVELOPER responds to the computer of the USER, that for now no “additional paid records” are sent until the identity of the USER is confirmed,

if the USER is identifiable with a third party, the computer of the DEVELOPER starts a new record in the Customer Table and stores the “identification” there in field “identification”,

stores the “program type identifier” in field “program type identifier”, creates a new “installation number” and fills all other fields with default values,

next, the computer of the DEVELOPER checks the account balance for this “installation number” in its Customer Table,

if it is larger than the “account balance limit” field of the record of the “installation number” in the Customer Table,

the computer of the DEVELOPER gives a message (negative response) to the computer of the USER, that for now no “additional paid records” are sent because of payment problems,

if it is smaller than the “account balance limit” field of the record of the “installation number” in the Customer Table, a positive response is sent)

6 in case response is negative, gives a message to the USER, that identity must be confirmed, or that there are payment problems, then ends;

7 in case response is positive, sends the “serial number”, “copy number” (in case option C is used) and “number” parts of PAID RECORDS to the computer of the DEVELOPER including a request to examine them, then waits for a response (the computer of the DEVELOPER starts a new record in the Orders Received Table, fills field “Rec” with a number that is either larger than or smaller than all other numbers in field “Rec” in that table, next fills the fields “installation number”, “minimum consumption per month”, “maximum number”, “price for one paid record” with the values from the Customer Table, next

the computer of the DEVELOPER stores (in case option C is used) the received “copy number” in field “copy number” of the new Orders Received record, and the received “serial number” in the “serial number” field of the same record, next

the computer of the DEVELOPER creates an empty ADDITIONAL PAID RECORDS data item, next

the computer of the DEVELOPER sets the “serial number” part of ADDITIONAL PAID RECORDS to the “serial number” of the Orders Received record,

the computer of the DEVELOPER sets (in case option C is used) the “copy number” part of ADDITIONAL PAID RECORDS to the “copy number” of the Orders Received record,

the computer of the DEVELOPER sets the “installation number” part of ADDITIONAL PAID RECORDS to the “installation number” of the Orders Received record,

the computer of the DEVELOPER sets the “number” part of ADDITIONAL PAID RECORDS to

in case Z is used as limit:

the difference between the “maximum number” from the Orders Received record and the current “number” part of PAID RECORDS, or the absolute difference, in case the “maximum number” part of PAID RECORDS is used as limit:

the current “number” part of PAID RECORDS, or the absolute value of it,

the computer of the DEVELOPER adds to the account balance of the installation in the Customer Table a usage fee, whose amount is the absolute value of the “number” part of ADDITIONAL PAID RECORDS multiplied with the price for one “paid record”,

the computer of the DEVELOPER sets (in case option B is used) the “minimum consumption per time unit” part of ADDITIONAL PAID RECORDS to the “minimum consumption per time unit” from the Orders Received record,

the computer of the DEVELOPER sets (in case option B is used) the “maximum number” part of ADDITIONAL PAID RECORDS to the “maximum number” from the Orders Received Record, next

the computer of the DEVELOPER sends the ADDITIONAL PAID RECORDS to the computer of the USER,)

8 checks whether the “serial number” part of PAID RECORDS equals the “serial number” part of ADDITIONAL PAID RECORDS, if it doesn't, the computer of the USER gives a failure message to the computer of the DEVELOPER, and a failure message to the USER, then ends;

9 checks (in case option C is used) whether the “copy number” part of PAID RECORDS equals the “copy number” part of ADDITIONAL PAID RECORDS, if it doesn't, the computer of the USER gives a failure message to the computer of the DEVELOPER, and a failure message to the USER, then ends;

10 checks whether the “installation number” part of PAID RECORDS equals the “installation number” part of ADDITIONAL PAID RECORDS, or whether the “installation number” part of PAID RECORDS equals the initial value if neither is the case, the computer of the USER gives a failure message to the computer of the DEVELOPER, and a failure message to the USER, then ends;

11 it checks whether the “number” part of ADDITIONAL PAID RECORDS is equal to zero, if it is, the computer of the USER gives a failure message to the computer of the DEVELOPER, and a failure message to the USER, then ends;

12 in case Z is used as limit and the “maximum number” part of PAID RECORDS is larger than Z, or the “maximum number” part of PAID RECORDS is used as limit and the “maximum number” part of PAID RECORDS is smaller than Z:

it checks whether the result of changing the “number” part of PAID RECORDS by the absolute value of the “number” part of ADDITIONAL PAID RECORDS away from the limit is between Z and the “maximum number” part of ADDITIONAL PAID RECORDS, (in case the “maximum number” part of PAID RECORDS is used as limit and the “maximum number” part of PAID RECORDS is larger than Z, or Z is used as limit and the “maximum number” part of PAID RECORDS is smaller than Z:

it checks whether the result of changing the “number” part of PAID RECORDS by the absolute value of the “number” part of ADDITIONAL PAID RECORDS away from the limit is between Z and the “maximum number” part of ADDITIONAL PAID RECORDS,) if it isn't, the computer of the USER gives a failure message to the computer of the DEVELOPER, and a failure message to the USER, then ends;

13 in case Z is used as limit and the “maximum number” part of PAID RECORDS is larger than Z, or the “maximum number” part of PAID RECORDS is used as limit and the “maximum number” part of PAID RECORDS is smaller than Z:

changes the “number” part of PAID RECORDS by the absolute value of the “number” part of ADDITIONAL PAID RECORDS away from the limit (e.g. takes the “number” part of ADDITIONAL PAID RECORDS, takes the “number” part of PAID RECORDS, adds them, then overwrites with the result the “number” part of PAID RECORDS, (in case the “maximum number” part of PAID RECORDS is used as limit and the “maximum number” part of PAID RECORDS is larger than Z, or Z is used as limit and the “maximum number” part of PAID RECORDS is smaller than Z:

changes the “number” part of PAID RECORDS by the absolute value of the “number” part of ADDITIONAL PAID RECORDS away from the limit (e.g. subtracts the “number” part of ADDITIONAL PAID RECORDS from the “number” part of PAID RECORDS, then overwrites with the result the “number” part of PAID RECORDS),)

14 adds the “number” part of ADDITIONAL PAID RECORDS to the “addition since start date” part of PAID RECORDS, then overwrites with the result the “addition since start date” part of PAID RECORDS,

15 overwrites the “copy number” part of PAID RECORDS with the “serial number” part of PAID RECORDS (in case option C is used),

16 overwrites the “serial number” part of PAID RECORDS with a new, unique number, e.g. the sum of the current date converted into an integer number and a random number between 0 and 1

17 overwrites the “installation number” part of PAID RECORDS with the “installation number” part of ADDITIONAL PAID RECORDS,

18 overwrites the “minimum consumption per time unit” part of PAID RECORDS with the “minimum consumption per time unit” part of ADDITIONAL PAID RECORDS (in case option B is used),

19 overwrites the “maximum number” part of PAID RECORDS with the “maximum number” part of ADDITIONAL PAID RECORDS (in case option B is used),

20 deletes the file, the disk volume or the storage facility containing the ADDITIONAL PAID RECORDS, or marks the icon representing the ADDITIONAL PAID RECORDS on a graphical computer screen as empty, or sets the “number” part of ADDITIONAL PAID RECORDS to zero,

21 gives a message to the computer of the DEVELOPER, that the transaction is complete, (the computer of the DEVELOPER marks the Order Received record as complete in the “completion code” field.)

Change/Addition 10: (Display of the Status of the PAID RECORDS Data Item)

The code of the program must be extended to receive a command from the USER to display to the USER the following parts of the PAID RECORDS data item, together with a label telling their meaning:

“identification”, “program type identifier”, the absolute difference between “number” and Z, “serial number”, “copy number” (in case option C is used), “installation number”, the absolute difference between “maximum number” and

“number” and the name of the DEVELOPER with a label telling that the DEVELOPER is the owner of the program, this latter information stored in the COMPUTER PROGRAM COPY in encrypted form.

In case Z is used as limit, the absolute difference between “number” and Z tells the USER, how much usage of the COMPUTER PROGRAM is left, the absolute difference between “maximum number” and “number” tells the USER, how many “additional paid records” can be ordered.

In case the “maximum number” is used as limit, the absolute difference between “maximum number” and “number” tells the USER, how much usage of the COMPUTER PROGRAM is left, the absolute difference between “number” and Z tells the USER, how many “additional paid records” can be ordered.

The other values are required for the USER to order “additional paid records”.

Change/Addition 11: (Display of the Status of the ADDITIONAL PAID RECORDS Data Item)

This change/addition is only useful in case ADDITIONAL PAID RECORDS are transported on storage media or as e-mail attachment from the DEVELOPER to the USER.

The code of the program can be extended to receive a command from the USER to display to the USER the following parts of the ADDITIONAL PAID RECORDS data item, together with a label telling their meaning:

“number”, “identification”, “serial number”, “copy number” (in case option C is used), “installation number”, “minimum consumption per time unit” (in case option B is used), “maximum number” (in case option B is used).

Change/Addition 12: (Billing Services for other Programs)

This change/addition is optional. It's only useful for such programs, which offer the COMPUTER DATABASE, which they manage, to other programs, for them to store their data in it.

To such other programs, the program can offer “billing services”, by preparing on request of such other program a PAID RECORDS data item merged with the COMPUTER DATABASE, and by allowing such other program to modify the contents of this PAID RECORDS.

To achieve this, the PAID RECORDS data item must be extended by an “access key” part, consisting of a “username” and a “password”. This access key must be large enough to prevent programs from finding it out by trying.

Then, the program must publish the following API (application program interface) to other programs:

1 a command to allocate a PAID RECORDS data item for another program, this returns an access key to the PAID RECORDS, which the other program has to store permanently in encrypted form,

2 a command to de-allocate a PAID RECORDS data item for a program, which supplies the access key to the PAID RECORDS data item,

3 a command to return the current “number” part of PAID RECORDS for a program, which supplies the access key to the PAID RECORDS data item,

4 a command to change the “number” part of PAID RECORDS for a program, which supplies the access key to the PAID RECORDS data item, to a value, which the other program requests,

5 a command to return the current “serial number”, “copy number” (in case option C is used), “installation number”, “identification”, “start date”, “number on start date”, “addition since start date”, “minimum consumption per time unit” or “maximum number” part of PAID RECORDS for a program, which supplies the access key to the PAID RECORDS data item,

6 a command to change the “serial number”, “copy number” (in case option C is used), “installation number”, “identification”, “start date”, “number on start date”, “addition since start date”, “minimum consumption per time unit” or “maximum number” part of PAID RECORDS for a program, which supplies the access key to the PAID RECORDS data item, to values, which the other program requests.

Regarding step 4: Establish an apparatus to provide USERs of the program with ADDITIONAL PAID RECORDS.

ADDITIONAL PAID RECORDS is a data item, which is

1 is stored in one computer file, in one computer disk volume or in one other sequential or block-oriented computer storage facility,

for which means to make copies of the entire file, of the entire disk volume or of the entire storage facility and to distribute those copies may be easily available to the USER,

however the DEVELOPER doesn't make available to the USER any means to make meaningful copies of or meaningful modifications of parts of the file, of the disk volume or of the storage facility, except as prescribed in the COMPUTER PROGRAM COPY,

2 used to transport information whether to permit or whether to deny the execution of tasks prescribed in a COMPUTER PROGRAM COPY from the DEVELOPER to the USER, consisting of the parts (see drawing D06)

1 number,

2 serial number,

3 copy number (in case option C is used),

4 installation number,

5 identification (optional),

6 minimum consumption per time unit (in case option B is used),

7 maximum number (in case option B is used).

Explanation of the Parts of ADDITIONAL PAID RECORDS:

ad 1, the “Number” Part.

Data type must be compatible to the “number” part of PAID RECORDS, for instance a 4-byte integer number, see #247.

This number is used by the COMPUTER PROGRAM COPY to change the “number” part of PAID RECORDS in the COMPUTER DATABASE, which this COMPUTER PROGRAM COPY manages, according to the rules explained above under step 3 (from #745).

ad 2, the “Serial Number” Part.

Data type must be compatible to the “serial number” part of PAID RECORDS, for instance an 8-byte date, see #252.

This “serial number” is used to identify the COMPUTER DATABASE, and therefore indirectly the USER of the COMPUTER PROGRAM COPY when adding ADDITIONAL PAID RECORDS to the database.

See step 3 above (from #750) for an exact description of how this “serial number” is used during adding “additional paid records”.

ad 3, the “Copy Number” Part.

Data type must be compatible to the “serial number” part of PAID RECORDS, for instance a 8-byte date, see #252.

Only used in case copy detection and loss estimation is done, see #641, from #803 and from #948.

This “copy number” is used to identify the COMPUTER DATABASE, and therefore indirectly the USER of the COMPUTER PROGRAM COPY when adding “additional paid records” to the database.

See step 3 above (from #752) for an exact description of how this “copy number” is used during adding “additional paid records”.

ad 4: the “Installation Number” Part

Data type must be compatible to the “installation number” part of PAID RECORDS, for instance a 4-byte integer, see #277.

When the DEVELOPER gets the first order of ADDITIONAL PAID RECORDS from the USER, the DEVELOPER creates a unique, new number and sends it together with the ADDITIONAL PAID RECORDS to the USER. See from #790.

ad 5: the “Identification” Part

Three strings of 48 bytes each, for name, company name and machine number. The exact number of bytes is not important. However it must be large enough to distinguish USERs with similar names.

Only used in case ADDITIONAL PAID RECORDS are distributed by floppy diskette or via e-mail (see from #852.)

This identification is set by the DEVELOPER according to its Customer records. It is used in case ADDITIONAL PAID RECORDS are transported to the USER on storage media or as e-mail attachment, to identify the ADDITIONAL PAID RECORDS data item.

ad 6: the “Minimum Consumption per Time Unit” Part

Data type must be compatible to the “minimum consumption per time unit” part of PAID RECORDS, for instance a 4-byte integer, see #294. Only used in case the DEVELOPER wants to be able to change the billing conditions for the USER after installation, see #642.

This number is set by the DEVELOPER according to assumptions made about the use of each COMPUTER PROGRAM COPY. See step 2 above (from #563) for the calculations related to this value.

It is used by the COMPUTER PROGRAM COPY during adding “additional paid records” to the COMPUTER DATABASE. See step 3 above (from #776) for an exact description.

ad 7: the “Maximum Number” Part

Data type must be compatible to the “number” part of PAID RECORDS, for instance a 4-byte integer, see #247. Only used in case the DEVELOPER wants to be able to change the billing conditions for the USER after installation, see #642.

This number is set by the DEVELOPER according to assumptions made about the use of each COMPUTER PROGRAM COPY. See step 2 above (from #597) for the calculations related to this value.

It is used by the COMPUTER PROGRAM COPY during adding “additional paid records” to the COMPUTER DATABASE. See step 3 above (from #758) for an exact description.

The DEVELOPER may write for the apparatus a special program, which is not part of any COMPUTER PROGRAM COPY distributed to the USERs, to create such ADDITIONAL PAID RECORDS data items.

This special program must encrypt each ADDITIONAL PAID RECORDS data item with a method and key, which each COMPUTER PROGRAM COPY can decrypt.

One file of the program must be so large,

that it can't be stored on any removable storage media attached to any computer, which has access to the program and,

that it can't be transferred over any network to which any computer, which has access to the program, is connected.

For a Windows PC, the minimum size is 1,5 GB (Gigabyte) at present to avoid copying to floppy diskettes or MO drives.

E-mail servers usually limit the size of an attachment to a few megabytes.

None of the computers, which have access to the program, must be connected to a network, which is capable of transporting Internet data packets (useful are for instance Novell's Ethernet 802.3 or the CompuServe protocol). In other words: All computers, which create ADDITIONAL PAID RECORDS data items to be sent over a network to the USERs, must use as intermediary a server, which bridges from the network that is not capable of transporting Internet data packets to the Internet and which doesn't transport any files with a size equal to or larger than the largest program file.

The large file need not contain executable code, a random sequence of data units (bytes) is enough. In this case the program must scan through the entire large file at each start up to confirm that the large file is present. During scanning it must calculate several check sums (CRC, choice of the DEVELOPER, from which to which offsets the calculation is done) and compare the result with numbers stored in the program to make sure that actually the correct large file is present.

In order to create ADDITIONAL PAID RECORDS for the USERs, the DEVELOPER needs to store the following data about the USERs:

1 A Customer Table, containing:

“installation number” for each USER and COMPUTER PROGRAM COPY

“identification” for each USER

“program type identifier” of the COMPUTER PROGRAM COPY

“account balance” for each installation

“account balance limit” for each installation

“minimum consumption per time unit” for each installation

“maximum number” for each installation

“price for one paid record” for each installation

2 An Orders Received Table, containing (see also drawing D03):

C/N, the “copy number” of the PAID RECORDS in the COMPUTER DATABASE for which ADDITIONAL PAID RECORDS were ordered (in case option C is used)

S/N, the “serial number” of the PAID RECORDS in the COMPUTER DATABASE for which ADDITIONAL PAID RECORDS were ordered

I/N, the “installation number”, which links the received order to the account balance of a installation

Amount, the “number” part of ADDITIONAL PAID RECORDS, which were created for the installation when the order was received

Max, “maximum number” for the installation at the time the order was received

Pr, “price for one paid record” for the installation at the time the order was received

Rec, a running number for each record, either

monotonously increasing (e.g. 1, 2, 3, . . .) or

monotonously decreasing (e.g. −1, −2, −3, . . .)

“minimum consumption per time unit” for the installation at the time the order was received

“completion code”, telling whether a received order was fulfilled.

The special program, which creates ADDITIONAL PAID RECORDS data items, may contain code, which manages those two tables as well, according to the steps written in italics in step 3 above (from #781).

The exact way of using those two tables in order to create ADDITIONAL PAID RECORDS for USERs of COMPUTER PROGRAM COPIES is described above under step 3 (from #781). This may be both manual handling of the tables, as well as automated handling.

The apparatus, which creates the ADDITIONAL PAID RECORDS data items, must be able to store the data items on storage media, which can be used on all computers where a COMPUTER PROGRAM COPY receives ADDITIONAL PAID RECORDS through storage media.

For example, those computers, where the COMPUTER PROGRAM COPY expects the ADDITIONAL PAID RECORDS to arrive via a floppy disk, must be served with floppy disks, which those computers can read and write.

The apparatus, which creates the ADDITIONAL PAID RECORDS data items, must be able to communicate via computer network with all computers where a COMPUTER PROGRAM COPY receives ADDITIONAL PAID RECORDS through computer network. For example, those computers, where the COMPUTER PROGRAM COPY expects the ADDITIONAL PAID RECORDS to arrive via the Internet, must be able to communicate with an Internet server, which provides ADDITIONAL PAID RECORDS for them.

From the record of “copy numbers” and “serial numbers” in the Orders Received Table, the DEVELOPER can make an estimate of the loss of revenue from copying PAID RECORDS data items and ADDITIONAL PAID RECORDS data items by the USERs.

The algorithm is as follows (see drawing D03-04):

Start from the record with the highest (lowest, in case numbers in field Rec are monotonously decreasing) running number Rec. Call this record the “current record”.

Check, whether the “copy number” of the “current record” is found in the “copy number” field of any record R1 with a lower (higher, in case numbers in field Rec are monotonously decreasing) running number Rec.

If such a record R1 is found, then

add to the “maximum possible loss” for the installation with “installation number” I/N from record R1 the price for one “paid record” Pr times the absolute value of the “maximum number” Max of that record R2 of the Orders Received Table,

where the “serial number” is equal to the “copy number” of that record R3, where the “serial number” is equal to the “copy number” of record R1, and

add to the “maximum possible loss” for the same installation the price for one “paid record” Pr times the absolute value of the “maximum number” Max of record R3 of the Orders Received Table,

if record R2 doesn't exist, add to the “maximum possible loss” for the same installation the price for one “paid record” Pr times the absolute value of the “maximum number” Max of record R3 times two,

with Rec for record R2 smaller (larger, in case numbers in field Rec are monotonously decreasing) than Rec for record R3 and Rec for record R3 smaller (larger, in case numbers in field Rec are monotonously decreasing) than Rec for record R1.

Continue with the next “current record”, which is the record with the next lower (higher, in case numbers in field Rec are monotonously decreasing) running number Rec, until the entire Orders Received Table is worked through.

The result of this algorithm is a list of “installation number” I/N and “maximum possible loss” for each “installation number” listed. The actual loss is probably about 50% of the maximum possible loss (see remarks on drawing D03).

Regarding step 5: Distribute COMPUTER PROGRAM COPIES to USERs

The distribution set must include:

All or some of the code of the program,

An initialized complete or partial COMPUTER DATABASE, or code to create one,

Installation instructions,

A statement telling the following:

“The DEVELOPER owns the code of the COMPUTER PROGRAM COPY and those parts of the COMPUTER DATABASE, which tell, where to find the data, which the USER owns, within the COMPUTER DATABASE.

Disassembly of the COMPUTER PROGRAM COPY or of the COMPUTER DATABASE cause damage to property of the DEVELOPER and will be prosecuted.

Deletion of parts of or modifications (including additions, which are capable to change the COMPUTER DATABASE) of the COMPUTER PROGRAM COPY

or deletion of parts of or modification of parts of the COMPUTER DATABASE except by using the COMPUTER PROGRAM COPY constitute causing damage to property of the DEVELOPER and will be prosecuted if the proper billing function of the COMPUTER PROGRAM COPY is inhibited as consequence of the deletion or of the modification.

The USER will be made liable for damages if disassembled parts of the COMPUTER PROGRAM COPY or of the COMPUTER DATABASE, or modified parts of the COMPUTER PROGRAM COPY or of the COMPUTER DATABASE inhibiting the proper billing function are found in the USER's possession.”

Distribution can be done by any means, like by putting COMPUTER PROGRAM COPIES on storage media or by allowing downloads of the COMPUTER PROGRAM COPIES.

Intermediaries also can be used. In this case, it is possible to pay kickbacks to intermediaries by setting the “program type identifier” in such a way, that the DEVELOPER can recognize from it the intermediary.

The DEVELOPER then can link the Customer Table and the Orders Received Table as described above using the “installation number” field in order to tally sales by “program type identifier” and calculate from those tallies the kickbacks.

Definition of DEVELOPER:

The legal entity (person or company etc) which develops the program which is the basis for the COMPUTER PROGRAM COPY to be distributed.

Definition of USER:

Any legal entity (person or company etc), which has at least one COMPUTER PROGRAM COPY at its disposal.

1.
Process
The inventor claims to have invented
a process to generate a specific positive, recurring cash flow from a particular, identified legal entity called USER of a computer program to another legal entity called DEVELOPER of the computer program,
by using a specific mechanism as claimed below in claim 2, which allows the DEVELOPER to identify the USER at a certain point of time via computer data stored as claimed below in claim 2,
by in a specific way permitting or denying to the USER the execution of tasks prescribed in the computer program, which creates and modifies those computer data, namely
to grant, in proportion to the cash flow, which the USER contributes, permission for the number of executions of those tasks, which create or modify or delete the “transient” part of those computer data, and
to deny, if the USER doesn't contribute to the cash flow, permission to execute those tasks, which create or modify or delete the “transient” part of those computer data, and
to unconditionally grant permission to execute those tasks, which create or delete the “basic” part of those computer data or,
which convert that part of those computer data, which the USER owns, into a form, which is directly understandable to human senses or to other computer programs,
the cash flow consisting of USAGE FEEs as claimed below in claim 12.

2.
Storage of the Parts of the Mechanism
The inventor claims to have invented
a mechanism, which allows the DEVELOPER of a computer program to permit or to deny to the USER the execution of tasks prescribed in the computer program on a computer,
whose technical specifications regarding the execution of code of computer programs in general are completely or partially known to the USER and
whose use in general is completely or partially outside of the control of the DEVELOPER of the computer program,
the complete code or partial code prescribing the tasks of the computer program being stored on a computer,
whose technical specifications regarding the storage of data in general are completely or partially known to the USER and whose use in general is completely or partially outside of the control of the DEVELOPER of the computer program,
the information used to decide whether to permit or whether to deny to the USER the execution of tasks being stored on a computer,
whose technical specifications regarding the storage of data in general are completely or partially known to the USER and
whose use in general is completely or partially outside of the control of the DEVELOPER of the computer program,
the decision whether to permit or whether to deny the execution of tasks prescribed in the computer program made through code stored as specified above in this claim using information stored as specified above in this claim,
the actions of the USER towards the computer and towards the data stored on it in general being completely or partially outside of the control of the DEVELOPER of the computer program,
the USER being identified by data being stored together with the information used to decide whether to grant or whether to deny to the USER the execution of tasks as specified above in this claim,
the specific parts of the mechanism and their basic construction principle as claimed below in claim 3.

3.
Parts of the Mechanism
The inventor claims to have invented,
that the parts of the mechanism, which is referred to in the previous claim 2, and their basic construction principle are
a data item called COMPUTER PROGRAM COPY,
a data item called COMPUTER DATABASE,
a data item called PAID RECORDS and
a data item called ADDITIONAL PAID RECORDS,
the COMPUTER PROGRAM COPY being a data item, which
1 is stored in computer files, in computer disk volumes or in other sequential or block-oriented computer storage facilities, for which means to make copies of one entire file, of one entire disk volume or of one entire storage facility and to distribute those copies may be easily available to the USER, however the DEVELOPER doesn't make available to the USER any means to make meaningful copies of or meaningful modifications of parts of one file, of one disk volume or of one storage facility,
2 contains code, some or all of which is to be executed on computers, whose specifications regarding the execution of code are completely or partially known to the USER,
3 contains INSEPARABLY LINKED the code prescribing those tasks of the computer program, which change the COMPUTER DATABASE, or perform other actions, while changing the PAID RECORDS data item,
the COMPUTER DATABASE being a data item, which is
1 stored in computer files, in computer disk volumes or in other sequential or block-oriented computer storage facilities, for which means to make copies of one entire file, of one entire disk volume or of one entire storage facility and to distribute those copies may be easily available to the USER, however the DEVELOPER doesn't make available to the USER any means to make meaningful copies of or meaningful modifications of parts of one file, of one disk volume or of one storage facility, except as prescribed in the COMPUTER PROGRAM COPY,
2 being changed in an ongoing way during the entire usage term of a COMPUTER PROGRAM COPY by the COMPUTER PROGRAM COPY, this condition promoted by a specific method as claimed below in claim 4,
code in the COMPUTER PROGRAM COPY being the only means made available by the DEVELOPER to the USER to make meaningful changes of the COMPUTER DATABASE,
3 meaningful only to, or confidential for, the USER, this condition promoted by a specific method as claimed below in claim 9,
PAID RECORDS being a data item, which is
1 INSEPARABLY LINKED to the COMPUTER DATABASE,
2 used by the methods claimed below in either claim 5 or claim 8 and either claims 6, 7, 14 or claims 7, 14 consisting of the parts
number,
serial number,
installation number,
identification,
start date,
number on start date,
addition since start date,
minimum consumption per time unit,
maximum number,
ADDITIONAL PAID RECORDS being a data item, which is
1 is stored in one computer file, in one computer disk volume or in one other sequential or block-oriented computer storage facility,
for which means to make copies of the entire file, of the entire disk volume or of the entire storage facility and distribute those copies may be easily available to the USER, however the DEVELOPER doesn't make available to the USER any means to make meaningful copies of or modifications of parts of the file, of the disk volume or of the storage facility, except as prescribed in the COMPUTER PROGRAM COPY,
2 used to transport information whether to permit or whether to deny the execution of tasks prescribed in a COMPUTER PROGRAM COPY from the DEVELOPER to the USER, consisting of the parts
number,
serial number,
installation number,
INSEPARABLY LINKED meaning with regard to the code prescribing the tasks mentioned above in this claim, which modify COMPUTER DATABASE and the PAID RECORDS data item,
that the DEVELOPER does not make available to the USER any means to partially delete or to change code, which prescribes those tasks, from the COMPUTER PROGRAM COPY and,
that the DEVELOPER does not make available to the USER any means to execute without authorization any of those tasks partially and,
that the code, which prescribes those tasks, contains commands, which verify the successful completion of the task and,
that, if such verification fails, the COMPUTER PROGRAM COPY denies permission to execute certain tasks, until the uncompleted task is completed, and,
that the DEVELOPER doesn't make available to the USER any means to convert the code of the COMPUTER PROGRAM COPY into a form, which is directly understandable to the human senses,
INSEPARABLY LINKED meaning with regard to COMPUTER DATABASE and the PAID RECORDS data item,
that, in case the COMPUTER DATABASE consists of several files, PAID RECORDS is stored in a file, which contains that type of “basic data” with the highest number of items,
that, in case the COMPUTER DATABASE consists of several disk volumes, PAID RECORDS is stored in a disk volume, which contains that type of “basic data” with the highest number of items,
that, in case the COMPUTER DATABASE consists of several storage facilities, PAID RECORDS is stored in a storage facility, which contains that type of “basic data” with the highest number of items,
that the particular file, disk volume or storage facility containing the PAID RECORDS data item is
1 being changed in an ongoing way during the entire usage term of a COMPUTER PROGRAM COPY by the COMPUTER PROGRAM COPY, this condition promoted by a specific method as claimed below in claim 4,
2 meaningful only to, or confidential for, the USER, this condition promoted by a specific method as claimed below in claim 9,
that the COMPUTER PROGRAM COPY is the only means, which the DEVELOPER makes available to the USER,
to make meaningful copies of parts of the combination of COMPUTER DATABASE and the PAID RECORDS data item or to delete meaningful parts of the combination of COMPUTER DATABASE and the PAID RECORDS data item,
the specific methods of using these parts of the mechanism as claimed below in either claim 5 or claim 8 and either claims 6, 7, 14 or claims 7, 14
“basic data” being that part of the COMPUTER DATABASE, whose permanent storage is the fundamental purpose of the COMPUTER PROGRAM COPY.

4.
Changed in an Ongoing Way
The inventor claims to have invented
a method to promote, that the COMPUTER DATABASE part of above claimed mechanism is being changed in an ongoing way, namely,
that the DEVELOPER stores a certain “start date” in the COMPUTER DATABASE, or, that the COMPUTER PROGRAM COPY stores a certain '“start date” in the COMPUTER DATABASE at installation time,
this “start date” being modifiable by the USER only via tasks prescribed in the COMPUTER PROGRAM COPY,
the COMPUTER PROGRAM COPY to contain code,
which denies permission to execute all or some tasks prescribed in the COMPUTER PROGRAM COPY, which attempt to store in the COMPUTER DATABASE any date prior to the “start date”, and
which denies permission to execute all or some tasks prescribed in the COMPUTER PROGRAM COPY, which attempt to store in the COMPUTER DATABASE any date after the sum of the “start date” and a certain “date window”,
the “date window” being a positive number of date units stored in the COMPUTER PROGRAM COPY or in the COMPUTER DATABASE by the DEVELOPER, so that the USER can not change it.
Remark: claim 5 and claim 8 mutually exclude each other, that is, if a process uses the methods of one claim, it must not use the methods of the other claim.

5.
Test for Permission Against a number Z
The inventor claims to have invented
a method to grant or to deny to a USER permission to execute some tasks prescribed in the COMPUTER PROGRAM COPY part of above claimed mechanism, namely,
that the code of these tasks is extended in such a way, that the task compares the “number” part of the PAID RECORDS data item with a number Z, before executing the original task, and
denies permission to execute the original task, in case the “number” part of the PAID RECORDS data item is equal to Z, grants permission to execute the original task, in case the “number” part of the PAID RECORDS data item is between Z and the “maximum number” part of the PAID RECORDS data item, excluding Z.

6.
Charging for Adding Transient Data
The inventor claims to have invented
a method to promote a cash flow from the USER to the DEVELOPER while a COMPUTER PROGRAM COPY is used, namely,
that the code of some tasks (prescribed in the COMPUTER PROGRAM COPY), which process “transient data”, is extended in such a way, that each such task,
while processing “transient data”, replaces at the same time the “number” part of the PAID RECORDS data item with a value,
which is equally distant to or closer to the limit used to decide whether to grant or whether to deny permission to execute certain tasks as claimed in claim 5 or in claim 8 and which is always between Z and the “maximum number” part of the PAID RECORDS data item,
the absolute difference between the “number” part of the PAID RECORDS data item before and after the execution of the task being proportional to the number of “transient data” processed,
or a constant number, or a number associated with the task,
the factor of proportionality, the constant number or the number associated with the task as stored by the DEVELOPER in the COMPUTER PROGRAM COPY or in the COMPUTER DATABASE, so that the USER can not change it,
the specific method, how the COMPUTER PROGRAM COPY uses the “number” part of the PAID RECORDS data item to decide whether to grant or whether to deny permission to execute certain tasks as claimed in claim 5 or in claim 8,
the specific method, how the DEVELOPER obtains a fee in exchange for a change of the “number” part of the PAID RECORDS data item to a higher value as claimed below in claim 12.

7.
Charging for Changing Start Date
The inventor claims to have invented
a method to promote a cash flow from the USER to the DEVELOPER during the time a COMPUTER PROGRAM COPY is used, namely,
that any task (prescribed in the COMPUTER PROGRAM COPY), which changes the “start date” part of the PAID RECORDS data item, replaces at the same time the “number” part of the PAID RECORDS data item with a value, which is equally distant to or closer to the limit used to decide whether to grant or whether to deny permission to execute certain tasks as claimed in claim 5 or in claim 8 and which is always between Z and the “maximum number” part of the PAID RECORDS data item,
the absolute difference between the “number” part of the PAID RECORDS data item before and after the change being the product of the absolute difference of the “start date” after and before the change in time units and the “minimum consumption per time unit” part of the PAID RECORDS data item, under the condition, that the result of “number on start date” changed by the absolute value of the “addition since start date” away from the limit and that result changed by the absolute difference between new “start date” and the old “start date” in time units multiplied by “minimum consumption per time unit” towards the limit
is closer to the limit than the “number” part of the PAID RECORDS data item,
however, if that value is not between the number Z and the “maximum number” part of the PAID RECORDS data item, replaces the “number” part with the limit,
and, that any such task replaces the “number on start date” part of the PAID RECORDS data item with the “number” part of the PAID RECORDS data item after having changed the “number” part of the PAID RECORDS data item,
and, that any task, which adds “additional paid records” to a COMPUTER DATABASE (see claim 12), adds at the same time the “number” part of the ADDITIONAL PAID RECORDS data item to the “addition since start date” part of the PAID RECORDS data item,
and, that the DEVELOPER sets the absolute difference between the “maximum number” part of the PAID RECORDS data item and Z to a value smaller than the number of time units, which fit into six calendar months, times the “minimum consumption per time unit” part of the PAID RECORDS data item,
and, that the DEVELOPER sets the absolute difference between the “maximum number” part of the ADDITIONAL PAID RECORDS data item and Z to a value smaller than
the number of time units, which fit into six calendar months, times the “minimum consumption per time unit” part of the ADDITIONAL PAID RECORDS data item,
and, that the DEVELOPER sets the length of the “date window” in the COMPUTER PROGRAM COPY or in the COMPUTER DATABASE to less than six calendar months,
the specific method, how the COMPUTER PROGRAM COPY uses the “number” part of the PAID RECORDS data item to decide whether to grant or whether to deny permission to execute certain tasks as claimed in claim 5 or in claim 8,
the specific method, how the DEVELOPER obtains a fee in exchange for a change of the “number” part of the PAID RECORDS data item to a higher value as claimed below in claim 12.

8.
Test for Permission Against the “maximum number” part of the PAID RECORDS data item
The inventor claims to have invented
a method to grant or to deny to a USER permission to execute some tasks prescribed in the COMPUTER PROGRAM COPY part of above claimed mechanism, namely,
that the code of these tasks is extended in such a way, that the task compares the “number” part of the PAID RECORDS data item with the “maximum number” part of the PAID RECORDS data item, before executing the original task, and
denies permission to execute the original task, in case the “number” part of the PAID RECORDS data item is equal to the “maximum number” part of the PAID RECORDS data item,
grants permission to execute the original task, in case the “number” part of the PAID RECORDS data item is between Z and the “maximum number” part of the PAID RECORDS data item,
excluding the “maximum number” part of the PAID RECORDS data item.

9.
Meaningful Only To, or Confidential for, a Certain USER
The inventor claims to have invented
a mechanism to promote, that a COMPUTER DATABASE is meaningful only to, or confidential for, a certain USER, namely,
that any task (prescribed in the COMPUTER PROGRAM COPY), which installs the COMPUTER PROGRAM COPY or which initializes the COMPUTER DATABASE,
sets at the same time the “installation number” part of the PAID RECORDS data item to a specific, initial value and,
that the DEVELOPER transfers in the first ADDITIONAL PAID RECORDS data item ordered for an initialized COMPUTER DATABASE an “installation number” into the PAID RECORDS data item in that COMPUTER DATABASE and,
that any task (prescribed in the COMPUTER PROGRAM COPY), which installs the COMPUTER PROGRAM COPY or which initializes the COMPUTER DATABASE,
sets at the same time the “number” part of the PAID RECORDS data item to the limit used to decide whether to grant or whether to deny permission to execute certain tasks according to claim 5 or claim 8, and sets “serial number” part of the PAID RECORDS data item to a new, unique value and,
that any task (prescribed in the COMPUTER PROGRAM COPY), which changes the “identification” part of the PAID RECORDS data item,
sets at the same time the “number” part of the PAID RECORDS data item to the limit used to decide whether to grant or whether to deny permission to execute certain tasks according to claim 5 or claim 8, and sets the “serial number” part of the PAID RECORDS data item to a new, unique value and,
that all tasks (prescribed in the COMPUTER PROGRAM COPY), which delete “basic data” from the COMPUTER DATABASE, change towards the limit used to decide whether to grant or whether to deny permission to execute certain tasks according to claim 5 or to claim 8
the “number” part of the PAID RECORDS data item at the same time
by the result of the calculation absolute difference between the “maximum number” part of the PAID RECORDS data item and Z times a factor x times the ratio of the size of the deleted part to the total size of that part of the COMPUTER DATABASE the deleted part belongs to, and,
that all tasks (prescribed in the COMPUTER PROGRAM COPY), which add “basic data” to the COMPUTER DATABASE, change towards the limit used to decide whether to grant or whether to deny permission to execute certain tasks according to claim 5 or claim 8
the “number” part of the PAID RECORDS data item at the same time
by the result of the calculation absolute difference between the “number” part of the PAID RECORDS data item and the limit used to decide whether to grant or whether to deny permission to execute certain tasks according to claim 5 or claim 8 times the a factor x times the
ratio of the size of the added part to the sum of the size of the added part times a factor y and the current size of that part of the COMPUTER DATABASE the added part belongs to times a factor z,
with x being larger than zero and smaller than or equal to one, y being larger than zero and smaller than ten, z being larger than zero and smaller than ten.

10.
Copy Detection and Loss Estimation
The inventor claims to have invented
a method to detect copying of a COMPUTER DATABASE containing a PAID RECORDS data item and to estimate the revenue loss to the DEVELOPER by such copying, namely,
that the PAID RECORDS data item gets an additional part “copy number” and the ADDITIONAL PAID RECORDS data item gets an additional part “copy number” and
that each ADDITIONAL PAID RECORDS data item is marked with the “serial number” of that PAID RECORDS data item, for which it can be used only, and,
that each ADDITIONAL PAID RECORDS data item is marked with the “copy number” of that PAID RECORDS data item, for which it can be used only, and,
that each ADDITIONAL PAID RECORDS data item is marked with the “installation number” of that PAID RECORDS data item, for which it can be used only, and,
that any task (prescribed in the COMPUTER PROGRAM COPY), which installs the COMPUTER PROGRAM COPY or which initializes the COMPUTER DATABASE,
sets at the same time the “copy number” part of the PAID RECORDS data item to a new, unique value and,
that during a COMPUTER PROGRAM COPY adds “additional paid records” to a COMPUTER DATABASE,
it replaces the “copy number” part of the PAID RECORDS data item with the “serial number” part of the PAID RECORDS data item and after that, replaces the “serial number” part of the PAID RECORDS data item with a new, unique value and,
that the DEVELOPER records in an orders received table, which has fields for “serial number”, “copy number”, “installation number”, “maximum number”, “price for one paid record” and “running number”,
at the time, when the DEVELOPER sends an ADDITIONAL PAID RECORDS data item to the USER,
the “serial number”, “copy number” and “installation number” parts of the PAID RECORDS data item as they were at the time, when the USER requested an ADDITIONAL PAID RECORDS data item from the DEVELOPER,
in such a way, that
the “serial number” received from the USER is recorded in the “serial number” field,
the “copy number” received from the USER is recorded in the “copy number” field and
the “installation number” received from the USER is recorded in the “installation number” field and
the current “maximum number” of the installation from the customer table of the DEVELOPER is recorded in the “maximum number” field and
the current “price for one paid record” of the installation from the customer table of the DEVELOPER is recorded in the “price for one paid record” field and
a monotonously increasing or monotonously decreasing number is recorded in the “running number” field of a new record and,
that in case at the time, when a USER requests an ADDITIONAL PAID RECORDS data item, in the orders received table a record R1 can be found,
which has a “running number”, which is smaller than the “running number” of the new record in case the numbers are filled monotonously increasing, which is larger than the “running number” of the new record in case the numbers are filled monotonously decreasing and which contains the “copy number” of the new record in field “copy number”,
the USER has copied the PAID RECORDS data item, for which he/she requests an ADDITIONAL PAID RECORDS data item, with a loss to the DEVELOPER between zero and the sum of the “price for one paid record” times the absolute value of the “maximum number” field of that record R2,
which has a “running number”, which is smaller than the “running number” of the new record in case the numbers are filled monotonously increasing, which is larger than the “running number” of the new record in case the numbers are filled monotonously decreasing and
where the “serial number” is equal to the “copy number” of that record R3, where the “serial number” is equal to the “copy number” which the USER tells now,
plus the “price for one paid record” times the absolute value of the “maximum number” field of record R3,
or, if such a record R2 doesn't exist, the “price for one paid record” times the absolute value of the “maximum number” from record R3,
with “running number” of record R2 smaller than “running number” of record R3 and “running number” of record R3 smaller than “running number” of record R1 in case numbers in field “running number” are filled monotonously increasing,
with “running number” of record R2 larger than “running number” of record R3 and “running number” of record R3 larger than “running number” of record R1 in case numbers in field “running number” are filled monotonously decreasing.

11.
Identification of a USER and Denial of Permission
The inventor claims to have invented
a method to deny permission to an identified USER to execute certain tasks prescribed in a COMPUTER PROGRAM COPY, by using the mechanism claimed in claim 3, namely
by refusing to provide an ADDITIONAL PAID RECORDS data item to the USER, who provides to the DEVELOPER the “installation number” and “serial number” parts of a PAID RECORDS data item.

12.
Identification of a USER and Grant of Permission
The inventor claims to have invented
a method to grant permission to execute certain tasks prescribed in a COMPUTER PROGRAM COPY to an identified USER in exchange for a fee, by using the mechanism claimed in claim 3, namely,
that the USER, in order to set the “number” part of the PAID RECORDS data item to a value away from the limit used to decide whether to grant or whether deny permission to execute certain tasks (and thereby getting permission to execute certain tasks prescribed in the COMPUTER PROGRAM COPY, as claimed in claim 5 or in claim 8),
must obtain from the DEVELOPER an ADDITIONAL PAID RECORDS data item in exchange for a USAGE FEE calculated as absolute value of the “number” part of the ADDITIONAL PAID RECORDS data item times the price for one “paid record”,
in other words, the DEVELOPER doesn't make available to the USER any means to create an ADDITIONAL PAID RECORDS data item, the COMPUTER PROGRAM COPY containing code, which the USER can execute, which changes the “number” part of the PAID RECORDS data item by the absolute value of the “number” part of the ADDITIONAL PAID RECORDS data item away from the limit, under the condition, that
the “serial number” part of the ADDITIONAL PAID RECORDS data item is equal to the current “serial number” part of the PAID RECORDS data item, and
the “installation number” part of the ADDITIONAL PAID RECORDS data item is equal to the current “installation number” part of the PAID RECORDS data item or the “installation number” part of the PAID RECORDS data item is equal to the initial value, and
the result of changing the “number” part of the PAID RECORDS data item by the absolute value of the “number” part of the ADDITIONAL PAID RECORDS data item away from the limit is between Z and the “maximum number” part of the ADDITIONAL PAID RECORDS data item,
the code, while replacing the “number” part of the PAID RECORDS data item, replacing the “serial number” part of the PAID RECORDS data item with a new, unique number,
and replacing the “installation number” part of the PAID RECORDS data item with the “installation number” part of the ADDITIONAL PAID RECORDS data item.

13.
Change of Billing Conditions
The inventor claims to have invented
a method enabling the DEVELOPER to change the billing conditions for the USER of a COMPUTER PROGRAM COPY at the time, when the USER obtains an ADDITIONAL PAID RECORDS data item, namely
that the ADDITIONAL PAID RECORDS data items gets the additional parts “maximum number” and “minimum consumption per time unit” and,
that the DEVELOPER sets the “minimum consumption per time unit” and “maximum number” parts of the ADDITIONAL PAID RECORDS data item to those values that apply for the USER at the time, when
the USER requests the ADDITIONAL PAID RECORDS data item, and,
that the COMPUTER PROGRAM COPY
replaces the “minimum consumption per time unit” part of the PAID RECORDS data item with the “minimum consumption per time unit” part of the ADDITIONAL PAID RECORDS data item, and replaces the “maximum number” part of the PAID RECORDS data item with the “maximum number” part of the ADDITIONAL PAID RECORDS data item
at the time, when it adds “additional paid records” to a COMPUTER DATABASE, as claimed above in claim 12.

14.
Price Calculation, Trial Period, “maximum number” and “minimum consumption per time unit” parts of the PAID RECORDS data item
The inventor claims to have invented
a method to calculate the price for one “paid record”, namely:
Estimate the minimum number of times, which the average COMPUTER PROGRAM COPY runs any of the tasks, which cost “paid records”, per time unit.
Multiplying these values with the numbers, which the tasks charge in average during each execution, and adding the products gives the value to set in the “minimum consumption per time unit” part of the PAID RECORDS data item.
Call this “minimum consumption per time unit” part of the PAID RECORDS data item A.
Next do the following:
Estimate the number of COMPUTER PROGRAM COPIES, which can be distributed during the forecast term and call this number N, then calculate the sum of the following 9 items:
1 the cost of development of the program before release,
2 the cost of research and development of major improvements of the program for the forecast term,
3 the cost of developing bug fixes for the program for the forecast term,
4 the cost of selling to the USERs N COMPUTER PROGRAM COPIES,
5 the cost of manufacturing and bringing to the USERs N COMPUTER PROGRAM COPIES, (Cost 1 through 5 assumed to be independent from the number of COMPUTER PROGRAM COPIES installed.)
6 capital cost for the forecast term: In case cost 1 through 5 take about two thirds of the total, therefore cost 7 through 9 take about one third, about 15% of the total cost are required as starting capital, the interest to be paid over the forecast term on that capital being cost 6,
7 the cost of supporting USERs of N COMPUTER PROGRAM COPIES for the forecast term, divided by a factor X, which is two, in case the number of installations per month is assumed constant,
8 the cost of bringing bug fixes to the USERs of N COMPUTER PROGRAM COPIES for the forecast term, divided by a factor X, which is two, in case the number of installations per month is assumed constant,
9 the cost of creating and bringing ADDITIONAL PAID RECORDS data items to the USERs of N COMPUTER PROGRAM COPIES for the forecast term, divided by a factor X, which is two, in case the number of installations per month is assumed constant,
and then divide this sum by
the product of N and the expected number of “paid records”, which one COMPUTER PROGRAM COPY consumes during the forecast term (which is at least A times the number of time units, which fit into the forecast term).
and then multiply the quotient with a factor X, this factor being
two, in case the number of installations per month is assumed constant,
larger than two, in case the program is expected to take off slowly, but to pick up during the forecast term to reach the expected number of copies,
smaller than two, in case the program is expected to take off fast, but then to slow down during the forecast term to reach the expected number of copies.
Decide the length of the trial period for one COMPUTER PROGRAM COPY. Call the number of time units, which fit into the trial period, T.
Now the “maximum number” part M of the PAID RECORDS data item is to be calculated as:

|M−Z|=(T×A)/2, Z being a constant number.
Because |M−Z|<A×the number of time units, which fit into six calendar months, (see claim 6 above), T must be smaller than twelve months.

15.
“Pay As You Go” Sales Control Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “sales control program”,
the DEVELOPER being the entity or being the entities, which develop(s) this “sales control program”,
the USER being any entity or being entities which has (have) at least one copy of this “sales control program” at its (their) disposal,
the COMPUTER PROGRAM COPY being a copy of the “sales control program”,
the COMPUTER DATABASE consisting of
“basic data”, which are any combination of customer records, delivery point records, product records and/or related records, and “transient data”, which are any combination of sales records, order records, payment received records, customer change records, delivery point change records, product change records and/or related records,
including the possibility, that none of the “transient data” is stored in the COMPUTER DATABASE,
some or all dates, which are stored together with the “transient data” and with the “basic data”, having to be at the time when they are stored within the current “date window”,
this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

16.
“Pay As You Go” Financial Accounting Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “financial accounting program”,
the DEVELOPER being the entity or being the entities, which develop(s) this “financial accounting program”,
the USER being any entity or being entities which has (have) at least one copy of this “financial accounting program” at its (their) disposal,
the COMPUTER PROGRAM COPY being a copy of the “financial accounting program”,
the COMPUTER DATABASE consisting of
“basic data”, which are any combination of account records, fixed assets records and/or related records, and “transient data”, which are any combination of account movement records, account change records, fixed asset change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

17.
“Pay As You Go” Stock Control Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “stock control program”,
the DEVELOPER being the entity or the entities, which develop(s) this “stock control program”,
the USER being any entity or entities which has (have) at least one copy of this “stock control program” at its (their) disposal,
the COMPUTER PROGRAM COPY being a copy of the “stock control program”,
the COMPUTER DATABASE consisting of
the “basic data”, which are any combination of warehouse records, product records, supplier records and/or related records,
the “transient data”, which are any combination of stock movement records, warehouse change records, product change records, supplier change records and/or related records, including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

18.
“Pay As You Go” Manufacturing Control Program
The inventor claims to have invented
a specific process to generate a cash flow consisting of the fees as claimed above in claim 12,
using the specific mechanism with its basic construction principle and parts as claimed above in claim 3, using the specific methods to use the mechanism as claimed above in claim 4 and claim 9 and either claim 5 or claim 8 and either claims 6, 7, 14 or claims 7, 14
for the use of a copy of a program called “manufacturing control program”,
the DEVELOPER being the entity or being the entities, which develop(s) this “manufacturing control program”,
the USER being any entity or being entities which has (have) at least one copy of this “manufacturing control program” at its (their) disposal,
the COMPUTER PROGRAM COPY being a copy of the “manufacturing control program”,
the COMPUTER DATABASE consisting of
the “basic data”, which are any combination of stock item records, product records, supplier records and/or related records,
the “transient data”, which are any combination of stock movement records, process records, stock item change records,
product change records, supplier change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

19.
“Pay As You Go” Property Valuation Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “property valuation program”,
the DEVELOPER being the entity or the entities, which develop(s) this “property valuation program”,
the USER being any entity or entities which has (have) at least one copy of this “property valuation program” at its (their) disposal,
the COMPUTER PROGRAM COPY being a copy of the “property valuation program”,
the COMPUTER DATABASE consisting of
the “basic data”, which are any combination of property owner records and/or related records,
the “transient data”, which are any combination of property records, property part records, property part value modifier records, property owner change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

20.
“Pay As You Go” Marketing Support Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “marketing support program”,
the DEVELOPER being the entity or the entities, which develop(s) this “marketing support program”,
the USER being any entity or entities which has (have) at least one copy of this “marketing support program” at its (their) disposal,
the COMPUTER PROGRAM COPY being a copy of the “marketing support program”,
the COMPUTER DATABASE consisting of
the “basic data”, which are any combination of prospective customer records, customer records and/or related records,
the “transient data”, which are any combination of contact records, prospective customer change records, customer change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

21.
“Pay As You Go” Fax/E-mail Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “fax/e-mail program”, the DEVELOPER being the entity or the entities, which
develop(s) this “fax/e-mail program”,
the USER being any entity or entities which has (have) at least one copy of this “fax/e-mail program” at its (their) disposal, the COMPUTER PROGRAM COPY being a copy of the “fax/e-mail program”,
the COMPUTER DATABASE consisting of
the “basic data”, which are any combination of address book records and/or related records,
the “transient data”, which are any combination of received fax/e-mail records, sent fax/e-mail records, address book change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

22.
“Pay As you Go” Calendar and Scheduling Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “calendar and scheduling program”,
the DEVELOPER being the entity or the entities, which
develop(s) this “calendar and scheduling program”,
the USER being any entity or entities which has (have) at least one copy of this “calendar and scheduling program” at its (their) disposal,
the COMPUTER PROGRAM COPY being a copy of the “calendar and scheduling program”,
the COMPUTER DATABASE consisting of
the “basic data”, which are any combination of user name records and/or related records,
the “Transient data”, which are any combination of calendar records, schedule records, user name change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data” it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY, the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

23.
“Pay As You Go” Payroll Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “payroll program”,
the DEVELOPER being the entity or the entities, which
develop(s) this “payroll program”,
the USER being any entity or entities which has (have) at least one copy of this “payroll program” at its (their) disposal,
the COMPUTER PROGRAM COPY being a copy of the “payroll program”,
the COMPUTER DATABASE consisting of
the “basic data”, which are any combination of employee records and/or related records,
the “transient data”, which are any combination of salary records, employee change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

24.
“Pay As You Go” Equipment Maintenance Control Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “equipment maintenance control program”,
the DEVELOPER being the entity or the entities, which
develop(s) this “equipment maintenance control program”,
the USER being any entity or entities which has (have) at least one copy of this “equipment maintenance control program” at its (their) disposal,
the COMPUTER PROGRAM COPY being a copy of the “equipment maintenance control program”,
the COMPUTER DATABASE consisting of
the “basic data”, which are any combination of maintenance records and/or related records,
the “transient data”, which are any combination of maintenance records, equipment change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY adds one record of one type of “transient data” or updates one record of one type of “transient data” or deletes one record of one type of “transient data”
it changes the “number” part of the PAID RECORDS data item by a number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

25.
“Pay As You Go” CAD Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “CAD program”,
the DEVELOPER being the entity or the entities, which
develop(s) this “CAD program
the USER being any entity or entities which has (have) at least one copy of this “CAD program” at its (their) disposal,
the COMPUTER PROGRAM COPY being a copy of the “CAD program”,
the COMPUTER DATABASE consisting of
the “basic data”, which are any combination of drawing records, stock object records and/or related records,
the “transient data”, which are any combination of drawing change records, stock object change records and/or related records,
including the possibility, that none of the “transient data” is stored in the COMPUTER DATABASE,
some or all dates, which are stored together with the “transient data” and with the “basic data”, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY updates one drawing, it changes the “number” part of the PAID RECORDS data item by a number (including zero) towards the limit, or
when the COMPUTER PROGRAM COPY updates a drawing, it changes the “number” part of the PAID RECORDS data item by a number proportional to the number of drawing elements added, or added and changed, or added and deleted, or added and changed and deleted, towards the limit, or
when the COMPUTER PROGRAM COPY updates one stock object, it changes the “number” part of the PAID RECORDS data item by a number (including zero) towards the limit, or
when the COMPUTER PROGRAM COPY updates a stock object, it changes the “number” part of the PAID RECORDS data item by a number proportional to
the number of drawing elements added, or added and changed, or added and deleted, or added and changed and deleted, towards the limit,
the “or” meaning, that the DEVELOPER can choose “any single one of these actions as well as any combination of them” to prescribe them in the code of the COMPUTER PROGRAM COPY, the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

26.
“Pay As You Go” Disk Operating Subsystem Program
The inventor claims to have invented
a specific process to generate a cash flow consisting of the fees as claimed above in claim 12,
using the specific mechanism with its basic construction principle and parts as claimed above in claim 3,
using the specific methods to use the mechanism as claimed above in claim 4 and claim 9 and either claim 5 or claim 8 and either claims 6, 7, 14 or claims 7, 14
for the use of a copy of a program called “disk operating subsystem”,
the DEVELOPER being the entity or the entities, which
develop(s) this “disk operating subsystem”,
the USER being any entity or entities which has (have) at least one copy of this “disk operating subsystem” at its (their) disposal,
the COMPUTER PROGRAM COPY being a copy of the “disk operating subsystem”,
the COMPUTER DATABASE consisting of
the “basic data”, which are the combination of file allocation table, directory, files and folders,
the “transient data”, which are the changes to file allocation table, directory, files and folders,
including the possibility, that none of the “transient data” is stored in the COMPUTER DATABASE,
the dates, which are stored to indicate the date, when a disk file is created or updated, having to be at the time when they are stored within the current “date window”, this “date window” starting from the “start date” stored in the COMPUTER DATABASE, as claimed above in claim 4,
the PAID RECORDS data item being stored together with that COMPUTER DATABASE INSEPARABLY LINKED,
charges for use of the program being calculated in such a way, that
when the COMPUTER PROGRAM COPY updates one file, it changes the “number” part of the PAID RECORDS data item by a constant number (including zero) towards the limit, or
when the COMPUTER PROGRAM COPY renames one file, it changes the “number” part of the PAID RECORDS data item by another number (including zero) towards the limit,
the “or” meaning, that the DEVELOPER can choose “any single one of these actions as well as any combination of them” to prescribe them in the code of the COMPUTER PROGRAM COPY,
the limit being the limit used by the COMPUTER PROGRAM COPY to decide whether to grant or whether to deny permission to execute certain tasks as claimed in claim 5 or in claim 8,
changes of the “start date” resulting in a change of the “number” part of the PAID RECORDS data item according to claim 7,
additions and deletions of “basic data” resulting in a change of the “number” part of the PAID RECORDS data item according to claim 9.

27.
“Billing Services” for Other Programs
The inventor claims to have invented
a method to give “billing services” to other programs, namely that the PAID RECORDS data item is extended by an “access key” part,
and, that the COMPUTER PROGRAM COPY, or a part of it, accepts the following commands from other programs:
1 a command to allocate a PAID RECORDS data item for another program, this returns an access key to the PAID RECORDS data item, which the other program has to store in encrypted form in a file, which the other program creates,
2 a command to de-allocate a PAID RECORDS data item for a program, which supplies the access key to the PAID RECORDS data item,
3 a command to return the current value of each part of a PAID RECORDS data item for a program, which supplies the access key to the PAID RECORDS data item,
4 a command to change the value of each part of a PAID RECORDS data item for a program, which supplies the access key to the PAID RECORDS data item, to a value, which the other program requests.

28.
Merging the PAID RECORDS data item into a FAT
The inventor claims to have invented a method to INSEPARABLY LINK one or several PAID RECORDS data items with a COMPUTER DATABASE, which is a combination of file allocation table (FAT), directory, files and folders, namely:
The FAT stores in each record
1 a “marker” of 1 byte which tells the meaning of the record as described below in this claim,
2 a “field 1” of 3.5 byte, containing a cluster number in case the record contains cluster information, a part of the PAID RECORDS data item in case the record contains that information,
3 a “field 2” of 3.5 byte, containing cluster contents information (unused, bad, reserved, number of next cluster in chain) in case the record contains cluster information, a part of the PAID RECORDS data item in case the record contains that information,
one PAID RECORDS data item being stored, as explained below:
The “marker” is:
0, in case the record contains cluster information,
1, in case record contains the “number” part of the PAID RECORDS data item,
2, in case record contains part 1 of the “serial number” part of the PAID RECORDS data item,
3, in case record contains part 2 of the “serial number” part of the PAID RECORDS data item,
4, in case record contains part 1 of the “copy number” part of the PAID RECORDS data item,
5, in case record contains part 2 of the “copy number” part of the PAID RECORDS data item,
6, in case record contains part 1 of the “identification” part of the PAID RECORDS data item,
7, in case record contains part 2 of the “identification” part of the PAID RECORDS data item,
8, in case record contains part 3 of the “identification” part of the PAID RECORDS data item,
9, in case record contains part 4 of the “identification” part of the PAID RECORDS data item,
10,in case record contains part 5 of the “identification” part of the PAID RECORDS data item,
11, in case record contains part 6 of the “identification” part of the PAID RECORDS data item,
12,in case record contains part 7 of the “identification” part of the PAID RECORDS data item,
13,in case record contains part 8 of the “identification” part of the PAID RECORDS data item,
14,in case record contains part 9 of the “identification” part of the PAID RECORDS data item,
15,in case record contains part 10 of the “identification” part of the PAID RECORDS data item,
16,in case record contains part 11 of the “identification” part of the PAID RECORDS data item,
17,in case record contains part 12 of the “identification” part of the PAID RECORDS data item,
18,in case record contains part 13 of the “identification” part of the PAID RECORDS data item,
19,in case record contains part 14 of the “identification” part of the PAID RECORDS data item,
20,in case record contains part 15 of the “identification” part of the PAID RECORDS data item,
21,in case record contains part 16 of the “identification” part of the PAID RECORDS data item,
22,in case record contains part 17 of the “identification” part of the PAID RECORDS data item,
23,in case record contains part 18 of the “identification” part of the PAID RECORDS data item,
24,in case record contains part 19 of the “identification” part of the PAID RECORDS data item,
25,in case record contains part 20 of the “identification” part of the PAID RECORDS data item,
26,in case record contains the “installation number” part of the PAID RECORDS data item,
27,in case the record contains the “start date” part of the PAID RECORDS data item,
28,in case the record contains the “number on start date” part of the PAID RECORDS data item,
29,in case record contains the “addition since start date” part of the PAID RECORDS data item,
30,in case the record contains the “minimum consumption per time unit” part of the PAID RECORDS data item,
31,in case the record contains the “maximum number” part of the PAID RECORDS data item,
or any other assignment of the parts of the PAID RECORDS data item to the numbers 1 through 31, or less than 31.
To merge such PAID RECORDS data items with the FAT, a COMPUTER PROGRAM COPY executes the following task during creating a partition on a storage media, assuming, that the maximum number of clusters on the storage is smaller than or equal to 2,097,152:
1 Find out the total number of clusters on the disk, then divide this number by 1024, the result is the “number of cluster blocks”. Allocate RAM of 1055 times 8 bytes, for 1024+31 records of 8 bytes each, the “current block”.
2 Set 0 as the “start of current block”.
3 Make record 0 the “current record”.
4 Create one random number between 0 and 1023+31 (because one PAID RECORDS data item uses 31 records), the “current number”.
Check, if the “current number” is “used”:
Do for each record in the “current block”, until “current number” is found to be “used” or until the record before the “current record” has been checked:
if “marker” is 0, compare “current number” and “field 1” minus “start of current block”, if equal, then “current number” is “used”,
if marker is not equal 0, compare “current number” and “marker” minus (“start of current block” divided by 32) plus 1023, if equal, “current number” is “used”.
6 If the “current number” is “used”, continue from step 4.
7 If the “current number” is not “used” and smaller than 1024, set in the “current record” field “marker” to 0 and “field 1” to “current number” plus “start of current block”, this is the cluster number.
8 If the “current number” is not “used” and larger than 1023, mark the “current record” as part of a PAID RECORDS data item, by setting “marker” to “current number” minus 1023 plus (“start of current block” divided by 32) and “field 1” to 0.
9 Continue from step 4 with the next “current record”, which is “current record” plus 1 until 512 records are filled (“current record” is 512).
Then continue as follows:
10 Make record 513 the “current record”.
11 Set 0 as “current number”.
12 Check, if the “current number” is “used”:
Do for each record in the “current block”, until “current number” is found to be “used” or until the record before the “current record” has been checked:
if “marker” is 0, compare “current number” and “field 1” minus “start of current block”, if equal, then “current number” is “used”,
if marker is not equal 0, compare “current number” and “marker” minus (“start of current block” divided by 32) plus 1023, if equal, “current number” is “used”.
13 If the “current number” is “used”, continue from step 12 with the next “current number”, which is “current number” plus 1.
14 If the “current number” is not “used” and smaller than 1024, set in the “current record” field “marker” to 0 and “field 1” to “current number” plus “start of current block”, the cluster number.
15 If the “current number” is not “used” and larger than 1023, mark the “current record” as part of a PAID RECORDS data item, by setting “marker” to “current number” minus 1023 plus (“start of current block” divided by 32),
16 Continue from step 12 with the next “current number”, which is “current number” plus 1, and the next “current record”, which is “current record” plus 1, until all positions from 0 to 1023+31 are filled, that is, “current record” is 1054.
17 Set in each record “field 2” to 0, then encrypt each record separately and store the result on the storage media, this is 1055 records of 8 bytes each, starting from offset (“start of current block” divided by 1024 times 1055 times 8).
Then continue as follows:
18 Set 1 as the “start of current block”.
19 Make record 0 the “current record”.
20 Set 0 as “current number”.
21 If the “current number” is smaller than 1024, set in the “current record” field “marker” to 0 and “field 1” to “current number” plus “start of current block”, the cluster number.
22 If the “current number” is larger than 1023, mark the “current record” as unused, by setting “marker” to FFFF hex.
23 Continue from step 21 with the next “current number”, which is “current number” plus 1, and the next “current record”, which is “current record” plus 1, until all positions from 0 to 1023+31 are filled, that is, “current record” is 1054.
24 Set in each record “field 2” to 0, then encrypt each record separately and store the result on storage media, this is 1055 records of 8 bytes each, starting from offset (“start of current block” divided by 1024 times 1055 times 8).
25 Continue from step 20 with the next “start of current block”, which is “start of current block” plus 1024, until “start of current block” is (“number of cluster blocks” times 1024) minus 1.
Remark regarding step 1:
The DEVELOPER can choose to use another number of clusters per cluster block but 1024.
Remark regarding step 10:
The DEVELOPER can choose another number but 512 to switch.
Remark regarding step 8:
During creating records for clusters 1024 through 2047, add 32 to the marker of the parts of the PAID RECORDS data item, during creating records for clusters 2048 through 3071 add 64 to the marker of the parts of the PAID RECORDS data item. For the next block of clusters add 96, and so on. This means, that for each 1024 clusters on the disk, the FAT contains one PAID RECORDS data item.
The COMPUTER PROGRAM COPY uses just the one in the first cluster block for itself, the others it can offer to other programs for their billing purposes, according to claim 27. The last cluster block with “start of current block” of 2047 can not contain a PAID RECORDS data item, because the marker field can not distinguish it any more.
Remark regarding steps 18 to 25:
From the 2nd cluster block onward, cluster records and PAID RECORDS data items are stored in consecutive order of cluster number, with 31 records marked as unused at the end of each block.
When the COMPUTER PROGRAM COPY receives a request from another program according to claim 27, it then merges cluster records with the PAID RECORDS data item for the cluster block, which is put to use then.

29.
“Pay As You Go” Program created using Microsoft Access
The inventor claims to have invented
a method to INSEPARABLY LINK a PAID RECORDS data item to a COMPUTER DATABASE, and to INSEPARABLY LINK the parts of the COMPUTER PROGRAM COPY, which perform actions, which include a change to the PAID RECORDS data item,
using the Microsoft Access programming environment or using any programming environment, which provides equivalent functionality with regard to this claim, namely:
Establish “user-level security”, and create three user names, for the “Programmer”, for the “Normal” user and for “System”, each with its own, distinct password.
Give to user “Programmer” all permissions for all objects (databases, tables, queries, forms, reports, macros and modules).
Give to user “Normal” open permission for databases, read-only permissions for tables and queries, “execute-only” permissions for forms, reports, macros and modules.
Give to user “System” open permission for databases, read-write permissions for all tables and queries, no permissions for all other objects.
Make sure, that all other users, which may be defined, don't have any permissions for any objects, neither directly nor through membership in groups nor through ownership of objects. Log in with the user name of the “Programmer” and do all the following work in that session.
Create a MDB file to contain the COMPUTER DATABASE and the PAID RECORDS data item, another MDB file to contain the COMPUTER PROGRAM COPY, and another MDB file to contain the ADDITIONAL PAID RECORDS data item.
Create all tables required for the database in the MDB file prepared for the COMPUTER DATABASE.
Create in that same file the tables required for the PAID RECORDS data item, then set for user “Normal” permissions to None for these tables.
Create in the file prepared for the ADDITIONAL PAID RECORDS data item the required tables, then set for user “Normal” permissions to None for these tables.
Create in the MDB file prepared for the COMPUTER PROGRAM COPY all the queries, forms, reports, macros and modules required for the program.
The modules, which modify the tables in the COMPUTER DATABASE, the PAID RECORDS data item and the ADDITIONAL PAID RECORDS data item, must contain the password of user “System” in order to start a session using that password.
The DEVELOPER must make sure, that those modules do not publish this password, nor publish any function, which starts a public session using that password without closing it before return, nor publish any function, which modifies table access permissions.
The user interface must include a function to compact the MDB file, which contains the COMPUTER DATABASE and the PAID RECORDS data item.
Finally, the three MDB files must be encrypted using the function, which the programming environment provides for that purpose.
The functions, which modify the COMPUTER DATABASE and the PAID RECORDS data item or the ADDITIONAL PAID RECORDS data item must do this within one single transaction, to make sure, that all prescribed changes are saved completely.
Each distributed COMPUTER PROGRAM COPY must include:
a copy of the MDB file, which contains the COMPUTER PROGRAM COPY,
a copy of the MDB file, which contains COMPUTER DATABASE and the PAID RECORDS data item,
or, alternatively, the COMPUTER PROGRAM COPY to contain code, which creates an MDB file containing COMPUTER DATABASE and the PAID RECORDS data item,
the password of user “Normal” in order for the USER to log into the programming environment and to use the tables, queries, forms, reports, macros and modules
and the MDA or MDW file containing encryption keys, usernames and passwords in encrypted form.

30.
Calculation of Kickbacks for Distributors
The inventor claims to have invented
a method to calculate kickbacks for intermediaries charged with distributing COMPUTER PROGRAM COPIES, namely
that the DEVELOPER marks each COMPUTER PROGRAM COPY with a program type identifier”, from which the intermediary, who has distributed the COMPUTER PROGRAM COPY, can be distinguished, and,
that the DEVELOPER logs for each USER, who has no “installation number” in his/her COMPUTER DATABASE, the “program type identifier” together with the new “installation number” for the USER at the time the USER requests “additional paid records”, and,
that the DEVELOPER marks each ADDITIONAL PAID RECORDS data item with the “installation number” of that PAID RECORDS data item for which it can be used only, and,
that the DEVELOPER logs each time a USER requests “additional paid records” the sales amount together with the “installation number” of the ADDITIONAL PAID RECORDS data item created, and,
that the DEVELOPER tallies the sales for each intermediary by linking the log of “program type identifier” and “installation number” with the log of “installation number” and sales amount, and,
that the DEVELOPER calculates kickbacks from those sales tallies by applying a contracted function to each sales tally.

31.
Visualization of Adding “Additional Paid Records”
The inventor claims to have invented
a method to make adding “additional paid records” visual to a USER, namely
the COMPUTER PROGRAM COPY to contain code which shows, or requests another program to show, COMPUTER DATABASE and the ADDITIONAL PAID RECORDS data item as icons on a computer screen, and
which enables, or allows another program to enable, the USER to drag and drop the icon representing the ADDITIONAL PAID RECORDS data item onto the icon representing the COMPUTER DATABASE, and
which executes the code claimed in claim 12 when the USER has dropped the icon representing the ADDITIONAL PAID RECORDS data item onto the icon representing the COMPUTER DATABASE, and
which marks the icon representing the ADDITIONAL PAID RECORDS data item as empty or which hides, or requests another program to hide, the icon representing the ADDITIONAL PAID RECORDS data item after the code claimed in claim 12 has finished adding “additional paid records” to the COMPUTER DATABASE.

32.
Inseparably merging two data items
The inventor claims to have invented
a method to inseparably merge two data items, namely
that both data items are stored together in one file, in one disk volume or in one storage facility and,
that one data item is smaller than 10% of the size of the other data item and,
that the size of both data items together is more than 10,000 data units and,
that a program moves the smaller data item from time to time to another offset within the file, the disk volume or the storage facility,
the time interval between such moves being smaller than three calendar months.

33.
Protection of a program from getting distributed
The inventor claims to have invented
a method to protect a program from getting distributed, namely
that the program contains one file, which is larger than the maximum capacity of any removable storage facility connectable to any computer, which can execute the program, and,
that any computer, which can execute the program, scans at start up through the entire file, and
that any computer, which can execute the program and which needs to send or to receive data from the Internet, is only connected to another computer via a network, which is not capable of transporting Internet data packets,
the other computer not allowing to transport files with a size equal to or larger than the largest file of the program.
